(19) United States
(12) Patent Application Publication
(10) Pub. No.: US 2008/0219168 A1
(43) Pub. Date: Sep. 11, 2008

(54) RELAY APPARATUS, PATH SELECTION SYSTEM, PATH SELECTION METHOD AND PROGRAM

(75) Inventors: Nobuyuki ENOMOTO, Tokyo (JP); Kazuo TAKAGI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/042,388

(22) Filed: Mar. 5, 2008

(30) Foreign Application Priority Data
Mar. 7, 2007 (JP) 2007-056643

(51) Int. Cl. H04J 3/16

(52) U.S. Cl. 370/237

(57) ABSTRACT

An object of the present invention is to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exists. In the system of the present invention, the port manager within the relay apparatus, upon receipt of a notification of the link rate from the port, investigates which side, out of the WAN side and the LAN side, becomes a bottleneck, and the cost rewriter within the relay apparatus rewrites the root path cost field within the BPDU in conformity to the rate of the bottleneck.

### INCORPORATION BY REFERENCE

This application is based upon and claims the benefit of priority from Japanese patent application No. 2007-056643, filed on Mar. 7, 2007, the disclosure of which is incorporated herein in its entirety by reference.

### RELATED ART

The present invention relates to a communication technology for enhancing a reliability by providing path redundancy, and more particularly to a technology of, in a net in which an apparatus (bridge etc.) in which a path control protocol (STP etc.) for automatically computing a cost of a connection link by a physical band of the connection link operates exists, reflecting a band of a bottleneck into the cost, selecting an optimal path, and enhancing a net utilization efficiency without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc.

[Related Art 1]

As a rule, realizing a reliability of Ethernet (Registered Trademark) by providing path redundancy premises that a Spanning Tree Protocol (STP) is applied, thereby to virtually construct a network having a tree structure for a purpose of preventing a frame to be repeatedly transferred in a loop-shape between the bridges (for example, Non-patent document 1).

The Spanning Tree Protocol sets the cost of each port (port path cost) and utilizes it for computing the path based upon a link rate of the connection link connected to each port of the apparatus (bridge) in which the Spanning Tree Protocol operates.

[Related Art 2]

Further, the technology is disclosed of constructing a net in which a spanning tree with no loop is created between a carrier network and a user network connected hereto even in a dual-homing configuration by attaching a tag to a control frame (BPDU) of the Spanning Tree Protocol, thereby preventing the apparatus (bridge etc.) within a carrier network from processing the BPDU, that is, allowing the apparatus to transmit the BPDU (for example, Patent document 1).

This technology is a technology of preventing the spanning tree with a loop from being created when utilizing the Spanning Tree Protocol while spanning the carrier network.

[Related Art 3]

Further, the technology is disclosed of computing a cost of the link by the physical band of the connection link, and constructing a topology based upon this cost in the apparatus (for example, bridge etc.) in which the path control protocol for computing a cost of the connection link operates (for example, Patent document 2).

[Explanation of a Configuration]

FIG. 1 is a block diagram illustrating a network configuration based upon the related art 2.

A relay apparatus 1 is an apparatus for relaying between a Local Area Network (LAN) and a Wide Area Network (WAN).

The relay apparatus 1 adds or deletes a header, a tag, a flag or the like necessary for connecting the LAN such as the user network and the WAN such as the carrier network, further makes a buffering for purpose of absorbing a rate difference between the LAN and the WAN, and further performs encoding/decoding etc. for extending a transmission distance. The relay apparatus 1 is also generally called a transmission apparatus or a tunnel apparatus.

The relay apparatus 1 does not perform a process of the Spanning Tree Protocol (BPDU transmission). For this, the STP does not grasp existence of the relay apparatus 1, so the relay apparatus 1 is not taken into consideration when the STP computes the path.

Each of relay apparatuses 2 to 4 is a relay apparatus similar to the relay apparatus 1.

A bridge 5, which is an apparatus for accommodating a plurality of ports and deciding a transferee port with a destination MAC address of the frame that was input, is, for example, a switch or a switching hub. This bridge 5, which corresponds to the Spanning Tree Protocol (STP), receives/transmits the STP control frame (BPDU) and prepares a tree with the other bridges.

A bridge 6 is a bridge similar to the bridge 5.

A path 91 is a path connecting the bridge 5, the relay apparatus 1, the relay apparatus 2, and the bridge 6. For example, if it is assumed that the LAN between the bridge 5 and the relay apparatus 1, the LAN between the relay apparatus 2 and the bridge 6, the WAN between the relay apparatus 1 and the relay apparatus 2 is 100 Mbps, 100 Mbps, and 1 Mbps, respectively, the maximum band as a path is a band of the bottleneck, i.e. 1 Mbps.

A path 92 is a path connecting the bridge 5, the relay apparatus 3, the relay apparatus 4, and the bridge 6. For example, if it is assumed that the LAN between the bridge 5 and the relay apparatus 3, the LAN between the relay apparatus 4 and the bridge 6, and the WAN between the relay apparatus 3 and the relay apparatus 4 is 10 Mbps, 10 Mbps, and 10 Mbps, respectively, the maximum band as a path is a band of the bottleneck, i.e. 10 Mbps.

[Explanation of an Operation]

In the network shown in FIG. 1, it is assumed that the Spanning Tree Protocol operates between the bridge 5 and the bridge 6. Further, it is assumed that the bridge 5 is a root node.

The STPs within the bridge 5 and the bridge 6 set 200000 to the port in the path 91 side as a cost value (port path cost) because it is linked up at 100 Mbps. Further, They set 2000000 to the port in the path 92 side as a cost value (port path cost) because it is linked up at 10 Mbps.

Upon completing the setting of the port path cost of each path, the STPs within the bridge 5 and the bridge 6 transmit the BPDU to each port, and advertise topology information. Theses BPDUs pass through the relay apparatus as they stand, and arrive at the bridge 6 and the bridge 5, respectively.

The STPs within the bridge 5 and the bridge 6 receive the BPDU from the STPs within the bridge 6 and the bridge 5 and compute the cost (path cost) path by path, respectively. At this time, the STPs within the bridge 5 and the bridge 6, which do not grasp existence of the relay apparatus 1 to the relay apparatus 4, recognize that the bridge 5 and the bridge 6 have been connected by two paths of the path 91 of which the band is 100 Mbps, and the path 92 of which the band is 10 Mbps.

For this, the bridge 6 closes the port in the path 92 side to prevent the frame to be transmitted/received to/from the port in the path 92 side. That is, communication between the bridge 5 and the bridge 6 results in being all made through the path 91.

Upon comparing the maximum band (1 Mbps) of the path 91 and the maximum band (10 Mbps) of the path 92, the latter is larger. Thus, originally, the path 92 is due to be selected as an optimal path; however the path 91 results in being selected when the related art is employed.

[Non-patent document 1] 1EEE P802. 1D/D4 Draft Standard for Local and Metropolitan Area Networks: Media Access Control (MAC) Bridges, P. 148 Table 17-3 Port Path Cost values

[Patent document 1] WO2004/066563

[Patent document 2] JP-P2006-109188A

As is the case with the related art 2 explained above, utilizing the STP between the LANs (user networks etc.) striding over the WAN (carrier network etc.) causes four problems that are listed below.

(1) In a case where a difference exists between an actually utilizable rate (a band of the bottleneck) over the path and a link rate of the connection link of the apparatus (the bridge etc.) in which the path control protocol (STP etc.) operates, a cost is computed erroneously, an optimum path is not selected, and an efficiency of the net utilization declines.

(2) The practice for setting/changing the appliance in which the path control protocol operates in conformity to the band of the bottleneck is complicated.

(3) The band of the bottleneck cannot be grasped when no bottleneck exists in the connection link of the relay apparatus.

(4) The bottleneck band cannot be grasped when a band of a WAN line fluctuates in some cases and a link-up rate differs from a band of the bottleneck within a WAN net in some cases.

Additionally, two problems as well to be listed below, which were not pointed out specifically in the related art 2 explained above, exist simultaneously therewith.

(5) The path selection in which a low delay takes priority over a wide band cannot be made.

(6) The link to which the VLANs are concentratedly set is selected as a path, which causes fairness among the VLANs to be lost, and an efficiency of the net utilization to decline.

Further, the related art 3 necessitates taking various controls in the bridge, which causes a lot of the load to be imposed upon the bridge, and a communication ability to be lowered.

### SUMMARY OF THE INVENTION

Thereupon, the present invention has been accomplished in consideration of the above-mentioned problems, and an exemplary object thereof is to provide the technology that makes it possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a connection link by a physical band of the connection link operates, exists.

The present invention for solving the above-mentioned problems, which is a relay apparatus, is characterized in: including a cost rewriter for, based upon a rate of a bottleneck out of a link rate of a first transfer apparatus for transmitting a root path cost, a link rate of a second transfer apparatus for selecting a path based upon the root path cost, and a transfer rate of a WAN, rewriting the root path cost; and being provided between the first transfer apparatus and the second transfer apparatus.

The present invention for solving the above-mentioned problems, which is a relay apparatus provided between transfer apparatuses for selecting a path based upon a link rate of a connection link, is characterized in including a controller for controlling a transfer rate of a WAN-side port, or a link rate of a LAN-side port in conformity to either a transfer rate of a WAN or a link rate of a connection link of the transfer apparatus, whichever is lower.

The present invention for solving the above-mentioned problems, which is a path selecting system, is characterized: in including a cost rewriter provided between a first transfer apparatus for transmitting a root path cost and a second transfer apparatus for selecting a path based upon the root path cost, which is characterized in rewriting the root path cost by pre-subtracting a cost that is added up in the second transfer apparatus; and that the second transfer apparatus selects a path based upon the root path cost from the cost rewriter of each path.

The present invention for solving the above-mentioned problems, which is a path selecting system, is characterized in including: a changer for, in conformity to either a transfer rate of a WAN or a link rate of a connection link, whichever is lower, changing the link rate of the connection link; a transfer apparatus for transmitting a root path cost based upon the changed link rate of the connection link; and a second transfer apparatus for selecting a path based upon the root path cost of each path.

The present invention for solving the above-mentioned problems, which is a path selection method of selecting a path based upon a root path cost, is characterized in including: a cost rewrite step of rewriting the root path cost based upon a rate of a bottleneck out of a link rate of a first transfer apparatus for transmitting the root path cost, a link rate of a connection link of a second transfer apparatus for selecting a path based upon the root path cost, and a transfer rate of a WAN; and a step of collecting the rewritten root path cost from each path and selecting a path based upon this collected root path cost.

The present invention for solving the above-mentioned problems, which is a path selection method, is characterized in including: a change step of, in conformity to either a transfer rate of a WAN or a link rate of a connection link, whichever is lower, changing the link rate of the connection link; a transmission step of transmitting a root path cost based upon the changed link rate of the connection link; and a selection step of selecting a path based upon the root path cost that is transmitted from each path.

The present invention for solving the above-mentioned problems, which is a program of a relay apparatus provided between a first transfer apparatus for transmitting a root path cost and a second transfer apparatus for selecting a path based upon the root path cost, is characterized in causing the relay apparatus to function as a cost rewriter for rewriting the root path cost based upon a rate of a bottleneck out of a link rate of the first transfer apparatus, a link rate of a connection link of the second transfer apparatus, and a transfer rate of a WAN.

The present invention for solving the above-mentioned problems, which is a program of a relay apparatus provided between transfer apparatuses for selecting a path based upon a link rate of a connection link, is characterized in causing the relay apparatus to function as a controller for controlling a transfer rate of a WAN-side port or a link rate of a LAN-side port in conformity to either a transfer rate of a WAN or the link rate of the connection link of the transfer apparatus, whichever is lower.

The relay apparatus of the present invention for solving the above-mentioned problems includes: a port manager for, upon receipt of a notification of the link rate from a port, investigating which side, out of the WAN side and the LAN side, becomes a bottleneck; a cost rewriter for rewriting a root path cost field within the BPDU in conformity to a rate of the bottleneck notified from the port manager; and a transfer controller for deciding an output port, appropriately buffering it, and thereafter transmitting it with a destination MAC address, an input port, additional information of the frame arriving from the port and the cost rewriter assumed to be a key, respectively.

Adopting such a configuration allows the port manager within the relay apparatus, upon receipt of a notification of the link rate from the port, to investigate which side, out of the WAN side and the LAN side, becomes a bottleneck, the cost rewriter within the relay apparatus to rewrite the root path cost field within the BPDU in conformity to the rate of the bottleneck and to reflect a band of the bottleneck into the cost, and the path control protocol (STP etc.) for automatically computing a cost of the link by a physical band of the connection link to select an optimal path, and to enhance an efficiency of the net utilization, which makes it possible to accomplish an exemplary object of the present invention.

The relay apparatus of the present invention for solving the above-mentioned problems includes: a port manager for, upon receipt of a notification of the link rate from the port, investigating which side, out of the WAN side and the LAN side, becomes a bottleneck; a cost rewriter for rewriting the root path cost field within the BPDU in conformity to the rate of the bottleneck notified from the port manager; a rate notifier for notifying the latest rate of the bottleneck of its own notified from the port manager to the relay apparatus facing its own relay apparatus, and contrarily, for receiving a notification from the relay apparatus facing its own relay apparatus and notifying it to the port manager; and a transfer controller for deciding an output port, appropriately buffering it, and thereafter transmitting it with a destination MAC address, an input port, additional information of the frame arriving from the port, the cost rewriter, and the rate notifier assumed to be a key, respectively.

Adopting such a configuration allows the rate notifier within the relay apparatus to notify the latest rate of the bottleneck of its own to the relay apparatus facing its own relay apparatus, and contrarily to receives a notification from the relay apparatus facing its own relay apparatus and to notify it to the port manager, and the port manager within the relay apparatus, upon receipt of a notification of the link rate from the port, to investigate which side, out of the WAN side and the LAN side, becomes a bottleneck, the cost rewriter within the relay apparatus to rewrite the root path cost field within the BPDU in conformity to the rate of the bottleneck and to reflect an actually utilizable rate (a band of the bottleneck) in the path between the bridges etc. into the cost, and the path control protocol (STP etc.) for automatically computing a cost of the link by a physical band of the connection link to select an optimal path, and to enhance an efficiency of the net utilization, which makes it possible to accomplish an exemplary object of the present invention.

The relay apparatus of the present invention for solving the above-mentioned problems includes: a port manager for, upon receipt of a notification of the link rate from the port, investigating which side, out of the WAN side and the LAN side, becomes a bottleneck; a cost rewriter for rewriting the root path cost field within the BPDU in conformity to the rate of the bottleneck notified from the port manager; a rate delay measurer for, upon receipt of a notification of a link-up of the WAN-side port, measuring a band of the WAN by transmitting/receiving a measurement frame to/from the relay apparatus facing its own relay apparatus, and notifying the WAN rate to the port manager; a transfer controller for deciding an output port, appropriately buffering it, and thereafter transmitting it with a destination MAC address, an input port, additional information of the frame arriving from the port, the cost rewriter, and the rate delay measurer assumed to be a key, respectively.

Adopting such a configuration allows the rate delay measurer within the relay apparatus to measure a band of the WAN by transmitting/receiving a measurement frame, the port manager within the relay apparatus, upon receipt of a notification of the link rate from the port, to investigate which side, out of the WAN side and the LAN side, becomes a bottleneck, and the cost rewriter within the relay apparatus to rewrite the root path cost field within the BPDU in conformity to the rate of the bottleneck and to reflect an actually utilizable rate (a band of the bottleneck) in the path between the bridges etc. into the cost, and the path control protocol (STP etc.) for automatically computing a cost of the link by a physical band of the connection link to select an optimal path, and to enhance an efficiency of the net utilization, which makes it possible to accomplish an exemplary object of the present invention.

The relay apparatus of the present invention for solving the above-mentioned problems includes: a port manager for, upon receipt of a notification of the link rate from the port, investigating which side, out of the WAN side and the LAN side, becomes a bottleneck; a cost rewriter for rewriting the root path cost field within the BPDU in conformity to the rate of the bottleneck notified from the port manager; a rate notifier for notifying the latest rate of the bottleneck of its own notified from the port manager to the relay apparatus facing its own relay apparatus, and contrarily for receiving a notification from the relay apparatus facing its own relay apparatus and notifying it to the port manager; a rate delay measurer for, upon receipt of a notification of a link-up of the WAN-side port, measuring a band of the WAN by transmitting/receiving a measurement frame to/from the relay apparatus facing its own relay apparatus, and notifying the WAN rate to the port manager; and a transfer controller for deciding an output port, appropriately buffering it, and thereafter transmitting it with a destination MAC address, an input port, additional information of the frame arriving from the port, the cost rewriter, the rate notifier, and the rate delay measurer assumed to be a key, respectively.

Adopting such a configuration allows the rate delay measurer within the relay apparatus to measure a band of the WAN by transmitting/receiving a measurement frame, the rate notifier within the relay apparatus to notify the latest rate of the bottleneck of its own to the relay apparatus facing its own relay apparatus, and contrarily, to receive a notification from the relay apparatus facing its own relay apparatus and to notify it to the port manager, the port manager within the relay apparatus, upon receipt of a notification of the link rate from the port, to investigate which side, out of the WAN side and the LAN side, becomes a bottleneck, and the cost rewriter within the relay apparatus to rewrite the root path cost field within the BPDU in conformity to the rate of the bottleneck and to reflect an actually utilizable rate (band of the bottleneck) in the path between the bridges etc. into the cost, and the path control protocol (STP etc.) for automatically computing a cost of the link by a physical band of the connection link to select an optimal path, and to enhance an efficiency of the net utilization, which makes it possible to accomplish an exemplary object of the present invention.

The relay apparatus of the present invention for solving the above-mentioned problems includes: a port manager for, upon receipt of a notification of the link rate from the port, investigating which side, out of the WAN side and the LAN side, becomes a bottleneck; a cost rewriter for rewriting the root path cost field within the BPDU in conformity to the rate of the bottleneck notified from the port manager; a rate delay measurer for, upon receipt of a notification of a link-up of the WAN-side port, measuring a band of the WAN by transmitting/receiving a measurement frame to/from a relay apparatus facing its own relay apparatus, and notifying the WAN rate to the port manager; a result manager for broadcasting a delay notified from the rate delay measurer to the other relay apparatuses within a net and for, contrarily, receiving a notification of a delay quantity from the other relay apparatuses within a net, converting its relative delay into a band (rate), and thereafter notifying it to the port manager; and a transfer controller for deciding an output port, appropriately buffering it, and thereafter transmitting it with a destination MAC address, an input port, additional information of the frame arriving from the port, the cost rewriter, the rate delay measurer, and the result manager assumed to be a key, respectively.

Adopting such a configuration allows the rate delay measurer within the relay apparatus to measure a delay of the WAN by transmitting/receiving a measurement frame, the result manager within the relay apparatus to broadcast a delay notified from the rate delay measurer to the other relay apparatuses within a net, and contrarily, to receive a notification of a delay quantity from the other relay apparatuses within a net, to convert its relative delay into a band (rate), and thereafter to notify it to the port manager, the port manager within the relay apparatus, upon receipt of a notification of the link rate from the port, to investigate which side, out of the WAN side and the LAN side, becomes a bottleneck, and the cost rewriter within the relay apparatus to rewrite the root path cost field within the BPDU in conformity to the rate of the bottleneck and to reflect an actually utilizable rate (band of the bottleneck) in the path between the bridges etc. into the cost, and the path control protocol (STP etc.) for automatically computing a cost of the link by a physical band of the connection link to select an optimal path, and to enhance an efficiency of the net utilization, which makes it possible to accomplish an exemplary object of the present invention.

The relay apparatus of the present invention for solving the above-mentioned problems includes: a port manager for receiving a notification of the link rate from the port; a cost rewriter for rewriting the root path cost field within the BPDU in conformity to the link rate notified from the port manager; and a transfer controller for deciding an output port, appropriately buffering it, and thereafter transmitting it with a destination MAC address, an input port and additional information of the frame arriving from the port and the cost rewriter assumed to be a key, respectively.

Adopting such a configuration allows the port manager within the relay apparatus to receive a notification of the link rate from the port, and the cost rewriter within the relay apparatus to rewrite the root path cost field within the BPDU in conformity to the rate of the input/output link and to reflect the band of the bottleneck into the cost, the path control protocol (STP etc.) for automatically computing a cost of the link by a physical band of the connection link to select an optimal path, and enhance an efficiency of the net utilization, which makes it possible to accomplish an exemplary object of the present invention.

The relay apparatus of the present invention for solving the above-mentioned problems includes: a port manager for, upon receipt of a notification of the link rate from the port, investigating which side, out of the WAN side and the LAN side, becomes a bottleneck; a cost rewriter for rewriting the root path cost field within the BPDU in conformity to the rate of the bottleneck notified from the port manager; and a transfer controller for deciding an output port, appropriately buffering it, and thereafter transmitting it with a destination MAC address, an input port and additional information of the frame arriving from the port and the cost rewriter assumed to be a key, respectively.

Adopting such a configuration allows the port manager within the relay apparatus, upon receipt of a notification of the link rate from the port, to investigate which side, out of the WAN side and the LAN side, becomes a bottleneck, and the cost rewriter within the relay apparatus to rewrite the root path cost field within the BPDU in conformity to the rate of the bottleneck and a by-VLAN band utilization ratio and to reflect the band of the bottleneck into the cost, the path control protocol (STP etc.) for automatically computing a cost of the link by a physical band of the connection link to select an optimal path, and enhance an efficiency of the net utilization, which makes it possible to accomplish an exemplary object of the present invention.

The relay apparatus of the present invention for solving the above-mentioned problems includes: a port manager for, upon receipt of a notification of the link rate from a port, investigating which side, out of the WAN side and the LAN side, becomes a bottleneck, and controlling the link rate in conformity to either a WAN-side link rate or a LAN-side link rate, whichever is lower; the port for, upon receipt of an instruction from the port manager, changing the link rate, and further notifying the link rate to the port manager; and a transfer controller for appropriately buffering the frame arriving from the port, and thereafter transmitting it.

Adopting such a configuration allows the port manager within the relay apparatus, upon receipt of a notification of the link rate from the port, to investigate which side, out of the WAN side and the LAN side, becomes a bottleneck, and in addition hereto, to control the link rate in conformity to either the WAN-side link rate or the LAN-side link rate, whichever is lower, and to reflect the band of the bottleneck into the cost, and the path control protocol (STP etc.) for automatically computing a cost of the link by a physical band of the connection link to select an optimal path and to enhance an efficiency of the net utilization, which makes it possible to accomplish an exemplary object of the present invention.

The relay apparatus of the present invention for solving the above-mentioned problems includes: a port manager for, upon receipt of a notification of the link rate from a port, investigating which side, out of the WAN side and the LAN side, becomes a bottleneck, and controlling the link rate in conformity to either the WAN-side link rate or the LAN-side link rate, whichever is lower; the port for, upon receipt of an instruction from the port manager, changing the link rate, and further notifying the link rate to the port manager; a rate delay measurer for, upon receipt of a notification of the link-up of the WAN-side port, measuring a band of the WAN by transmitting/receiving a measurement frame to/from the relay apparatus facing its own relay apparatus, and notifying the WAN rate to the port manager; and a transfer controller for deciding an output port, appropriately buffering it, and thereafter transmitting it with a destination MAC address and an input port of the frame arriving from the port and the rate delay measurer assumed to be a key, respectively.

Adopting such a configuration allows the rate delay measurer in the relay apparatus to measure a band of the WAN by transmitting/receiving a measurement frame, the port manager within the relay apparatus, upon receipt of a notification of the link rate from the port, to investigate which side, out of the WAN side and the LAN side, becomes a bottleneck, and in addition hereto, to control the link rate in conformity to either the WAN-side link rate or the LAN-side link rate, whichever is lower, and to reflect the band of the bottleneck into the cost, and the path control protocol (STP etc.) for automatically computing a cost of the link by a physical band of the connection link to select an optimal path and enhance an efficiency of the net utilization, which makes it possible to accomplish an exemplary object of the present invention.

The relay apparatus of the present invention for solving the above-mentioned problems includes: a port manager for, upon receipt of a notification of the link rate from a port, investigating which side, out of the WAN side and the LAN side, becomes a bottleneck, and controlling the link rate in conformity to either the WAN-side link rate or the LAN-side link rate, whichever is lower; the port for, upon receipt of an instruction from the port manager, changing the link rate, and further notifying the link rate to the port manager; a rate notifier for notifying the latest rate of the bottleneck of its own notified from the port manager to the relay apparatus facing its own relay apparatus, and contrarily, for receiving a notification from the relay apparatus facing its own relay apparatus and notifying it to the port manager; a rate delay measurer for, upon receipt of a notification of the link-up of the WAN-side port, measuring a band of the WAN by transmitting/receiving a measurement frame to/from the relay apparatus facing its own relay apparatus, and notifying the WAN rate to the port manager; and a transfer controller for deciding an output port, appropriately buffering it, and thereafter transmitting it with a destination MAC address and an input port of the frame arriving from the port, the rate notifier, and the rate delay measurer assumed to be a key, respectively.

Adopting such a configuration allows the a rate delay measurer in the relay apparatus to measure a band of the WAN by transmitting/receiving a measurement frame, the rate notifier within the relay apparatus to notify the latest rate of the bottleneck of its own to the relay apparatus facing its own relay apparatus, and contrarily, to receive a notification from the relay apparatus facing its own relay apparatus, and to notify it to the port manager, the port manager within the relay apparatus, upon receipt of a notification of the link rate from the port, to investigate which side, out of the WAN side and the LAN side, becomes a bottleneck, to control the link rate in conformity to either the WAN-side link rate or the LAN-side link rate, whichever is lower, and to reflect the band of the bottleneck into the cost, and the path control protocol (STP etc.) for automatically computing a cost of the link by a physical band of the connection link to select an optimal path and to enhance an efficiency of the net utilization, which makes it possible to accomplish an exemplary object of the present invention.

The relay apparatus of the present invention for solving the above-mentioned problems includes: a port manager for, upon receipt of a notification of the link rate from a port, investigating which side, out of the WAN side and the LAN side, becomes a bottleneck, and controlling the link rate in conformity to either the WAN-side link rate or the LAN-side link rate, whichever is lower; the port for, upon receipt of an instruction from the port manager, changing the link rate, and further notifying the link rate to the port manager; a rate delay measurer for, upon receipt of a notification of the link-up of the WAN-side port, measuring a band of the WAN by transmitting/receiving a measurement frame to/from the relay apparatus facing its own relay apparatus, and notifying the WAN rate to the port manager: a result manager for broadcasting a delay notified from the rate delay measurer to the other relay apparatuses within a net, and for contrarily, receiving a notification of a delay quantity from the other relay apparatuses within a net, converting its relative delay into a band (rate), and thereafter notifying it to the port manager; and a transfer controller for deciding an output port, appropriately buffering it, and thereafter transmitting it with a destination MAC address and an input port of the frame arriving from the port, the result manager and the rate delay measurer assumed to be a key, respectively.

Adopting such a configuration allows the rate delay measurer in the relay apparatus to measure a delay of the WAN by transmitting/receiving a measurement frame, the result manager within the relay apparatus to broadcast a delay notified from the rate delay measurer to the other relay apparatus within a network, and contrarily, to receive a notification of a delay quantity from the other relay apparatuses within a net, to convert its relative delay into a band (rate), and thereafter to notify it to the port manager, the port manager within the relay apparatus, upon receipt of a notification of the link rate from the port, to investigate which side, out of the WAN side and the LAN side, becomes a bottleneck, and in addition hereto, to control the link rate in conformity to either the WAN-side link rate or the LAN-side link rate, whichever is lower, and to reflect the band of the bottleneck into the cost, and the path control protocol (STP etc.) for automatically computing a cost of the link by a physical band of the connection link to select an optimal path and to enhance an efficiency of the net utilization, which makes it possible to accomplish an exemplary object of the present invention.

### BRIEF DESCRIPTION OF THE DRAWINGS

This and other objects, features and advantages of the present invention will become more apparent upon a reading of the following detailed description and drawings, in which:

FIG. 1 is a block diagram illustrating a network configuration based upon the related art 1 and the related art 2;

FIG. 2 is a block diagram illustrating a configuration of a first exemplary embodiment of the present invention;

FIG. 3 is a table illustrating a table configuration in a transfer controller 13;

FIG. 4 is a table illustrating a table configuration in a port manager 14;

FIG. 5 is a table illustrating a table configuration in a cost rewriter 15;

FIG. 6 is a block diagram illustrating a configuration of a second exemplary embodiment of the present invention;

FIG. 7 is a table illustrating a table configuration in a transfer controller 13A;

FIG. 8 is a table illustrating a table configuration in a port manager 14A;

FIG. 9 is a block diagram illustrating a configuration of a third exemplary embodiment of the present invention;

FIG. 10 is a table illustrating a table configuration in a transfer controller 13B;

FIG. 11 is a block diagram illustrating a configuration of a fourth exemplary embodiment of the present invention;

FIG. 12 is a table illustrating a table configuration in a transfer controller 13C;

FIG. 13 is a table illustrating a setting example of a cost rewriter 15A in a fifth exemplary embodiment of the present invention;

FIG. 14 is a block diagram illustrating a configuration of a sixth exemplary embodiment of the present invention;

FIG. 15 is a table illustrating a table configuration in a port manager 14D;

FIG. 16 is a block diagram illustrating a configuration of an example 2 in the sixth exemplary embodiment of the present invention;

FIG. 17 is a block diagram illustrating a configuration of a seventh exemplary embodiment of the present invention;

FIG. 18 is a table illustrating a table configuration in a transfer controller 13E;

FIG. 19 is a table illustrating a table configuration in a port manager 14E;

FIG. 20 is a block diagram illustrating a configuration of an eighth exemplary embodiment of the present invention; and

FIG. 21 is a table illustrating a table configuration in a cost rewriter 15F.

### EXEMPLARY EMBODIMENTS

So as to explain characteristics of the present invention, hereinafter, they will be described specifically by making a reference to the accompanied drawings.

The first exemplary embodiment for carrying out the present invention will be explained in details by making a reference to the accompanied drawings.

### First Exemplary Embodiment

In the first exemplary embodiment of the present invention, in a net in which the apparatus (bridge etc.) in which a path control protocol (STP etc.) for automatically computing a cost of a link by a physical band of the connection link operates exists, in a case where a difference exists between an actually utilizable rate (a band of the bottleneck) in the path between the bridges etc. and a link rate of the connection link such as the bridge etc., the relay apparatus (a transfer apparatus, a tunnel apparatus, or the like) that is inserted between the bridges etc., upon receipt of a notification of the link rate from the port, investigates which side, out of the WAN side and the LAN side, becomes a bottleneck, and in addition hereto, snoops the BPDU to rewrite the root path cost field within the BPDU in conformity to the rate of the bottleneck, thereby allowing the band of the bottleneck to be reflected into the cost, an optimal path to be selected, and an efficiency of the net utilization to be enhanced without making a setting or a modification to the apparatus (bridge etc.) in which the path control protocol operates.

(Explanation of a Configuration)

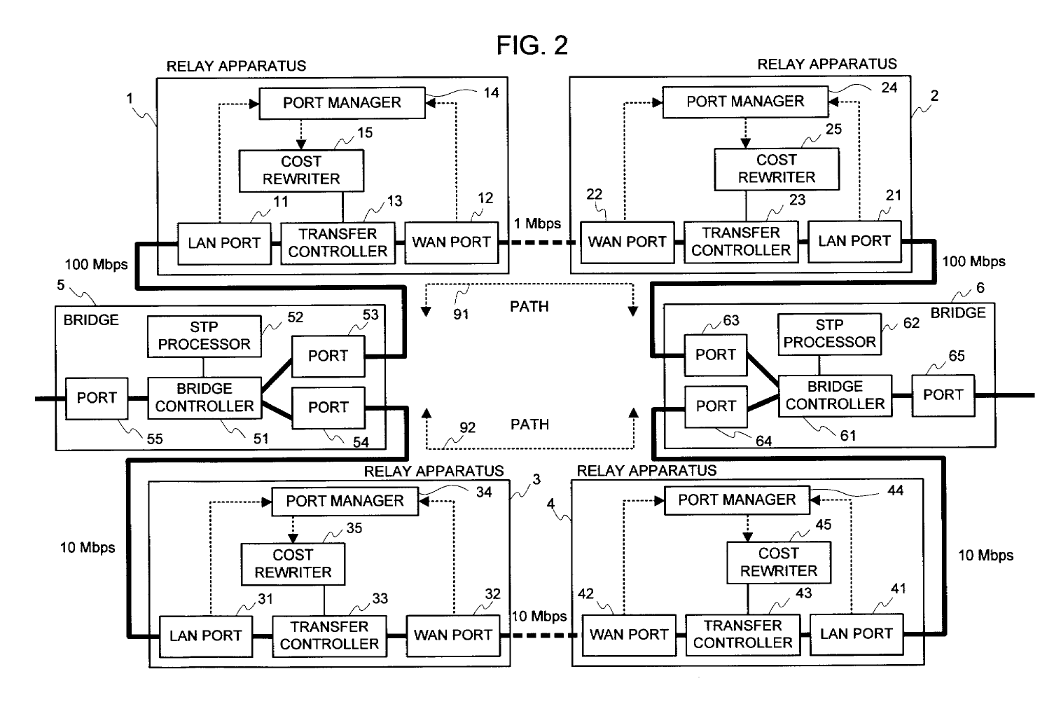

A configuration in this exemplary embodiment will be explained by making a reference to FIG. 2.

A relay apparatus 1 is an apparatus for relaying between a Local Area Network (LAN) and a Wide Area Network (WAN).

The relay apparatus 1 is an apparatus generally called, for example, a transfer apparatus or a tunnel apparatus. The relay apparatus 1 adds or deletes a header, a tag, a flag, or the like necessary for connecting the LAN such as a user network and the WAN such as a carrier network responding to a necessity. In addition hereto, the relay apparatus 1 makes a buffering for a purpose of absorbing a rate difference between the LAN and the WAN responding to a necessity, and executes encoding and decoding for extending a transmission distance responding to a necessity. Further, the relay apparatus 1 does not perform a process of the Spanning Tree Protocol (BPDU transmission). For this, the STP, which cannot grasp existence of the relay apparatus 1, does not take the relay apparatus 1 into consideration at the time of computing the path.

Each of relay apparatuses 2 to 4 is a relay apparatus similar to the relay apparatus 1.

A bridge 5, which is generally called a switch or a switching hub, is an apparatus for accommodating a plurality of ports, and deciding a transferee port by a destination MAC address of the frame that was input. The bridge 5, which corresponds to the Spanning Tree Protocol (STP), receives/transmits the STP control frame (BPDU) and prepares a tree with the other bridges.

A bridge 6 is a bridge similar to the bridge 5.

A path 91 is a path that goes through the relay apparatus 1 and the relay apparatus 2 from the bridge 5 and reaches the bridge 6.

A path 92 is a path that goes through the relay apparatus 3 and the relay apparatus 4 from the bridge 5 and reaches the bridge 6.

Herein, a configuration of the relay apparatus 1 will be explained in details.

The relay apparatus 1 includes a LAN PORT 11, a WAN PORT 12, a transfer controller 13, a port manager 14, and a cost rewriter 15.

The LAN PORT 11, which is a port for accommodating an Ethernet link in a side of the LAN, being a user network, notifies a link rate to the port manager 14 at the time of a link-up, and in addition hereto, notifies the fact that link communication has been lost to the port manager 14 at the time of a link-down.

The WAN PORT 12, which is a port for accommodating a link (Ethernet etc.) in a side of the WAN, being a carrier network, notifies a link rate to the port manager 14 at the time of a link-up, and in addition hereto, notifies the fact that link communication has been lost to the port manager 14 at the time of a link-down. Further, the WAN PORT 12 makes a conversion from electric signal into an optical signal, and performs the process such as encoding and decoding for extending a transmission distance, or the like responding to a necessity. The link rate that is mentioned herein includes not only a link-up rate of Ethernet, but also an ADSL link-up rate, a rate of modem negotiation, a rate of RS 232, USB or the like, a link rate of a wireless protocol, and so on.

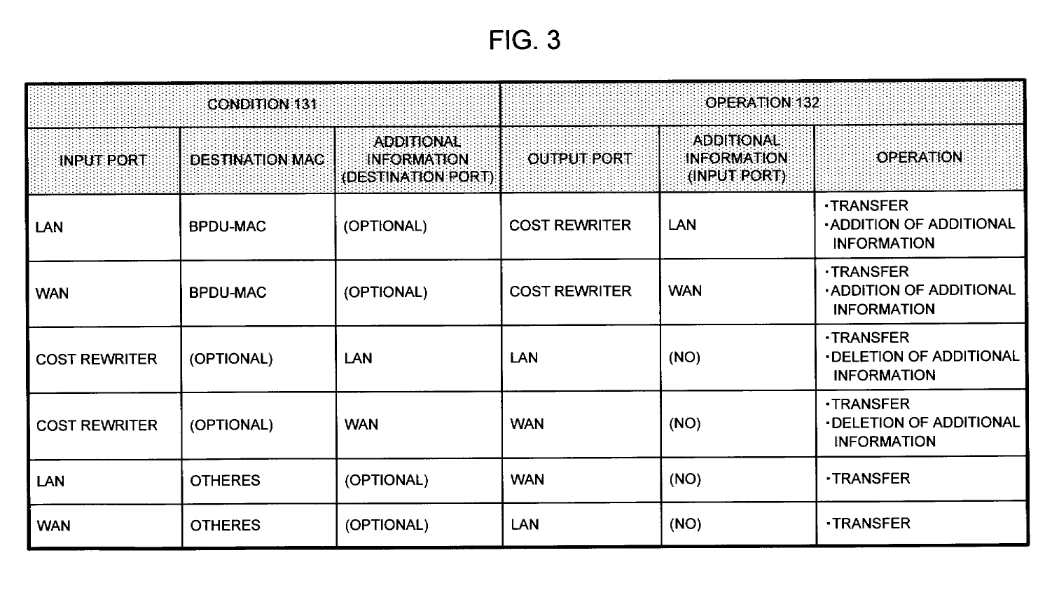

In a case of having received the frame from the LAN PORT 11, the WAN PORT 12, and the cost rewriter 15, the transfer controller 13 makes a reference to the input port, the destination MAC address, and the destination port thereof, decides an operation, an output port, or the like according to a table shown in FIG. 3 and transfers the frame to the LAN PORT 11, the WAN PORT 12, and the cost rewriter 15. Further, the transfer controller 13 adds or deletes a header, a tag, a flag, or the like for a purpose of constructing a tunnel with the relay apparatus (relay apparatus 2) facing its own relay apparatus responding to a necessity. In addition hereto, it makes a buffering as well for a purpose of avoiding a frame collision, and further absorbing a rate difference between the LAN and the WAN.

When a BPDU frame is input from the LAN PORT 11 or the WAN PORT 12, the transfer controller 13 adds input port identification information (LAN PORT 11 or the WAN PORT 12) as additional information to the BPDU frame, and transfers it to the cost rewriter 15. Further, the transfer controller 13 receives the BPDU frame to which destination port identification information (LAN PORT 11 or the WAN PORT 12) has been added from the cost rewriter 15, and transfers it to a designated output port (the LAN PORT 11 or the WAN PORT 12). At this time, it deletes the output port identification information, and thereafter transfers it.

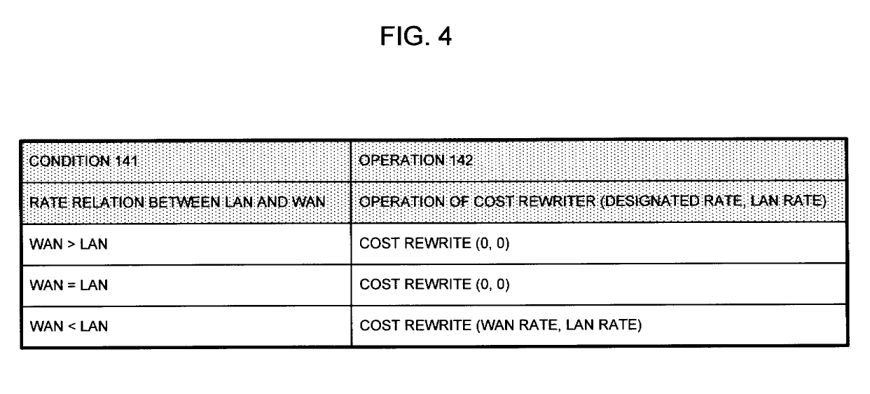

The port manager 14 receives a notification of the link rate from the LAN PORT 11 and the WAN PORT 12 at the time of a link-up and at the time of a link-down, decides an operation according to a table shown in FIG. 4, and conveys parameters (a designated rate and an LAN rate) necessary for rewriting the BPDU frame to the cost rewriter 15. Further, the notified rate is preserved until the next notification is issued. Further, the port manager 14 decides an operation according to the table shown in FIG. 4 by employing the rate information preserved owing to the notification received in the past, and conveys the parameters (the designated rate and the LAN rate) necessary for rewriting the BPDU frame to the cost rewriter 15 for each constant time period.

The cost rewriter 15 receives a notification of the parameters (the designated rate and the LAN rate) necessary for rewriting the BPDU frame from the cost manager 14, preserves these parameters until the next notification is issued, and utilizes them at the time of rewriting. Additionally, it stops the rewriting when 0 is set to at least one of the designated rate and the LAN rate. The so-called designated rate, which is a rate that should be employed for computing the cost, as a rule, is a rate of a bottlenecked link over the path. Further, the LAN rate is notified for a purpose of pre-subtracting the cost that the bridge would add.

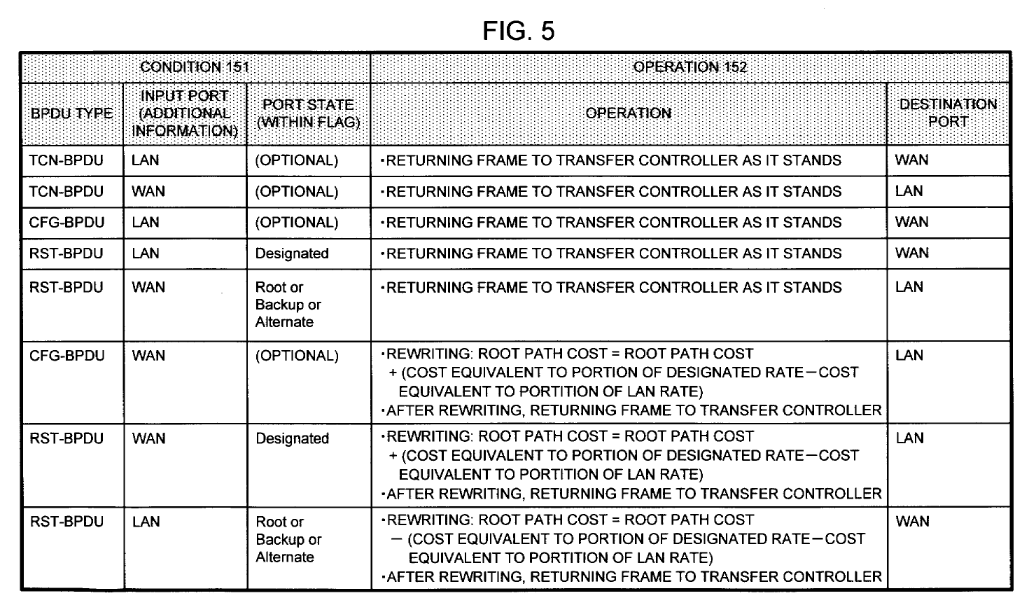

In a case of having received the BPDU frame and the additional information (input port) from transfer controller 13, the cost rewriter 15 decides an operation and a destination port according to a table shown in FIG. 5 based upon type information (BPDU type) within the BPDU frame, a port state (Port Role) within a “Flags” field of the BPDU frame, and in addition hereto, the input port, being additional information. If the rewrite process is required, the cost rewriter 15 rewrites the cost recorded in a “Root Path Cost” field within the BPDU frame. And, it adds the destination port information as additional information, and returns it to the transfer controller 13 as a replay. Additionally, it transfers the frame (LAN→WAN, WAN→LAN) as it stands without performing the rewriting in a case where 0 has been set to at least one of the designated rate and the LAN rate.

Continuously, the relay apparatus 2 will be explained.

A LAN PORT 21, which has a configuration similar to that of the LAN PORT 11, performs a similar operation.

A WAN PORT 22, which has a configuration similar to that of the WAN PORT 12, performs a similar operation.

A transfer controller 23, which has a configuration similar to that of the transfer controller 13, performs a similar operation.

A port manager 24, which has a configuration similar to that of the port manager 14, performs a similar operation.

A cost rewriter 25, which has a configuration similar to that of the cost rewriter 15, performs a similar operation.

Continuously, a configuration of the relay apparatus 3 will be explained.

A LAN PORT 31, which has a configuration similar to that of the LAN PORT 11, performs a similar operation.

A WAN PORT 32, which has a configuration similar to that of the WAN PORT 12, performs a similar operation.

A transfer controller 33, which has a configuration similar to that of the transfer controller 13, performs a similar operation.

A port manager 34, which has a configuration similar to that of the port manager 14, performs a similar operation.

A cost rewriter 35, which has a configuration similar to that of the cost rewriter 15, performs a similar operation.

Continuously, a configuration of the relay apparatus 4 will be explained.

A LAN PORT 41, which has a configuration similar to that of the LAN PORT 11, performs a similar operation.

A WAN PORT 42, which has a configuration similar to that of the WAN PORT 12, performs a similar operation.

A transfer controller 43, which has a configuration similar to that of the transfer controller 13, performs a similar operation.

A port manager 44, which has a configuration similar to that of the port manager 14, performs a similar operation.

A cost rewriter 45, which has a configuration similar to that of the cost rewriter 15, performs a similar operation.

Continuously, a configuration of the bridge 5 will be explained.

The bridge 5 includes a bridge controller 51, an STP processor 52, a PORT 53, a PORT 54, and a PORT 55.

The bridge controller 51 receives the frame from the PORT 53, the PORT 54, the PORT 55 and the STP processor 52, makes a reference to the input port and the destination MAC address thereof, decides an output port, and transfers the frame to any of the PORT 53, the PORT 54, the PORT 55 and the STP processor 52. At this time, it also broadcasts the frame responding to a necessity. In addition hereto, it makes a buffering as well for a purpose of avoiding a frame collision and further absorbing a rate difference between each of the ports and the other.

Further, when the BPDU frame is input from any of the PORT 53 to PORT 55, the bridge controller 51 transfers it to the STP processor 52. Further, in a case of having received the BPDU frame from the STP processor 52, the bridge controller 51 outputs the BPDU frame from the port designated by the STP processor 52.

The STP processor 52 transmits/receives the BPDU frame to/from the bridge controller 51, and performs the process of the Spanning Tree Protocol in the bridge 5.

The PORT 53 is a port for accommodating an Ethernet link.

The PORT 54 is a port for accommodating an Ethernet link.

The PORT 55 is a port for accommodating an Ethernet link.

Continuously, a configuration of the bridge 6 will be explained.

A bridge controller 61, which has a configuration similar to that of the bridge controller 51, performs a similar operation.

An STP processor 62, which has a configuration similar to that of the STP processor 52, performs a similar operation.

A PORT 63, which has a configuration similar to that of the PORT 53, performs a similar operation.

A PORT 64, which has a configuration similar to that of the PORT 54, performs a similar operation.

A PORT 65, which has a configuration similar to that of the PORT 55, performs a similar operation.

Herein, the details of the transfer controller 13 will be explained.

FIG. 3 is a table to which the transfer controller 13 in the first exemplary embodiment makes a reference for a purpose of deciding a transferee (output port) of the frame, additional information, and an operation at the moment of having received the frame from each port.

A condition 131 is an index (a key) for retrieving an operation 132 responding to the input frame. There are items of the input port, the destination MAC, and the additional information in the condition 131. The transfer controller 13 decides the operation 132 by making a reference to the additional information responding to the input port and the destination MAC of the input frame in some cases, and by making a reference to the additional information when the frame is input from the cost rewriter 15 in some cases.

The operation 132 is an operation that is retrieved with the condition 131 assumed to be an index. There are items of the output port, the additional information and the operation in the operation 132. The transfer controller 13 handles the frame according to the content described in the operation 132.

Next, the details of the port manager 14 will be explained.

FIG. 4 is a table to which the port manager 14 in the first exemplary embodiment makes a reference for a purpose of deciding an operation at the moment of having received a link-up rate from the port.

A condition 141 is an index (a key) for retrieving an operation 142 responding to the link-up rate notified from the port. There are an item of a rate relation between the LAN and the WAN in the condition 141. The port manager 14 searches the condition 141 at the time of receiving a notification of the link-up rate from the LAN PORT 11 and the WAN PORT 12, and decides an operation 142.

The operation 142 is an operation that is retrieved with the condition 141 assumed to be an index. The instruction as to which rate is employed to rewrite the cost in a case of requesting of the cost rewriter 15 the cost rewrite is described in the operation 142. Additionally, when the port manager 14 instructs the cost rewriter 15 to rewrite the cost, it notifies the designated rate, being a rate that becomes a reference for computing the cost, and the LAN rate, being a rate that becomes a reference for forecasting the cost that the LAN-side appliance would add.

Next, the details of the cost rewriter 15 will be explained.

FIG. 5 is a table to which the cost rewriter 15 in the first exemplary embodiment makes a reference for a purpose of deciding how to handle the BPDU frame at the moment of having received the BPDU frame from the transfer controller 13.

A condition 151 is an index (a key) for retrieving an operation 152 responding to the input BPDU frame. There are items of the BPDU type, the input port, and a state of the port in the condition 151. The cost rewriter 15 makes a reference to the “BPDU Type” within the BPDU frame, the input port within the additional information, and the “Port Role” recorded in the “Flags” within the BPDU frame, respectively, and decides an operation 152.

The operation 152 is an operation that is retrieved with the condition 151 assumed to be an index. There are items of the operation and the destination port in the operation 152, and the cost rewriter 15 handles the BPDU frame according to the content described in the operation 152.

### AN OPERATIONAL EXAMPLE

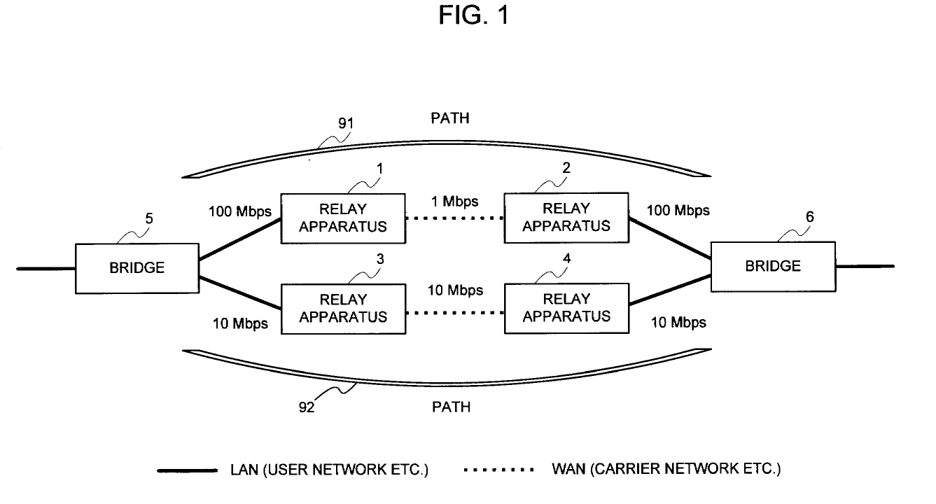

Hereinafter, an operation in this exemplary embodiment will be explained by making a reference to FIG. 2 with the case of the network configuration similar to the configuration having the problem caused by the related art 2 shown in FIG. 1 and the link rate thereof as an example.

(The Operational Example: a Precondition and an Initial Operation)

Herein, it is assumed that the Spanning Tree Protocol (the Rapid Spanning Tree specified in the old IEEE 802. 1w) operates in the bridge 5 and the bridge 6. Further, it is assumed that the bridge 5 is a root node.

The STP processor 52 sets 200000 to the PORT 53 as a cost value (port path cost) because the PORT 53 is linked up at 100 Mbps. Further, it sets 2000000 to the PORT 54 as a cost value (port path cost) because the PORT 54 is linked up at 10 Mbps.

The STP processor 62 sets 200000 to the PORT 63 as a cost value (port path cost) because the PORT 63 is linked up at 100 Mbps. Further, it sets 2000000 to the PORT 64 as a cost value (port path cost) because the PORT 64 is linked up at 10 Mbps.

Herein, it is assumed that the link between the relay apparatus 1 and the relay apparatus 2 has been linked up at 1 Mbps.

The WAN PORT 12 notifies the effect that the link has been linked up at 1 Mbps to the port manager 14. Likewise, the WAN PORT 22 notifies the effect that the link has been linked up at 1 Mbps to the port manager 24.

Herein, it is assumed that the link between the relay apparatus 3 and the relay apparatus 4 has been linked up at 10 Mbps.

The WAN PORT 32 notifies the effect that the link has been linked up at 10 Mbps to the port manager 34. Likewise, the WAN PORT 42 notifies the effect that the link has been linked up at 10 Mbps to the port manager 44.

Herein, it is assumed that the link between the relay apparatus 1 and the bridge 5, and the link between the relay apparatus 2 and the bridge 6 have been linked up at 100 Mbps, respectively.

The LAN PORT 11 notifies the effect that the link has been linked up at 100 Mbps to the port manager 14. Likewise, the LAN PORT 21 notifies the effect that the link has been linked up at 100 Mbps to the port manager 24.

Herein, it is assumed that the link between the relay apparatus 3 and the bridge 5, and the link between the relay apparatus 4 and the bridge 6 have been linked up at 10 Mbps, respectively.

The LAN PORT 31 notifies the effect that the link has been linked up at 10 Mbps to the port manager 34. Likewise, the LAN PORT 41 notifies the effect that the link has been linked up at 10 Mbps to the port manager 44.

The port manager 14 receives a notification of the link-up from the LAN PORT 11 and the WAN PORT 12, and collates the notified rate with the condition 141. And, the port manager 14 instructs the cost rewriter 15 to rewrite the frame when the BPDU frame arrives with the designated rate and the LAN rate assumed to be 1 Mbps, being a WAN rate, and 100 Mbps, respectively, because the LAN rate is 100 Mbps and the WAN rate is 1 Mbps, that is, WAN<LAN.

The port manager 24 receives a notification of the link-up from the LAN PORT 21 and the WAN PORT 22, and collates the notified rate with the condition 141. And, the port manager 24 instructs the cost rewriter 25 to rewrite the frame when the BPDU frame arrives with the designated rate and the LAN rate assumed to be 1 Mbps, being a WAN rate, and 100 Mbps, respectively, because the LAN rate is 100 Mbps and the WAN rate is 1 Mbps, that is, WAN<LAN.

The port manager 34 receives a notification of the link-up from the LAN PORT 31 and the WAN PORT 32, and collates the notified rate with the condition 141. And, the port manager 34 instructs the cost rewriter 35 to transfer the BPDU frame as it stands without rewriting it with the designated rate and the LAN rate assumed to be 0 Mbps and 0 Mbps, respectively, because the LAN rate is 10 Mbps and the WAN rate is 10 Mbps, that is, WAN=LAN.

The port manager 44 receives a notification of the link-up from the LAN PORT 41 and the WAN PORT 42, and collates the notified rate with the condition 141. And, the port manager 44 instructs the cost rewriter 45 to transfer the BPDU frame as it stands without rewriting it with the designated rate and the LAN rate assumed to be 0 Mbps and 0 Mbps, respectively, because the LAN rate is 10 Mbps and the WAN rate is 10 Mbps, that is, WAN=LAN.

(The Operational Example: Explanation of an Operation in an Outward Trip of the BPDU in the Path 91)

As describe above, the bridge 5 has becomes a root node. The STP processor 52 within this bridge 5 transmits an RST-BPDU frame to the PORT 53 through the bridge controller 51. , “Designated”, and “BPDU-MAC” have been set to the RPC (Root Path Cost), the port state, and the destination MAC of this frame, respectively.

The transfer controller 13 within the relay apparatus 1 receives the RST-BPDU frame from the LAN PORT 11, and collates the input port and the destination MAC thereof with the condition 131 of the table shown in FIG. 3. And, the transfer controller 13 makes a reference to the operation 132, adds the LAN port to the frame that was input as additional information (input port), and outputs this RST-BPDU frame to the cost rewriter 15 because the input port is a LAN port and the destination MAC is “BPDU-MAC”.

Upon receipt of the RST-BPDU frame from the transfer controller 13, the cost rewriter 15 makes a reference to the condition 151 of the table shown in FIG. 5, and returns it to the transfer controller 13 as it stands because the input port is “LAN” and the port state is “Designated”. At this moment, it sets the WAN as additional information (destination port).

The transfer controller 13 receives the RST-BPDU frame, and the WAN as a destination port from the cost rewriter 15, and outputs its frame to the WAN PORT 12 according to the condition 131 and the operation 132 of the table shown in FIG. 3. At this moment, it deletes the additional information.

The transfer controller 23 within the relay apparatus 2 receives the RST-BPDU frame from the WAN PORT 22, and collates the input port and the destination MAC thereof with the condition 131 of FIG. 3. And, the transfer controller 23 makes a reference to the operation 132, adds the WAN port to the frame that was input as additional information (input port), and outputs the RST-BPDU frame to the cost rewriter 25 because the input port is a WAN port and the destination MAC is “BPDU-MAC”.

Upon receipt of the RST-BPDU frame from the transfer controller 23, the cost rewriter 25 collates it with the condition 151 of FIG. 5 and makes a reference to the corresponding operation 152 because the input port is “WAN” and the port state is “Designated”.

The cost rewriter 25, which has already been instructed by the port manager 24 to rewrite the frame with the designated rate and the LAN rate assumed to be 1 Mbps and 100 Mbps, respectively, when the BPDU frame arrives, rewrites the “Root Path Cost” into 19800000 according to new “Root Path Cost”=old “Root Path Cost” (0)+20000000−200000=19800000, which is derived by assuming the cost equivalent to the portion of 1 Mbps and the cost equivalent to the portion of 100 Mbps to be 20000000 and 200000, respectively, and thereafter returns the frame to the transfer controller 23. At this moment, it sets the LAN as additional information (destination port).

The transfer controller 23 receives the RST-BPDU frame, and the LAN as a destination port from the cost rewriter 25, and outputs the frame to the LAN PORT 21 according to the condition 131 and the operation 132 shown in FIG. 3. At this moment, it deletes the additional information.

When the RST-BPDU frame arrives from the PORT 63, the bridge controller 61 within the bridge 6 transfers it to the STP processor 62.

The STP processor 62 receives the RST-BPDU frame from the bridge controller 61, and computes the root path cost of the path 91. At this time, the STP processor 62 recognizes that the root path cost of the path 91 is 19800000+200000=20000000 because the PORT 63 has been linked up at 100 Mbps, and in addition hereto, 19800000 has been set to the “Root Path Cost” value of the RST-BPDU that was input. In short, it recognizes that the band of the path 91 is 1 Mbps.

Additionally, the operation in the outward trip of the path 91 as described above is almost similarly applicable to the CFG-BPDU as well of the old IEEE 802. 1D. However, the operation in the return trip of the path 91 that is described below is not generated in the CFG-BPDU of the old IEEE 802. 1D.

(The Operational Example: Explanation in a Return Trip of the BPDU in the Path 91)

In the following, the operation in the case that a “Proposal” flag has been set to the RST-BPDU in the outward trip transmitted by the bridge 5, and the bridge 6 returns the BPDU with an “Agreement” flag to the bridge 5 will be explained.

As described above, the bridge 6 has become a subordinate node because the bridge 5 is a root node. The STP processor 62 of this bridge 6 transmits the RST-BPDU frame to the PORT 63 through the bridge controller 61. 19800000 and “Root” have been set to this frame as a RPC (Root Path Cost) and a port state, respectively.

The transfer controller 23 within the relay apparatus 2 receives the RST-BPDU frame from the LAN PORT 21, and collates the input port and the destination MAC thereof with the condition 131 of FIG. 3. And, the transfer controller 23 makes a reference to the operation 132, adds the LAN port to the frame that was input as additional information (input port), and outputs the RST-BPDU frame to the cost rewriter because the input port is a LAN port and the destination MAC is “BPDU-MAC”.

Upon receipt of the RST-BPDU frame from the transfer controller 23, the cost rewriter 25 collates it with the condition 151 of FIG. 5, and makes a reference to the corresponding operation 152 because the input port is “LAN” and the port state is “Root”.

The cost rewriter 25, which has been already instructed by the port manager 24 to rewrite the frame with the designated rate and the LAN rate assumed to be 1 Mbps and 100 Mbps, respectively, when the BPDU frame arrives, rewrites the “Root Path Cost” into 0 according to new “Root Path Cost”=old “Root Path Cost” (19800000)−(20000000−200000)=0, which is derived by assuming the cost equivalent to the portion of 1 Mbps and the cost equivalent to the portion of 100 Mbps assumed to be 20000000 and 200000, respectively, and thereafter returns the frame to the transfer controller 23. At this moment, it sets the WAN as additional information (destination port).

The transfer controller 23 receives the RST-BPDU frame, and the WAN as a destination port from the cost rewriter, and outputs the frame to the WAN PORT 22 according to the condition 131 and the operation 132 shown in FIG. 3. At this moment, it deletes the additional information.

The transfer controller 13 within the relay apparatus 1 receives the RST-BPDU frame from the WAN PORT 12, and collates the input port and the destination MAC thereof with the condition 131 of FIG. 3. And, the transfer controller 13 makes a reference to the operation 132, adds the WAN port to the frame that was input as additional information (input port), and outputs the RST-BPDU frame to the cost rewriter because the input port is a WAN port and the destination MAC is “BPDU-MAC”.

Upon receipt of the RST-BPDU frame from the transfer controller 13, the cost rewriter 15 returns it to the transfer controller 13 as it stands because the input port is “WAN” and the port state is “Root”. At this moment, it sets the LAN as additional information (destination port).

The transfer controller 13 receives the RST-BPDU frame, and the LAN as a destination port from the cost rewriter, and outputs the frame to the LAN PORT 11 according to the condition 131 and the operation 132 shown in FIG. 3. At this moment, it deletes the additional information.

When the RST-BPDU frame arrives from the PORT 53, the bridge controller 51 within the bridge 5 transfers it to the STP processor 52.

The STP processor 52 receives the RST-BPDU frame from the bridge controller 51, and keeps the state maintained up to this point (the bridge 5 is a root node, and the PORT 53 is a “designated” port) because “Root” has been set as a port state.

Additionally, the rewriting process of the return trip is a process of writing back to the original “Root Path Cost” that is one prior to rewriting in the rewriting process of the outward trip, so only the rewriting process of the BPDU in the outward trip is included, and the rewriting process of the BPDU in the return trip is omitted in the operation to be later explained.

Additionally, the operation of the return trip in the path 91 described above is not generated in the CFG-BPDU of the old IEEE 802. 1D.

(The Operational Example: Explanation of an Operation in the Path 92)

The STP processor 52 within the bridge 5 transmits the RST-BPDU frame to the PORT 54 through the bridge controller 51. and “Designated” have been set to this frame as a RPC (Root Path Cost) and a port state, respectively. (The bridge 5 has become a root node).

The transfer controller 33 within the relay apparatus 3 receives the RST-BPDU frame from the LAN PORT 31, and collates the input port and the destination MAC thereof with the condition 131 of the table 3 shown in FIG. 3. And, the transfer controller 13 makes a reference to the operation 132, adds the LAN port to the frame that was input as additional information (input port), and outputs the RST-BPDU frame to the cost rewriter because the input port is a LAN port and the destination MAC is “BPDU-MAC”.

Upon receipt of the RST-BPDU frame from the transfer controller 33, the cost rewriter 35 returns it to the transfer controller 33 as it stands because the input port is “LAN” and the port state is “Designated”. At this moment, it sets the WAN as additional information (destination port).

The transfer controller 33 receives the RST-BPDU frame, and the WAN as a destination port from the cost rewriter, and outputs the frame to the WAN PORT 32 according to the condition 131 and the operation 132 shown in FIG. 3. At this moment, it deletes the additional information.

The transfer controller 43 within the relay apparatus 4 receives the RST-BPDU frame from the WAN PORT 42, and collates the input port and the destination MAC thereof with the condition 131 of FIG. 3. And, the transfer controller 43 makes a reference to the operation 132, adds the WAN port to the frame that was input as additional information (input port), and outputs the RST-BPDU frame to the cost rewriter because the input port is a WAN port and the destination MAC is “BPDU-MAC”.

Upon receipt of the RST-BPDU frame from the transfer controller 43, the cost rewriter 45 collates it with the condition 151 of FIG. 5 and makes a reference to the corresponding operation 152 because the input port is “WAN” and the port state is “designated”.

The cost rewriter 45, which has already been instructed by the port manager 44 to transfer the BPDU frame as it stands without rewriting it, returns the RST-BPDU frame to the transfer controller 43 as it stands. At this moment, it sets the LAN as additional information (destination port).

The transfer controller 43 receives the RST-BPDU frame, and the LAN as a destination port from the cost rewriter, and outputs the frame to the LAN PORT 41 according to the condition 131 and the operation 132 shown in FIG. 3. At this moment, it deletes the additional information.

When the RST-BPDU frame arrives from the PORT 63, the bridge controller 61 within the bridge 6 transfers it to the STP processor 62.

The STP processor 62 receives the RST-BPDU frame from the bridge controller 61, and computes the root path cost of the path 92. At this time, the STP processor 62 recognizes that the root path cost of the path 92 is 0+2000000=2000000 because the PORT 64 has been linked up at 10 Mbps, and in addition hereto, 0 has been set to the “Root Path Cost” value of the RST-BPDU that was input. In short, it recognizes that the band of the path 92 is 10 Mbps.

In the path 92, the process of rewriting the cost was not generated in the transfer of the BPDU in the outward trip mentioned above. For this reason, the process of rewriting the cost is not generated in the transfer as well of the BPDU in the return trip.

Additionally, the operation in the outward trip of the path 92 described above is almost similarly applicable to the CFG-BPDU of the old IEEE 802. 1D as well. However, the operation in the return trip of the path 92 is not generated in the CFG-BPDU of the old IEEE 802. 1D.

(The Operational Example: a Path Selection in the Bridge 6)

The STP processor 62 within the bridge 6 recognizes that the root path cost of the path 91 is 20000000 (1 Mbps), and the root path cost of the path 92 is 2000000 (10 Mbps) from the operation described up to this point. For this, it closes the port in the path 91 side, thereby preventing the frame from being transmitted/received to/from the port in the path 91 side. In short, communication between the bridge 5 and the bridge 6 results in being all made through the path 92.

Upon comparing the maximum band (1 Mbps) of the path 91 with the maximum band (10 Mbps) of the path 92, the latter is larger. Thus, the optimal path was selected.

With the above explanation, it was demonstrated that applying the configuration shown in this exemplary embodiment allowed the cost to be computed normally, and the optimal path to be selected also in a case where a difference existed between an actually utilizable rate and a link rate of the connection link when the STP was utilized among the LANs (user network etc.) spanning the WAN (carrier network etc.).

(Effects of the Invention)

Next, the effects of this exemplary embodiment will be explained.

Utilizing the invention listed in this exemplary embodiment makes it possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exists.

The reason is that in the relay apparatus (a transmission apparatus, a tunnel apparatus, or the like) that is inserted between the bridges etc., the port manager within the relay apparatus, upon receipt of a link rate from the port, investigates which side, out of the WAN side and the LAN side, becomes a bottleneck, and the cost rewriter within the relay apparatus rewrites the root path cost field within the BPDU in conformity to the rate of the bottleneck.

### A Second Exemplary Embodiment

In the second exemplary embodiment of the present invention, in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exist, the relay apparatus (a transmission apparatus, a tunnel apparatus, or the like) that is inserted between the bridges etc., upon receipt of a link rate from the port, investigates which side, out of the WAN side and the LAN side, becomes a bottleneck, and rewrites the root path cost field within the BPDU in conformity to the rate of the bottleneck by snooping the BPDU, thereby allowing a band of the bottleneck to be reflected into the cost, an optimal path to be selected, and an efficiency of the net utilization to be enhanced without making a setting or a modification to the apparatus (bridge etc.) in which the path control protocol operates.

In addition hereto, the above-mentioned relay apparatus notifies the latest rate of the bottleneck of its own to the relay apparatus facing it, and further receives information of the rate of the bottleneck from the relay apparatus facing it, thereby allowing the relay apparatus for rewriting the root path cost to know a band of the bottleneck also in a case where no bottleneck exists in the connection link of the relay apparatus for rewriting the root path cost, which enables an actually utilizable rate (a band of the bottleneck) in the path between the bridges etc. to be reflected into the cost, an optimal path to be selected, and an efficiency of the net utilization to be enhanced.

The second exemplary embodiment of the present invention differs from the first exemplary embodiment in a point that a rate notifier is added to the configuration of the first exemplary embodiment, the rate notifier notifies the latest rate of the bottleneck of its own to the relay apparatus facing its own relay apparatus, and the port manager takes the notified rate of the bottleneck into consideration and gives an instruction for rewriting the cost.

(Explanation of a Configuration)

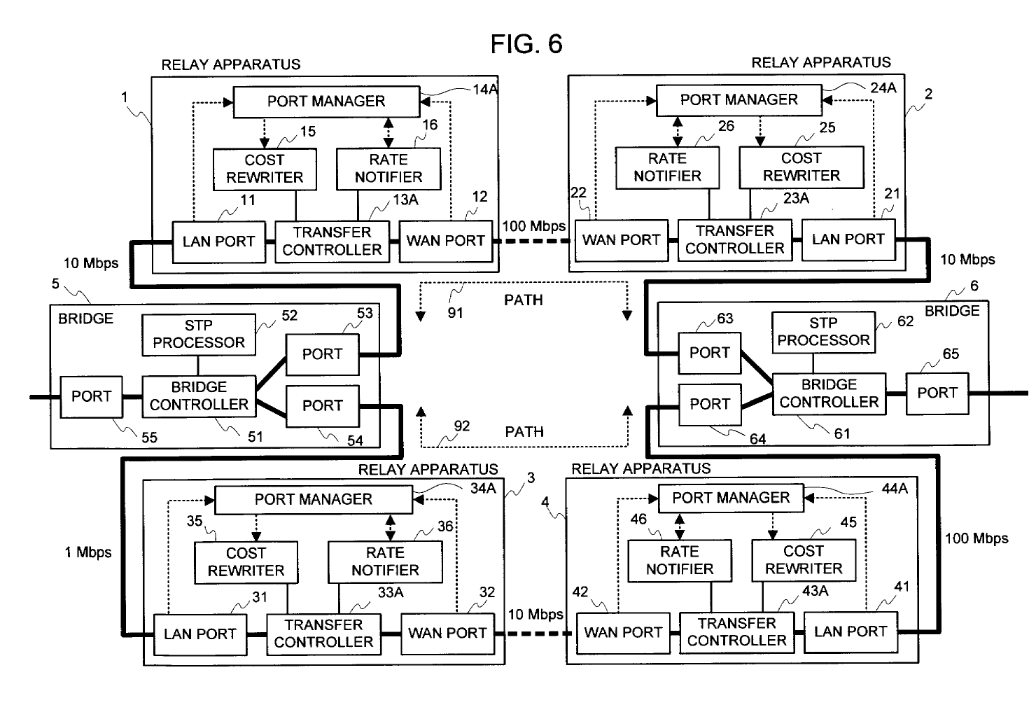

A configuration in this exemplary embodiment will be explained by making a reference to FIG. 6.

In the second exemplary embodiment of the present invention, a rate notifier 16 is added to the configuration of the first exemplary embodiment, and the processing methods in a transfer controller 13A and a port manager 14A are changed. Additionally, the identical numeral is affixed to the component similar to that of the above-mentioned exemplary embodiment, and the detailed explanation thereof is omitted.

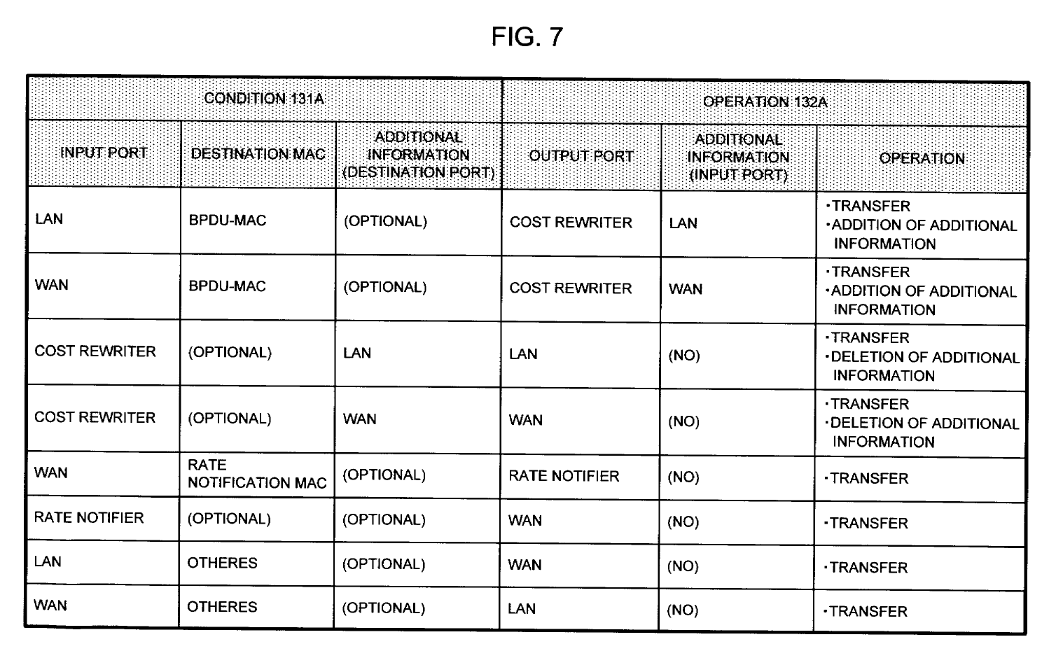

In a case of having received the frame from the LAN PORT 11, the WAN PORT 12, the cost rewriter 15, and the rate notifier 16, the transfer controller 13A makes a reference to the input port, the destination MAC address, and the destination port thereof, decides an operation, an output port, and so on according to a table shown in FIG. 7, and transfers the frame to the LAN PORT 11, the WAN PORT 12, the cost rewriter 15, and the rate identifier 16. Further, the transfer controller 13A adds or deletes a header, a tag, a flag, or the like for a purpose of constructing a tunnel with the relay apparatus (relay apparatus 2) facing its own relay apparatus responding to a necessity. In addition hereto, it makes a buffering as well for a purpose of avoiding a frame collision, and further absorbing a rate difference between the LAN and the WAN.

When the BPDU frame is input from the LAN PORT 11 or the WAN PORT 12, the transfer controller 13A adds the input port identification information (LAN PORT 11 or the WAN PORT 12) as additional information to the BPDU frame, and transfers it to the cost rewriter 15. Further, the transfer controller 13A receives the BPDU frame to which the destination port identification information (LAN PORT 11 or the WAN PORT 12) has been added from the cost rewriter 15, and transfers it to the designated output port (the LAN PORT 11 or the WAN PORT 12). At this time, it deletes the output port identification information, and thereafter transfers the frame.

The port manager 14A receives a notification of the link rate from the LAN PORT 11 and the WAN PORT 12 at the time of a link-up and at the time of a link-down, decides an operation according to a table shown in FIG. 4, and conveys parameters (a designated rate and an LAN rate) necessary for rewriting the BPDU frame to the cost rewriter 15, and further instructs the rate notifier 16 to convey the LAN rate to the relay apparatus (relay apparatus 2) facing its own relay apparatus responding to a necessity. Further, the notified rate is preserved until the next notification is issued.

In a case of having received the LAN rate of the relay apparatus (relay apparatus 2) facing its own relay apparatus from the rate notifier 16, the port manager 14A decides an operation according to the table shown in FIG. 4, and conveys the parameters (the designated rate and the LAN rate) necessary for rewriting the BPDU frame to the cost rewriter 15, and further instructs the rate notifier 16 to convey the LAN rate to the relay apparatus (relay apparatus 2) facing its own relay apparatus responding to a necessity. Further, the notified rate is preserved until the next notification is issued.

The port manager 14A decides an operation according to the table shown in FIG. 4 by employing the rate information preserved owing to the notification received in the past, conveys the parameters (the designated rate and the LAN rate) necessary for rewriting the BPDU frame to the cost rewriter 15, and further instructs the rate notifier 16 to convey the LAN rate to the relay apparatus (relay apparatus 2) facing its own relay apparatus responding to a necessity for each constant time period.

In a case of having received a notification of the LAN rate from the port manager 14A, the rate notifier 16 conveys the LAN rate to the relay apparatus (relay apparatus 2) facing its own relay apparatus. This notification is performed by preparing a rate notification frame of which the destination MAC address and the transmission source MAC address are a rate notification MAC address (for example: specially-subscribed MAC address such as 00-00-4C-00-00-01), and an MAC address of the relay apparatus 1, respectively. The rate notification frame is transferred in the order of the rate notifier 16, the transfer controller 13A, the WAN PORT 12, the WAN PORT 22, a transfer controller 23A, and a rate notifier 26.

In a case of having received the rate notification frame from the transfer controller 13A, the rate notifier 16 conveys to the port manager 14A the LAN rate of the relay apparatus (relay apparatus 2) facing its own relay apparatus that is included in the rate notification frame.

The transfer controller 23A, which has a configuration similar to that of the transfer controller 13A, performs a similar operation.

A port manager 24A, which has a configuration similar to that of the port manager 14A, performs a similar operation.

The rate notifier 26, which has a configuration similar to that of the rate notifier 16, performs a similar operation.

A transfer controller 33A, which has a configuration similar to that of the transfer controller 13A, performs a similar operation.

A port manager 34A, which has a configuration similar to that of the port manager 14A, performs a similar operation.

A rate notifier 36, which has a configuration similar to that of the rate notifier 16, performs a similar operation.

A transfer controller 43A, which has a configuration similar to that of the transfer controller 13A, performs a similar operation.

A port manager 44A, which has a configuration similar to that of the port manager 14A, performs a similar operation.

A rate notifier 46, which has a configuration similar to that of the rate notifier 16, performs a similar operation.

FIG. 7 is a table to which the transfer controller 13A in the second exemplary embodiment makes a reference for a purpose of deciding a transferee (output port) of the frame, additional information, and an operation at the moment of having received the frame from each port.

A condition 131A is an index (a key) for retrieving an operation 132A responding to the input frame. There are items of the input port, the destination MAC, and the additional information in the condition 131A, and the transfer controller 13A makes a reference to the input port and the destination MAC of the input frame, and the additional information when the frame is input from the cost rewriter, and decides an operation 132A.

The operation 132A is an operation that is retrieved with the condition 131A assumed to be an index. There are respective items of the output port, the additional information, and the operation in the operation 132A, and the transfer controller 13A handles the frame according to the content described in the operation 132A.

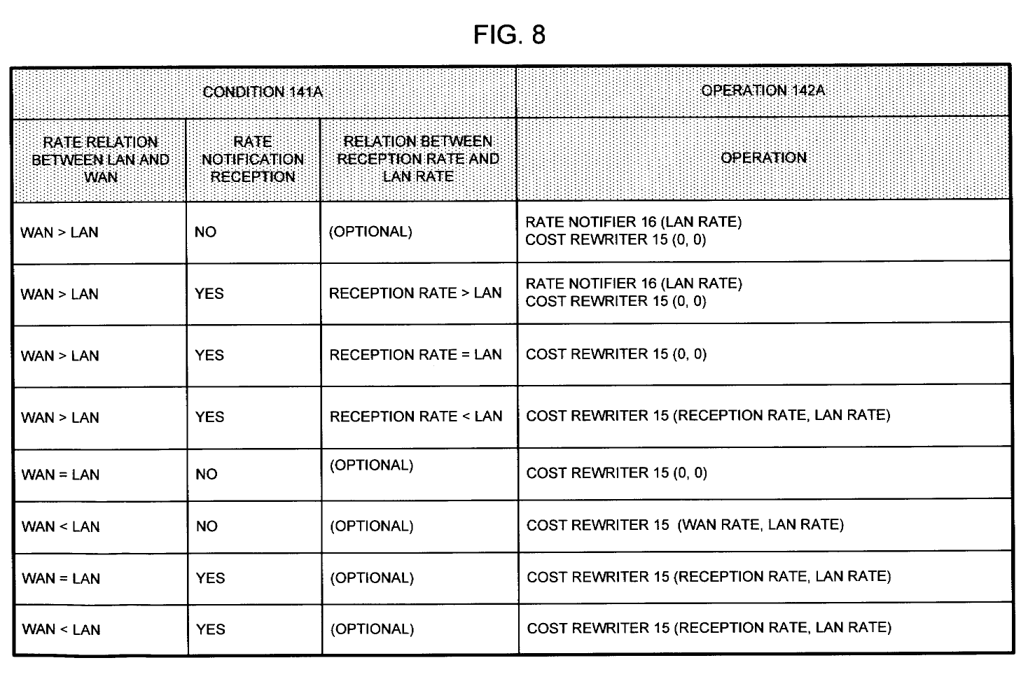

FIG. 8 is a table to which the port manager 14A in the second exemplary embodiment makes a reference for a purpose of deciding an operation at the moment of having received the link-up rate or the rate notification.

A condition 141A is an index (a key) for retrieving an operation 142A responding to the received link-up rate or rate notification. There are items of a rate relation between the LAN and the WAN, and presence or absence of the rate notification reception in the condition 141A. The port manager 14A searches the condition 141A at the time of receiving a notification of the link-up rate, or at the time of receiving the rate notification from the LAN PORT 11 and the WAN PORT 12, and decides an operation 142A.

The operation 142A is an operation that is retrieved with the condition 141A assumed to be an index. The instruction as to which rate is employed to rewrite the cost at the moment of requesting of the cost rewriter 15 the cost rewrite, and the instruction as to which rate is notified at the moment of requesting the rate notifier 16 to notify the rate to the relay apparatus facing its own relay apparatus are described in the operation 142A. Additionally, an instruction to the cost rewriter 15 is given by notifying the designated rate (rate that becomes a reference for computing the cost) and the LAN rate (rate that becomes a reference for predicting the cost that the LAN-side appliance would add).

### THE OPERATIONAL EXAMPLE

Hereinafter, an operation in this exemplary embodiment will be explained by making a reference to FIG. 6 with an operation exemplified of the subordinate node (bridge 6) in the case that the band of the connection link of the root node (bridge 5) is smallest over the path.

(The Operational Example: a Precondition and an Initial Operation)

Herein, it is assumed that the Spanning Tree Protocol (the Rapid Spanning Tree specified in the old IEEE 802. 1w) operates in the bridge 5 and the bridge 6. Further, it is assumed that the bridge 5 is a root node.

The STP processor 52 sets 2000000 to the PORT 53 as a cost value (port path cost) because the PORT 53 is linked up at 10 Mbps. Further, it sets 20000000 to the PORT 54 as a cost value (port path cost) because the PORT 54 is linked up at 1 Mbps.

The STP processor 62 sets 2000000 to the PORT 63 as a cost value (port path cost) because the PORT 63 is linked up at 10 Mbps. Further, it sets 200000 to the PORT 64 as a cost value (port path cost) because the PORT 64 is linked up at 100 Mbps.

Herein, it is assumed that the link between the relay apparatus 1 and the relay apparatus 2 has been linked up at 100 Mbps.

The WAN PORT 12 notifies the effect that the link has been linked up at 100 Mbps to the port manager 14A.

The WAN PORT 22 notifies the effect that the link has been linked up at 100 Mbps to the port manager 24A.

Herein, it is assumed that the link between the relay apparatus 3 and the relay apparatus 4 has been linked up at 10 Mbps.

The WAN PORT 32 notifies the effect that the link has been linked up at 10 Mbps to the port manager 34A.

The WAN PORT 42 notifies the effect that the link has been linked up at 10 Mbps to the port manager 44A.

Herein, it is assumed that the link between the relay apparatus 1 and the bridge 5, and the link between the relay apparatus 2 and the bridge 6 have been linked up at 10 Mbps, respectively.

The LAN PORT 11 notifies the effect that the link has been linked up at 10 Mbps to the port manager 14A.

The LAN PORT 21 notifies the effect that the link has been linked up at 10 Mbps to the port manager 24A.

Herein, it is assumed that the link between the relay apparatus 3 and the bridge 5 has been linked up at 1 Mbps.

The LAN PORT 31 notifies the effect that the link has been linked up at 1 Mbps to the port manager 34A.

Herein, it is assumed that the link between the relay apparatus 4 and the bridge 6 has been linked up at 100 Mbps.

The LAN PORT 41 notifies the effect that the link has been linked up at 100 Mbps to the port manager 44A.

The port manager 14A receives a notification of the link-up from the LAN PORT 11 and the WAN PORT 12, and collates the notified rate with the condition 141A. And, the port manager 14A instructs the cost rewriter 15 to transfer the BPDU frame as it stands without rewriting it with the designated rate and the LAN rate assumed to be 0 Mbps and 0 Mbps, respectively, because the LAN rate is 10 Mbps, the WAN rate is 100 Mbps, and in addition hereto, the rate notification has not been received. Further, It instructs the rate notifier 16 to notify the LAN rate (10 Mbps) to the rate notifier 26.

The port manager 24A receives a notification of the link-up from the LAN PORT 21 and the WAN PORT 22, and collates the notified rate with the condition 141A. And, the port manager 24A instructs the cost rewriter 25 to transfer the BPDU frame as it stands without rewriting it with the designated rate and the LAN rate assumed to be 0 Mbps and 0 Mbps, respectively, because the LAN rate is 10 Mbps, the WAN rate is 100 Mbps, and in addition hereto, the rate notification has not been received. Further, it instructs the rate notifier 26 to notify the LAN rate (10 Mbps) to the rate notifier 16.

The port manager 34A receives a notification of the link-up from the LAN PORT 31 and the WAN PORT 32 and collates the notified rate with the condition 141A. And, the port manager 34A instructs the cost rewriter 35 to transfer the BPDU frame as it stands without rewriting it with the designated rate and the LAN rate assumed to be 0 Mbps and 0 Mbps, respectively, because the LAN rate is 1 Mbps, the WAN rate is 10 Mbps, and in addition hereto, the rate notification has not been received. Further, it instructs the rate notifier 36 to notify the LAN rate (1 Mbps) to the rate notifier 46.

The port manager 44A receives a notification of the link-up from the LAN PORT 41 and the WAN PORT 42, and collates the notified rate with the condition 141A. And, the port manager 44A instructs the cost rewriter 45 to rewrite the BPDU frame at the moment that it arrives with the designated rate and the LAN rate assumed to be 10 Mbps and 100 Mbps, respectively, because the LAN rate is 100 Mbps, the WAN rate is 10 Mbps, and in addition hereto, the rate notification has not been received.

Upon receipt of an instruction for notifying the LAN rate from the port manager 14A, the rate notifier 16 prepares a rate notification frame, and notifies the LAN rate to the rate notifier 26 via the transfer controller 13A, the WAM PORT 12, the WAN PORT 22, and the transfer controller 23A. Upon receipt of the rate notification frame transmitted by the rate notifier 16, the rate notifier 26 notifies the LAN-side rate (10 Mbps) of the relay apparatus 1 to the port manager 24A.

Upon receipt of an instruction for notifying the LAN rate from the port manager 24A, the rate notifier 26 prepares a rate notification frame, and notifies the LAN rate to the rate notifier 16 via the transfer controller 23A, the WAM PORT 22, the WAN PORT 12, and the transfer controller 13A. Upon receipt of the rate notification frame transmitted by the rate notifier 26, the rate notifier 16 notifies the LAN-side rate (10 Mbps) of the relay apparatus 2 to the port manager 14A.

Upon receipt of an instruction for notifying the LAN rate from the port manager 34A, the rate notifier 36 prepares a rate notification frame, and notifies the LAN rate to the rate notifier 46 via the transfer controller 33A, the WAM PORT 32, the WAN PORT 42, and the transfer controller 43A. Upon receipt of the rate notification frame transmitted by the rate notifier 36, the rate notifier 46 notifies the LAN-side rate (1 Mbps) of the relay apparatus 3 to the port manager 44A.

The port manager 14A receives a notification of the LAN rate of the apparatus facing it from the rate notifier 16, and collates the rate (10 Mbps) of the LAN PORT 11 and the rate (100 Mbps) of the WAN PORT 12 that it has already preserved, and the reception rate (10 Mbps) notified this time with the condition 141A, respectively. And, the port manager 14A instructs the cost rewriter 15 to transfer the BPDU frame as it stands without rewriting it with the designated rate and the LAN rate assumed to be 0 Mbps and 0 Mbps, respectively, because the LAN rate is 10 Mbps and the WAN rate is 100 Mbps, and in addition hereto, the rate notification has been received and the reception rate=the LAN rate.

The port manager 24A receives a notification of the LAN rate of the apparatus facing it from the rate notifier 26, and collates the rate (10 Mbps) of the LAN PORT 21 and the rate (100 Mbps) of the WAN PORT 22 that it has already preserved, and the reception rate (10 Mbps) notified this time with the condition 141A, respectively. And, the port manager 24A instructs the cost rewriter 25 to transfer the BPDU frame as it stands without rewriting it with the designated rate and the LAN rate assumed to be 0 Mbps and 0 Mbps, respectively, because the LAN rate is 10 Mbps and the WAN rate is 100 Mbps, and in addition hereto, the rate notification has been received and the reception rate=the LAN rate.

The port manager 44A receives a notification of the LAN rate of the apparatus facing it from the rate notifier 46, and collates the rate (100 Mbps) of the LAN PORT 41 and the rate (10 Mbps) of the WAN PORT 42 that it has already preserved, and the reception rate (1 Mbps) notified this time with the condition 141A, respectively. And, the port manager 44A instructs the cost rewriter 45 to rewrite the BPDU frame at the moment that it arrives with the designated rate and the LAN rate assumed to be 1 Mbps and 100 Mbps, respectively, because the LAN rate is 100 Mbps and the WAN rate is 10 Mbps, and in addition hereto, the rate notification has been received and the reception rate<the LAN rate.

(The Operational Example: Explanation of an Operation in the Path 91)

The STP processor 52 within the bridge 5 transmits the RST-BPDU frame to the PORT 53 through the bridge controller 51. and “Designated” have been set to this frame as a RPC (Root Path Cost) and a port state, respectively. (The bridge 5 has become a root node).

The transfer controller 13A within the relay apparatus 1 receives the RST-BPDU frame from the LAN PORT 11, and collates the input port and the destination MAC thereof with the condition 131 of FIG. 3, respectively. And, the transfer controller 13A makes a reference to the operation 132, adds the LAN port to the frame that was input as additional information (input port), and outputs the RST-BPDU frame to the cost rewriter because the input port is a LAN port and the destination MAC is “BPDU-MAC”.

Upon receipt of the RST-BPDU frame from the transfer controller 13A, the cost rewriter 15 returns it to the transfer controller 13A as it stands because the input port is “LAN” and the port state is “Designated”. At this moment, it sets the WAN as additional information (destination port).

The transfer controller 13A receives the RST-BPDU frame, and the WAN as a destination port from the cost rewriter 15, and outputs the frame to the WAN PORT 12 according to the condition 131A and the operation 132A shown in FIG. 7. At this moment, it deletes the additional information.

The transfer controller 23A within the relay apparatus 2 receives the RST-BPDU frame from the WAN PORT 22, and collates the input port and the destination MAC thereof with the condition 131A of FIG. 7, respectively. And, the transfer controller 23A makes a reference to the operation 132A, adds the WAN port to the frame that was input as additional information (input port), and outputs the RST-BPDU frame to the cost rewriter because the input port is a WAN port and the destination MAC is “BPDU-MAC”.

Upon receipt of the RST-BPDU frame from the transfer controller 23A, the cost rewriter 25 collates it with the condition 151 of FIG. 5 and makes a reference to the corresponding operation 152 because the input port is “WAN” and the port state is “designated”.

The cost rewriter 25, which has already been instructed by the port manager 24A to transfer the BPDU frame as it stands without rewriting it, returns the RST-BPDU frame to the transfer controller 23A as it stands. At this moment, it sets the LAN as additional information (destination port).

The transfer controller 23A receives the RST-BPDU frame, and the LAN as a destination port from the cost rewriter 25, and outputs the frame to the LAN PORT 21 according to the condition 131A and the operation 132A shown in FIG. 7. At this moment, it deletes the additional information.

When the RST-BPDU frame arrives from the PORT 63, the bridge controller 61 within the bridge 6 transfers it to the STP processor 62.

The STP processor 62 receives the RST-BPDU frame from the bridge controller 61, and computes the root path cost of the path 91. At this time, the STP processor 62 recognizes that the root path cost of the path 91 is 0+2000000=2000000 because the PORT 63 has been linked up at 10 Mbps, and in addition hereto, 0 has been set to the “Root Path Cost” value of the RST-BPDU that was input. In short, it recognizes that the band of the path 91 is 10 Mbps.

In the path 91, the process of rewriting the cost was not generated in the transfer of the BPDU in the outward trip mentioned above. For this reason, the process of rewriting the cost is not generated in the transfer as well in the return trip.

(The Operational Example: Explanation of an Operation in the Path 92)

The STP processor 52 transmits the RST-BPDU frame to the PORT 54 through the bridge controller 51. and “Designated” have been set to this frame as a RPC (Root Path Cost) and a port state, respectively.

The transfer controller 33A within the relay apparatus 3 receives the RST-BPDU frame from the LAN PORT 31, and collates the input port and the destination MAC thereof with the condition 131A of FIG. 7, respectively. And, the transfer controller 33A makes a reference to the operation 132A, adds the LAN port to the frame that was input as additional information (input port), and outputs the RST-BPDU frame to the cost rewriter because the input port is a LAN port and the destination MAC is “BPDU-MAC”.

Upon receipt of the RST-BPDU frame from the transfer controller 33A, the cost rewriter 35 returns it to the transfer controller 33A as it stands because the input port is a LAN and the port state is “Designated”. At this moment, it sets the WAN as additional information (destination port).

The transfer controller 33A receives the RST-BPDU frame, and the WAN as a destination port from the cost rewriter 35, and outputs the frame to the WAN PORT 32 according to the condition 131A and the operation 132A shown in FIG. 7. At this moment, it deletes the additional information.

The transfer controller 43A within the relay apparatus 4 receives the RST-BPDU frame from the WAN PORT 42, and collates the input port and the destination MAC thereof with the condition 131A of FIG. 7, respectively. And, the transfer controller 43A makes a reference to the operation 132A, adds the WAN port to the frame that was input as additional information (input port), and outputs the RST-BPDU frame to the cost rewriter because the input port is a WAN port and the destination MAC is “BPDU-MAC”.

Upon receipt of the RST-BPDU frame from the transfer controller 43A, the cost rewriter 45 collates it with the condition 151 of FIG. 5 and makes a reference to the corresponding operation 152 because the input port is “WAN” and the port state is “designated”.

The cost rewriter 45, which has already been instructed by the port manager 44A to rewrite the BPDU frame with the designated rate and the LAN rate assumed to be 1 Mbps and 100 Mbps, respectively, at the moment that it arrives, rewrites the “Root Path Cost” into 19800000 according to new “Root Path Cost”=old “Root Path Cost” (0)+20000000−200000=19800000, which is derived by assuming the cost equivalent to the portion of 1 Mbps and the cost equivalent to the portion of 100 Mbps assumed to be 20000000 and 200000, respectively, and thereafter returns the frame to the transfer controller 43A. At this moment, it sets the LAN as additional information (destination port).

The transfer controller 43A receives the RST-BPDU frame, and the LAN as a destination port from the cost rewriter 45, and outputs the frame to the LAN PORT 41 according to the condition 131A and the operation 132A shown in FIG. 7. At this moment, it deletes the additional information.

When the RST-BPDU frame arrives from the PORT 63, the bridge controller 61 within the bridge 6 transfers it to the STP processor 62.

The STP processor 62 receives the RST-BPDU frame from the bridge controller 61, and computes the root path cost of the path 92. At this time, the STP processor 62 recognizes that the root path cost of the path 92 is 19800000+200000=20000000 because the PORT 64 has been linked up at 100 Mbps, and in addition hereto, 19800000 has been set to the “Root Path Cost” value of the RST-BPDU that was input. In short, it recognizes that band of the path 92 is 1 Mbps.

In the path 92, the root path cost was rewritten from 0 to 19800000 in the transfer of the BPDU in the outward trip described above. For this reason, the root path cost of the BPDU is to be re-written from 19800000 to 0 in the transfer in the return trip.

(The Operational Example: a Path Selection in the Bridge 6)

The STP processor 62 within the bridge 6 recognizes that the root path cost of the path 91 is 2000000 (10 Mbps), and the root path cost of the path 92 is 20000000 (1 Mbps) from the operation described up to this point. For this, it closes the port in the path 92 side, thereby preventing the frame from being transmitted/received to/from the port in the path 92 side. In short, communication between the bridge 5 and the bridge 6 results in being all made through the path 91.

Upon comparing the maximum band (10 Mbps) of the path 91 with the maximum band (1 Mbps) of the path 92, the former is larger. Thus, the optimal path was selected.

With the above explanation, it was demonstrated that applying the configuration shown in this exemplary embodiment allowed the cost to be computed normally, and the optimal path to be selected also in a case where a difference existed between an actually utilizable rate and a link rate of the connection link when the STP was utilized among the LANs (user network etc.) spanning the WAN (carrier network etc.).

(Effects of the Invention)

Next, the effects of this exemplary embodiment will be explained.

Utilizing the invention listed in this exemplary embodiment makes it possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of the link by a physical band of the connection link operates, exists.

The reason is that in the relay apparatus (a transmission apparatus, a tunnel apparatus, or the like) that is inserted between the bridges etc., the port manager within the relay apparatus, upon receipt of a link rate from the port, investigates which side, out of the WAN side and the LAN side, becomes a bottleneck, and the cost rewriter within the relay apparatus rewrites the root path cost field within the BPDU in conformity to the rate of the bottleneck.

Further, utilizing the invention listed in this exemplary embodiment makes it possible to reflect an actually utilizable rate (a band of the bottleneck) in the path between the bridges etc. into the cost, to select an optimal path, and to enhance an efficiency of the net utilization also in a case where no bottleneck exists in the connection link of the relay apparatus for rewriting the root path cost.

The reason is that in the relay apparatus (a transmission apparatus, a tunnel apparatus, or the like) that is inserted between the bridges etc., the rate notifier within the relay apparatus notifies the latest rate of the bottleneck of its own to the relay apparatus facing its own relay apparatus, and contrarily receives a notification from the relay apparatus facing its own relay apparatus and notifies it to the port manager.

### A Third Exemplary Embodiment

In the second exemplary embodiment of the present invention, the rate of the WAN line, which was acquired from the link-up rate in the WAN PORT 12, the WAN PORT 22, the WAN PORT 32, and the WAN PORT 42, was is utilized for computing the cost, whereas the third exemplary embodiment of the present invention differs from the second exemplary embodiment in a point of providing a rate delay measurer 17, a rate delay measurer 27, a rate delay measurer 37, and a rate delay measurer 47, acquiring the rate of the WAN line by transmitting/receiving a measurement frame, and computing the cost.

This makes it possible to accurately obtain the cost also in a case where the link rate of the WAN line fluctuates.

(Explanation of a Configuration)

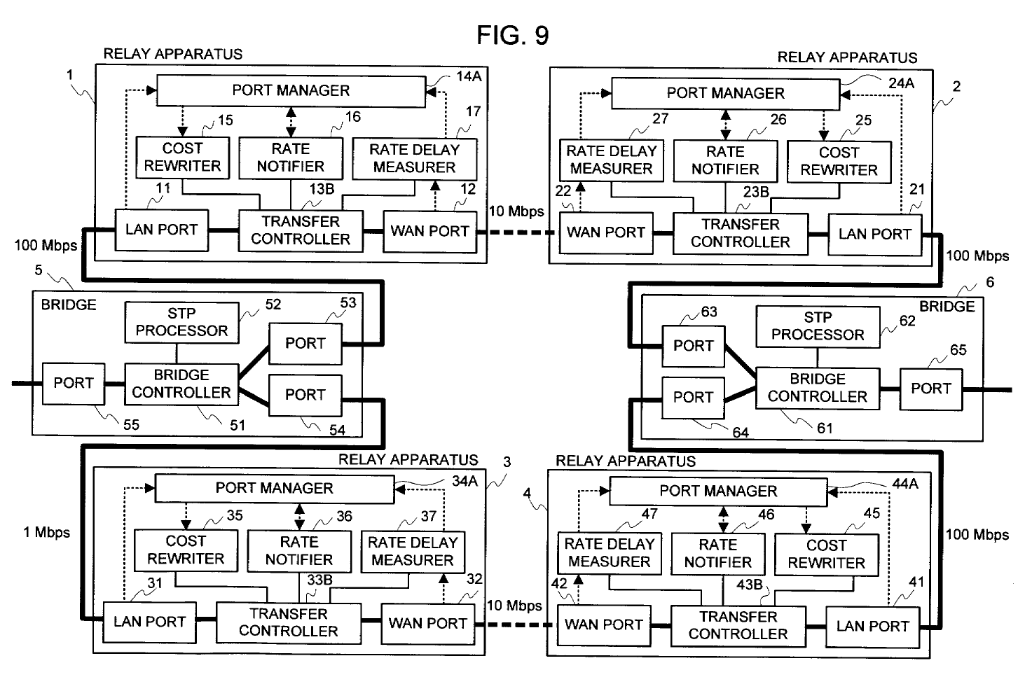

A configuration in this exemplary embodiment will be explained by making a reference to FIG. 9.

In third exemplary embodiment of the present invention, a rate delay measurer is added to the configuration of the second exemplary embodiment, a notification of the link rate from the WAN PORT to the port manager is abolished, and the link-up is notified from the WAN PORT to the rate delay measurer instead thereof. Additionally, the identical numeral is affixed to the component similar to that of the above-mentioned exemplary embodiments, and the detailed explanation thereof is omitted.

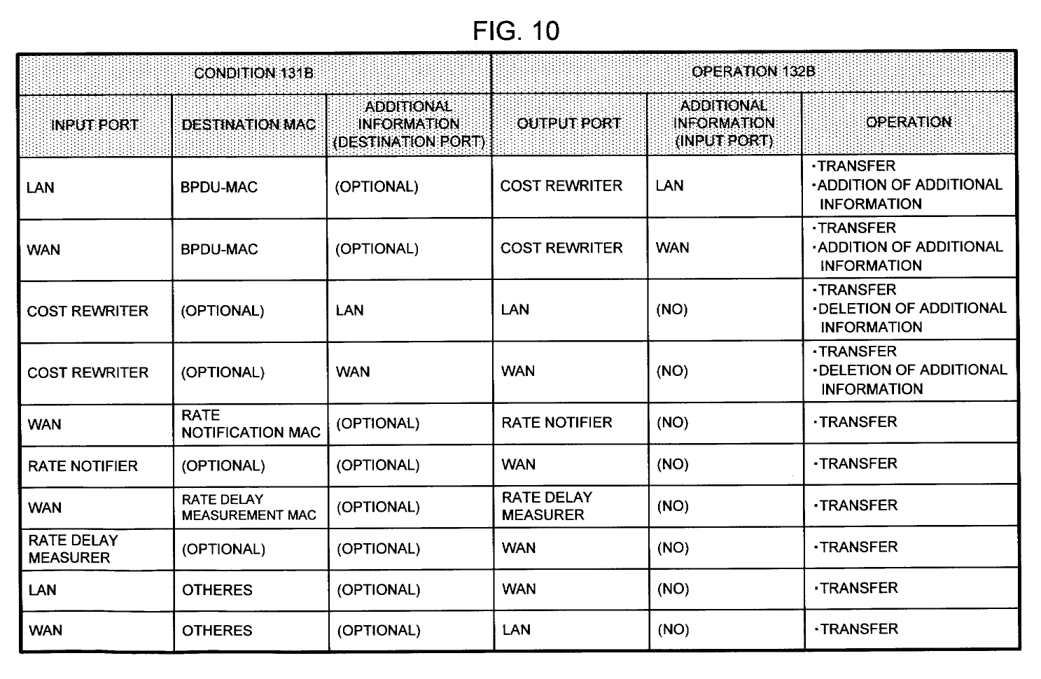

In a case of having received the frame from the LAN PORT 11, the WAN PORT 12, the cost rewriter 15, the rate notifier 16, and the rate delay measurer 17, a transfer controller 13B makes a reference to the input port, the destination MAC address, and the destination port thereof, decides an operation, an output port, and so on according to a table shown in FIG. 10 and transfers the frame to the LAN PORT 11, the WAN PORT 12, the cost rewriter 15, the rate identifier 16, and rate delay measurer 17. Further, the transfer controller 13B adds or deletes a header, a tag, a flag, or the like for a purpose of constructing a tunnel with the relay apparatus (relay apparatus 2) facing its own relay apparatus responding to a necessity. In addition hereto, it makes a buffering as well for a purpose of avoiding a frame collision, and further absorbing a rate difference between the LAN and the WAN.

When the BPDU frame is input from the LAN PORT 11 or the WAN PORT 12, the transfer controller 13B adds the input port identification information (the LAN PORT 11 or the WAN PORT 12) as additional information to the BPDU frame, and transfers it to the cost rewriter 15. Further, the transfer controller 13B receives the BPDU frame to which the destination port identification information (the LAN PORT 11 or the WAN PORT 12) has been added from the cost rewriter 15, and transfers it to the designated output port (the LAN PORT 11 or the WAN PORT 12). At this time, it deletes the output port identification information, and thereafter transfers the frame.

In a case of having received a notification of the link-up from the WAN PORT 12, or in a case of having a request from the user, the rate delay measurer 17 transmits/receives the measurement frame to/from the rate delay measurer facing it (the rate delay measurer 27), and notifies the measured rate to the port manager 14A. The measurement frame, which goes through the rate delay measurer 17, the transfer controller 13B, the WAN PORT 12, the WAN PORT 22, and a transfer controller 23B, arrives at the rate delay measurer 27.

The rate delay measurer 17 also requests the rate delay measurer 27 to transmit the measurement frame and to notify a measurement result, and computes a rate or a delay from the sent measurement frame. Herein, a result of the rate computation is notified to the port manager 14A.

At this time, the port manager 14A handles the rate notified from the rate delay measurer 17 in such a manner that is similar to the WAN rate notified from the WAN PORT 12 (The operation of the port manager 14A becomes similar to that of the second exemplary embodiment).

The transfer controller 23B is similar to the transfer controller 13B.

A transfer controller 33B is similar to the transfer controller 13B.

A transfer controller 43B is similar to the transfer controller 13B.

The rate delay measurer 27 is similar to the rate delay measurer 17.

The rate delay measurer 37 is similar to the rate delay measurer 17.

The rate delay measurer 47 is similar to the rate delay measurer 17.

(Explanation of an Operation)

Hereinafter, an operation of the rate delay measurer 17 in this exemplary embodiment will be explained by making a reference to FIG. 9. The operation after completing the measurement is similar to that of the second exemplary embodiment, so its explanation is omitted.

Upon receipt of a notification of the link-up from the WAN PORT 12, the rate delay measurer 17 transmits a pre-decided quantity of the measurement frame (the quantity of the frame that occupies the band of the WAN link for several seconds, or something like it) to the relay apparatus facing its own relay apparatus. The rate delay measurement MAC and the MAC address of the relay apparatus 1 have been set to the MAC DA and the MAC SA of the measurement frame, respectively, and the measurement frame transmitted from the rate delay measurer 17 arrives at the rate delay measurer 27 via the transfer controller 13B, the WAN PORT 12, the WAN PORT 22, and the transfer controller 23B.

Upon receipt of the measurement frame, the rate delay measurer 27 starts a measurement of the band. And, upon completing reception of the measurement frame, it gives a measurement result to the rate delay measurer 17 as a reply by transmitting a measurement result frame. The rate delay measurement MAC and the MAC address of the relay apparatus 2 have been set to the MAC DA and the MAC SA of the measurement result frame, respectively, and the measurement result frame transmitted from the rate delay measurer 27 arrives at the rate delay measurer 17 via the transfer controller 23B, the WAN PORT 22, the WAN PORT 12, and the transfer controller 13B.

Upon receipt of the measurement result frame, the rate delay measurer 17 notifies the rate described in the measurement result frame to the port manager 14A.

The port manager 14A receives a notification of the WAN rate from the rate delay measurer 17, and collates the notified rate with the condition 141A. And, the port manager 14A instructs the cost rewriter 15 to rewrite the frame with the designated rate and the LAN rate assumed to be 10 Mbps and 100 Mbps, respectively, when BPDU frame arrives because the LAN rate is 100 Mbps and the WAN rate is 10 Mbps, and in addition hereto, the rate notification has been not received.

Additionally, in this operational example, the measurement frame is transmitted from the rate delay measurer 17 to the rate delay measurer 27, and the measurement result frame is sent back from the rate delay measurer 27 to the rate delay measurer 17; however contrarily hereto, the measurement frame may be transmitted from the rate delay measurer 27 to the rate delay measurer 17, and the measurement result frame may be sent back from the rate delay measurer 17 to the rate delay measurer 27. Further, both of the above-mentioned methods may be employed at the same time.

Further, in this operational example, the band is measured by transmitting the measurement frame; however the band may be obtained from the delay by utilizing the fact that a delay-bandwidth product becomes a constant.

(Effects of the Invention)

Next, the effects of this exemplary embodiment will be explained.

Utilizing the invention listed in this exemplary embodiment makes it possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exists.

The reason is that in the relay apparatus (a transmission apparatus, a tunnel apparatus, or the like) that is inserted between the bridges etc., the port manager within the relay apparatus, upon receipt of a notification of the link rate from the port, investigates which side, out of the WAN side and the LAN side, becomes a bottleneck, and the cost rewriter within the relay apparatus rewrites the root path cost field within the BPDU in conformity to the rate of the bottleneck.

Further, utilizing the invention listed in this exemplary embodiment makes it possible to reflect an actually utilizable rate (a band of the bottleneck) in the path between the bridges etc. into the cost, to select an optimal path, and to enhance an efficiency of the net utilization also in a case where no bottleneck exists in the connection link of the relay apparatus for rewriting the root path cost.

The reason is that in the relay apparatus (a transmission apparatus, a tunnel apparatus, or the like) that is inserted between the bridges etc., the rate notifier within the relay apparatus notifies the latest rate of the bottleneck of its own to the relay apparatus facing its own relay apparatus, and contrarily receives a notification from the relay apparatus facing its own relay apparatus and notifies it to the port manager.

Further, utilizing the invention listed in this exemplary embodiment makes it possible to reflect a band of the bottleneck into the cost, to select an optimal path, and to enhance an efficiency of the net utilization in a case where the band of the WAN line fluctuates in some cases, and the link-up rate and the band of the bottleneck within the WAN net differ from each other in some cases.

The reason is that in the relay apparatus (a transmission apparatus, a tunnel apparatus, or the like) that is inserted between the bridges etc., the rate delay measurer within the relay apparatus measures the band of the WAN by transmitting/receiving the measurement frame.

### A Fourth Exemplary Embodiment

The fourth exemplary embodiment of the present invention differs from the third exemplary embodiment in a point of replacing the rate notifier 16 in the third exemplary embodiment with a result manager 18, sharing a delay measurement result among the relay apparatuses within the net, and deciding the cost from a relative delay quantity.

This enables the path selection in which the low delay takes priority over the wide band.

(Explanation of a Configuration)

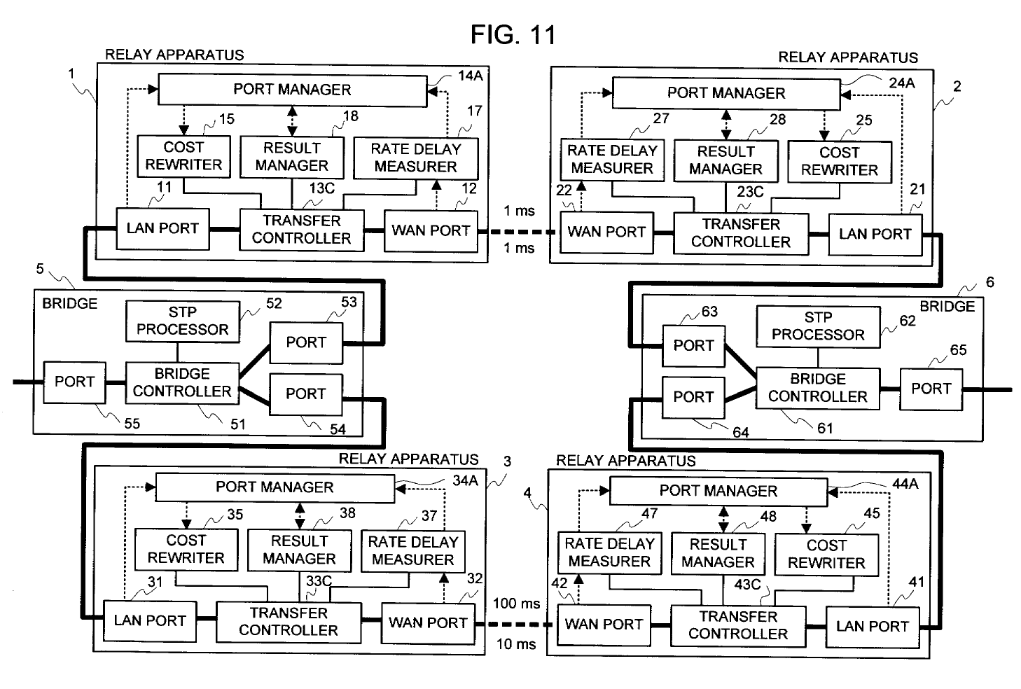

A configuration in this exemplary embodiment will be explained by making a reference to FIG. 11.

The fourth exemplary embodiment of the present invention differs from the third exemplary embodiment in a point of abolishing the rate notifier 16, and employing a result manager 18 instead thereof. Further, information of the delay quantity is sent from the rate delay measurer 17 to the result manager 18.

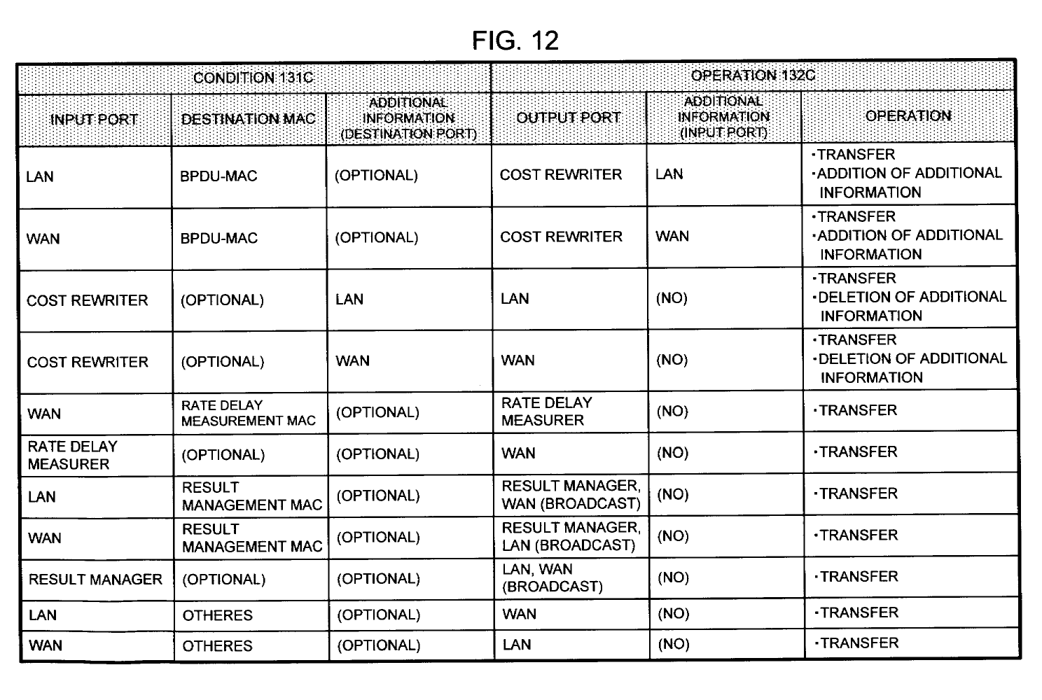

In a case of having received the frame from the LAN PORT 11, the WAN PORT 12, the cost rewriter 15, the result manager 18, and the rate delay measurer 17, a transfer controller 13C makes a reference to the input port, the destination MAC address, and the destination port thereof, decides an operation, an output port, and so on according to a table shown in FIG. 12 and transfers the frame to the LAN PORT 11, the WAN PORT 12, the cost rewriter 15, the result manager 18, and the rate delay measurer 17. Further, the transfer controller 13C adds or deletes a header, a tag, a flag, or the like for a purpose of constructing a tunnel with the relay apparatus (relay apparatus 2) facing its own relay apparatus responding to a necessity. In addition hereto, it makes a buffering as well for a purpose of avoiding a frame collision, and further absorbing a rate difference between the LAN and the WAN.

When the BPDU frame is input from the LAN PORT 11 or the WAN PORT 12, the transfer controller 13C adds the input port identification information (the LAN PORT 11 or the WAN PORT 12) as additional information to the BPDU frame, and transfers it to the cost rewriter 15. Further, the transfer controller 13C receives the BPDU frame to which the destination port identification information (the LAN PORT 11 or the WAN PORT 12) has been added from the cost rewriter 15, and transfers it to the designated output port (the LAN PORT 11 or the WAN PORT 12). At this time, it deletes the output port identification information, and thereafter transfers the frame.

A transfer controller 23C is similar to the transfer controller 13C.

A transfer controller 33C is similar to the transfer controller 13C.

A transfer controller 43C is similar to the transfer controller 13C.

In a case of having received a notification of the link-up from the WAN PORT 12, or in a case of having received a request from the user, the rate delay measurer 17 transmits/receives the measurement frame to/from the rate delay measurer (rate delay measurer 27) facing it, and notifies the measured rate to the port manager 14A. The measurement frame arrives at the rate delay measurer 27 via the rate delay measurer 17, the transfer controller 13C, the WAN PORT 12, the WAN PORT 22, and the transfer controller 23C.

The rate delay measurer 17 also requests the rate delay measurer 27 to transmit the measurement frame and to notify a measurement result, and computes a rate or a delay from the sent measurement frame. Herein, a result of the rate computation is notified to the port manager 14A, and a result of the delay quantity is notified to the result manager 18.

At this time, the port manager 14A handles the rate notified from the rate delay measurer 17 in such a manner that it is similar to the WAN rate notified from the WAN PORT 12 (The other operations of the port manager 14A become similar to that of the third exemplary embodiment).

The rate delay measurer 27 is similar to the rate delay measurer 17.

The rate delay measurer 37 is similar to the rate delay measurer 17.

The rate delay measurer 47 is similar to the rate delay measurer 17.

In a case of having received a notification of the delay from the rate delay measurer 17, the result manager 18 records this delay quantity, and simultaneously therewith, conveys the delay to all other relay apparatuses (the relay apparatus 2, the relay apparatus 3, and the relay apparatus 4) within the network. This notification is performed by preparing a result management frame of which the destination MAC address and the transmission source MAC address are a result management MAC address (for example: specially-subscribed MAC address such as 00-00-4C-00-00-02), and an MAC address of the relay apparatus 1, respectively. The result management frame, which is transmitted from the result manager 18, is broadcast to both of the LAN and the WAN by the transfer controller 13C.

In a case of having received the result management frame from the transfer controller 13C, the result manager 18 records the delay quantity, which is included in the result management frame, together with the transmission source MAC address of the result management frame. And, the result manager 18 compares the already-recorded delay quantity received up to this point with the delay quantity received from the rate delay measurer 17, and computes a relative magnitude of the delay notified from the rate delay measurer 17. For example, when the delay notified from the rate delay measurer 17 is 1 ms, the delay notified from the relay apparatus 3 is 100 ms, and the delay notified from the relay apparatus 4 is 10 ms, the result manager 18 makes a report of the band saying the reception rate=100 Mbps to the port manager 14A

At this time, the port manager 14A handles the rate notified from the result manager 18 in such a manner that it is similar to the LAN rate of the relay apparatus facing its own relay apparatus notified from the rate notifier 16 (The other operations of the port manager 14A becomes similar to that of the third exemplary embodiment).

A result manager 28 is similar to the result manager 18.

A result manager 38 is similar to the result manager 18.

A result manager 48 is similar to the result manager 18.

(Explanation of an Operation)

Hereinafter, an operation of the result manager 18 in this exemplary embodiment will be explained by making a reference to FIG. 11.

Herein, it is assumed that the PORT 64 of the bridge 6 has been closed with the spanning tree.

Herein, it is assumed that a delay 1 ms, a delay 100 ms, and a delay 10 ms have been already broadcast to each relay apparatus by the result manager 28 within the relay apparatus 2, the result manager 38 within the relay apparatus 3, and the result manager 48 within the relay apparatus 4, respectively.

The rate delay measurer 17 measures the WAN band with the method described in the explanation of the operation in the third exemplary embodiment, and notifies its result to the port manager 14A.

In addition hereto, the rate delay measurer 17 transmits the delay measurement frame to the relay apparatus facing its own relay apparatus. The rate delay measurement MAC and the MAC address of the relay apparatus 1 have been set to the MAC DA and the MAC SA of the delay measurement frame, respectively, and the delay measurement frame transmitted from the rate delay measurer 17 arrives at the rate delay measurer 27 via the transfer controller 13C, the WAN PORT 12, the WAN PORT 22, and the transfer controller 23C.

Upon receipt of the delay measurement frame, the rate delay measurer 27 immediately transmits a delay response frame to the rate delay measurer 17. The rate delay measurement MAC and the MAC address of the relay apparatus 2 have been set to the MAC DA and the MA SA of the delay response frame, respectively, and the delay response frame transmitted from the rate delay measurer 27 arrives at the rate delay measurer 17 via the transfer controller 23C, the WAN port 22, the WAN PORT 12, and the transfer controller 13C.

Upon receipt of the delay response frame, the rate delay measurer 17 computes a round trip delay from a difference between a transmission time and a reception time, and notifies its result to the result manager 18. Hereinafter, the explanation is continued on the premise that the delay is 1 ms.

The result manager 18 receives a notification of the delay from the rate delay measurer 17, and records the notified delay quantity (1 ms). And, the result manager 18 performs the following operations shown in (1) and (2).

(1) It compares the already-received delay obtained from the result management frame with the delay quantity (1 ms) received from the rate delay measurer 17, and computes a relative magnitude of the delay notified from the rate delay measurer 17. Herein, if it is assumed that the delay of 100 ms and the delay of 10 ms have been already notified to the result manager 18 by the relay apparatus 3 and the relay apparatus 4, respectively, the result manager 18 makes a report of the band saying the reception rate=100 Mbps to the port manager 14A

(2) It broadcasts the result management frame so as to convey the delay to all other relay apparatuses (the relay apparatus 2, the relay apparatus 3, and the relay apparatus 4) within the network. The result management MAC and the MAC address of the relay apparatus 1 have been set to the destination MAC address and the transmission source MAC address of the result management frame, respectively, and the result management frame, which is transmitted from the result manager 18, is broadcast to both of the LAN and the WAN by the transfer controller 13C. Additionally, in the operational example of this exemplary embodiment, the minimum delay and the maximum delay within the network were 1 ms and 100 ms, respectively, whereby the location of the maximum delay was handled as a location of 1 Mbps and the location of the minimum delay was handled as a location of 100 Mbps (if the maximum delay is 1000 ms, the location of the minimum delay is handled as a location of 1000 Mbps). The reason why the delay is converted into the rate is that the port manager 14A determines the operation not with the delay but the rate.

Upon receipt of a notification of the rate (10 Mbps) from the result manager 18, the port manager 14A handles this similarly to the rate notification from the rate notifier 26 in the second exemplary embodiment, and gives an instruction associated with the cost rewrite to the cost rewriter 15 if necessary.

The frame transmitted to the WAN PORT 12 side, out of the result management frames, is broadcast to the result manager 28 and the LAN PORT 21 side by the transfer controller 23C within the relay apparatus 2.

In a case of having received the result management frame from the transfer controller 23C, the result manager 28 records the delay quantity (1 ms), which is included in the result management frame, together with the transmission source MAC address (the MAC address of the relay apparatus 1) of the result management frame. And, the result manager 28 compares the already-received delay obtained from the result management frame with the delay quantity (1 ms) received from the rate delay measurer 27, and computes a relative magnitude of the delay notified from the rate delay measurer 27. Herein, if it is assumed that the delay of 100 ms and the delay of 10 ms have been already notified to the result manager 28 from the relay apparatus 3 and the relay apparatus 4, respectively, the result manager 28 makes a report of the band saying the reception rate=100 Mbps to the port manager 24A.

Upon receipt of a notification of the rate (10 Mbps) from the result manager 28, the port manager 24A handles this similarly to the rate notification from the rate notifier 26 in the second exemplary embodiment, and gives an instruction associated with the cost rewrite to the cost rewriter 25 if necessary.

The frame broadcast to the LAN PORT 21 side, out of the result management frames, is broadcast to the PORT 64 and the PORT 65 also in the bridge controller 61 within the bridge 6. However, the frame broadcast to the PORT 64 side is cancelled because the PORT 64 has been closed. Further, the frame transmitted to the PORT 65 side, which continues to be broadcast also in a LAN segment subsequent hereto, become extinct after all.

The frame transmitted to the LAN PORT 11 side, out of the result management frames, is broadcast to the PORT 54 and the PORT 55 also in the bridge controller 51 within the bridge 5. The frame transmitted to the PORT 55 side, which continues to be broadcast also in the LAN segment subsequent hereto, become extinct after all.

The frame broadcast to the PORT 54 side is broadcast to the result manager 38 and the WAN PORT 32 side in the transfer controller 33C within the relay apparatus 3.

In a case of having received the result management frame from the transfer controller 33C, the result manager 38 records the delay quantity (1 ms), which is included in the result management frame, together with the transmission source MAC address (the MAC address of the relay apparatus 1) of the result management frame. And, the result manager 38 compares the already-received delay obtained from the result management frame with the delay quantity received from the rate delay measurer 37, and computes a relative magnitude of the delay (100 ms) notified from the rate delay measurer 37. Herein, if it is assumed that the delay of 1 ms and the delay of 10 ms have been already notified to the result manager 38 from the relay apparatus 2 and the relay apparatus 4, respectively, the result manager 38 makes a report of the band saying the reception rate=1 Mbps to the port manager 34A.

Upon receipt of a notification of the rate (1 Mbps) from the result manager 38, the port manager 34A handles this similarly to the rate notification from the rate notifier 36 in the second exemplary embodiment, and gives an instruction associated with the cost rewrite to the cost rewriter 35 if necessary.

The frame broadcast to the WAN PORT 32 side, out of the result management frames, is broadcast to the result manager 48 and the LAN PORT 41 side in the transfer controller 43C within the relay apparatus 4.

In a case of having received the result management frame from the transfer controller 43C, the result manager 48 records the delay quantity (1 ms), which is included in the result management frame, together with the transmission source MAC address (the MAC address of the relay apparatus 1) of the result management frame. And, the result manager 48 compares the already-received delay obtained from the result management frame with the delay quantity received from the rate delay measurer 47, and computes a relative magnitude of the delay (10 ms) notified from the rate delay measurer 47. Herein, if it is assumed that the delay of 1 ms and the delay of 100 ms have been already notified to the result manager 48 from the relay apparatus 2 and the relay apparatus 3, respectively, the result manager 48 makes a report of the band saying the reception rate=10 Mbps to the port manager 44A.

Upon receipt of a notification of the rate (10 Mbps) from the result manager 48, the port manager 44A handles this similarly to the rate notification from the rate notifier 46 in the second exemplary embodiment, and gives an instruction associated with the cost rewrite to the cost rewriter 45 if necessary.

The cost rewrite in the cost rewriter 15, the path selection operation in the bridge 6, or the like, which is performed after the above-mentioned operations are completed, is similar to that of the exemplary embodiment 1, and its explanation is omitted.

(Effects of the Invention)

Next, the effects of this exemplary embodiment will be explained.

Utilizing the invention listed in this exemplary embodiment makes it possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exists.

The reason is that in the relay apparatus (a transmission apparatus, a tunnel apparatus, or the like) that is inserted between the bridges etc., the port manager within the relay apparatus, upon receipt of a notification of the link rate from the port, investigates which side, out of the WAN side and the LAN side, becomes a bottleneck, and the cost rewriter within the relay apparatus rewrites the root path cost field within the BPDU in conformity to the rate of the bottleneck.

Further, utilizing the invention listed in this exemplary embodiment makes it possible to reflect a band of the bottleneck into the cost, to select an optimal path, and to enhance an efficiency of the net utilization in a case where the band of the WAN line fluctuates in some cases, and the link-up rate and the band of the bottleneck within the WAN net differ from each other in some cases.

The reason is that in the relay apparatus (a transmission apparatus, a tunnel apparatus, or the like) that is inserted between the bridges etc., the rate delay measurer within the relay apparatus measures the band of the WAN by transmitting/receiving the measurement frame.

Further, utilizing the invention listed in this exemplary embodiment makes it possible to perform the path selection in which the low delay takes priority over the wide band.

The reason is that in the relay apparatus (a transmission apparatus, a tunnel apparatus, or the like) that is inserted between the bridges etc., the result manager within the relay apparatus broadcasts the delay notified from the rate delay measurer to other relay apparatuses within the net, and contrarily receives a notification of the delay quantity from the other relay apparatuses within the net, converts its relative delay into a band (a rate), and thereafter notifies it the port manager.

### A Fifth Exemplary Embodiment

The cost rewriter 15 in the first exemplary embodiment computed the cost without paying attention to a VLAN, whereas in the fifth exemplary embodiment of the present invention, a cost rewriter 15A assigns the band to respective VLANs fairly, or at a set ratio by pre-setting a ratio of the VLAN, which passes through, and the band, which is utilized, in the network that is configured of the multiple spanning tree being specified by the IEEE 802. 1s. This makes it possible to detour a dense spot through which many VLANs pass, and to enhance a utilization efficiency of the entirety of the network.

(Explanation of a Configuration)

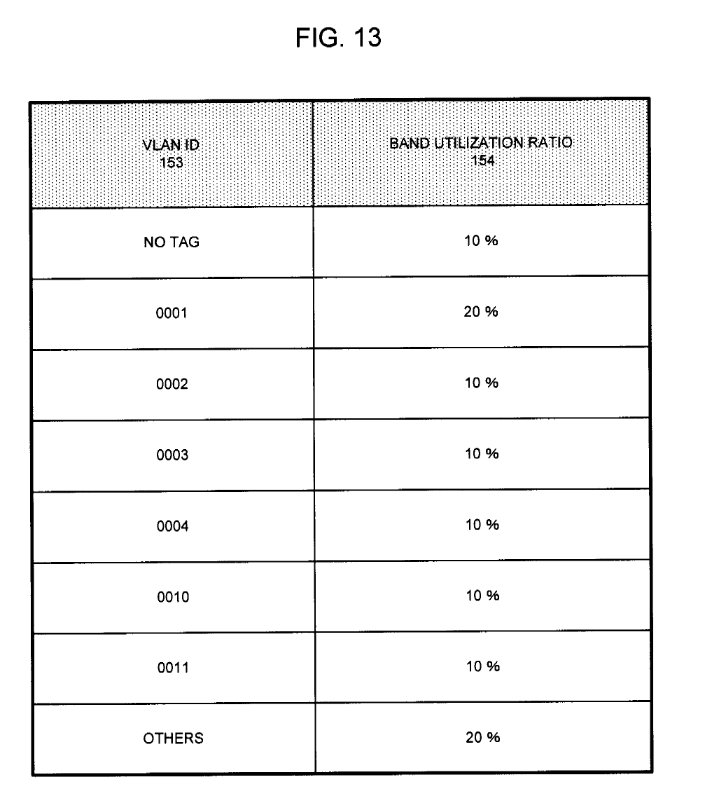

A configuration in this exemplary embodiment will be explained by making a reference to FIG. 2 and FIG. 13.

In the fifth exemplary embodiment of the present invention, the cost rewriter 15 in the first exemplary embodiment shown in FIG. 2 is replaced with the cost rewriter 15A, and the cost is computed VLAN by VLAN.

The cost rewriter 15A has five functions shown below in addition to the operation of the cost rewriter 15 in the first exemplary embodiment.

1) A function of accepting the setting of the VLAN that passes through the link, and the by-VLAN band utilization ratio, as illustrated in a setting example of FIG. 13.

2) A function of computing the cost responding to the pre-set by-VLAN band utilization ratio at the time of rewriting the “Root Path Cost”.

3) A function of, when the BPDU frame with no VLAN tag arrives, computing the cost at the band utilization ratio described correspondingly to “No Tag of VLAN ID”.

4) A function of, when the frame of which “VLAN ID” has not been registered in VLAN ID 153 arrives, computing the cost at the band utilization ratio described correspondingly to “otheres of VLAN ID”.

5) A function of learning the VLAN ID of the BPDU frame that has arrived, and automatically setting the VLAN ID 153 and the band utilization ratio 154 of FIG. 13 so that the band is fairly assigned to each VLAN, in addition to a function of the manual setting shown in 1.

A cost rewriter 25A is similar to the cost rewriter 15A.

A cost rewriter 35A is similar to the cost rewriter 15A.

A cost rewriter 45A is similar to the cost rewriter 15A.

### THE OPERATIONAL EXAMPLE

Hereinafter, operations of the cost rewriter 15A and the cost rewriter 25A in this exemplary embodiment will be explained by making a reference to FIG. 2 and FIG. 13.

(The Operational Example: a Precondition and an Initial Operation)

The setting shown in FIG. 13 is made to the cost rewriter 15A, the cost rewriter 25A, the cost rewriter 35A, and the cost rewriter 45A, respectively.

Herein, it is assumed that the Multiple Spanning Tree Protocol (the Multiple Rapid Spanning Tree specified in the IEEE 802. 1s) operates in the bridge 5 and the bridge 6. Further, it is assumed that the bridge 5 is a root node in all STP planes (VLAN).

The other precondition and initial operation abide by the operational example (precondition and initial operation) in the first exemplary embodiment.

(The Operational Example: Explanation of an Operation in the Path 91)

The STP processor 52 within the bridge 5 transmits the RST-BPDU frame to the PORT 53 through the bridge controller 51. and “Designated” have been set to this frame, to which the VLAN tag (VLAN ID 0002) has been added, as a RPC (Root Path Cost) and a port state, respectively. (The bridge 5 has become a root node.)

The transfer controller 13 within the relay apparatus 1 receives the RST-BPDU frame from the LAN PORT 11, and collates the input port and the destination MAC thereof with the condition 131 of FIG. 3, respectively. And, the transfer controller 13 makes a reference to the operation 132, adds the LAN port to the frame that was input as additional information (input port), and outputs the RST-BPDU frame to the cost rewriter because the input port is a LAN port and the destination MAC is “BPDU-MAC”. Additionally, the transfer controller 13 operates similarly irrespective of presence or absence of the VLAN tag, or the VLAN ID.

Upon receipt of the RST-BPDU frame from the transfer controller 13, the cost rewriter 15A returns it to the transfer controller 13 as it stands because the input port is “LAN” and the port state is “Designated”. At this moment, it sets the WAN as additional information (destination port).

The transfer controller 13 receives the RST-BPDU frame, and the WAN as a destination port from the cost rewriter, and outputs the frame to the WAN PORT 12 according to the condition 131 and the operation 132 shown in FIG. 3. At this moment, it deletes the additional information.

The transfer controller 23 within the relay apparatus 2 receives the RST-BPDU frame from the WAN PORT 22, and collates the input port and the destination MAC thereof with the condition 131 of FIG. 3, respectively. And, the transfer controller 23 makes a reference to the operation 132, adds the WAN port to the frame that was input as additional information (input port), and outputs the RST-BPDU frame to the cost rewriter because the input port is a WAN port and the destination MAC is “BPDU-MAC”. Additionally, the transfer controller 23 operates similarly irrespective of presence or absence of the VLAN tag, or the VLAN ID.

Upon receipt of the RST-BPDU frame from the transfer controller 23, the cost rewriter 25A collates it with the condition 151 of FIG. 5 and makes a reference to the corresponding operation 152 because the input port is “WAN” and the port state is “designated”.

Computation of the “Root Path Cost” is performed so that 10% of the designated rate 1 Mbps, i.e. 100 kbps is satisfied because making a reference to the VLAN ID 153 shown in FIG. 13 demonstrates that the band utilization ratio 154 that corresponds to the VLAN ID 0002 is 10%. Thus, the cost rewriter 25A, which has already been instructed by the port manager 24 to rewrite the frame with the designated rate and the LAN rate assumed to be 1 Mbps and 100 Mbps, respectively, when the BPDU frame arrives, rewrites the cost into new “Root Path Cost”=old “Root Path Cost” (0)+200000000−200000=199800000, which is derived by assuming the cost equivalent to the portion of 100 kbps and the cost equivalent to the portion of 100 Mbps to be 200000000 and 200000, respectively, and thereafter returns the frame to the transfer controller 23. At this moment, it sets the LAN as additional information (destination port).

The transfer controller 23 receives the RST-BPDU frame, and the LAN as a destination port from the cost rewriter, and outputs the frame to the LAN PORT 21 according to the condition 131 and the operation 132 shown in FIG. 3. At this moment, it deletes the additional information.

When the RST-BPDU frame arrives from the PORT 63, the bridge controller 61 within the bridge 6 transfers it to the STP processor 62.

The STP processor 62 receives the RST-BPDU frame with “VLAN ID 0002” from the bridge controller 61, and computes the root path cost of the path 91. At this time, the STP processor 62 recognizes that the root path cost of the path 91 is 199800000+200000=200000000 because the PORT 63 has been linked up at 100 Mbps, and in addition hereto, 199800000 has been set to the “Root Path Cost” value of the RST-BPDU that was input. In short, it recognizes that the band of path 91 in the VLAN 0002 is 100 kbps.

The root path cost was rewritten from 0 to 199800000 in the transfer of the BPDU in the outward trip described above. For this, the root path cost is to be rewritten from 199800000 to 0 in the transfer of the BPDU in the return trip.

Additionally, in this operational example, the case of manually setting the VLAN ID 153 and the band utilization ratio 154 shown in FIG. 13 was exemplified; however the cost rewriter 15A can learn the VLAN ID of the BPDU frame that has arrived, thereby to automatically set the VLAN ID 153 and the band utilization ratio 154 of FIG. 13 so that the band is fairly assigned to each VLAN.

(Effects of the Invention)

Next, the effects of this exemplary embodiment will be explained.

Utilizing the invention listed in this exemplary embodiment makes it possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exists.

The reason is that in the relay apparatus (a transmission apparatus, a tunnel apparatus, or the like) that is inserted between the bridges etc., the port manager within the relay apparatus, upon receipt of a notification of the link rate from the port, investigates which side, out of the WAN side and the LAN side, becomes a bottleneck, and the cost rewriter within the relay apparatus rewrites the root path cost field within the BPDU in conformity to the rate of the bottleneck.

Further, utilizing the invention listed in this exemplary embodiment makes it possible to avoid the dense path on which the setting of the VLAN concentrates, to keep fairness among the VLANs, and to enhance an efficiency of the net utilization in the network that is configured of the multiple spanning trees that are specified by the IEEE 802. 1s.

The reason is that in the relay apparatus (a transmission apparatus, a tunnel apparatus, or the like) that is inserted between the bridges etc., the cost rewriter within the relay apparatus rewrites the “Root Path Cost” responding to the by-VLAN band utilization ratio.

### A Sixth Exemplary Embodiment

In the sixth exemplary embodiment of the present invention, in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exist, the relay apparatus (a transmission apparatus, a tunnel apparatus, or the like) that is inserted between the bridges etc., upon receipt of a notification of the link rate from the port, investigates which side, out of the WAN side and the LAN side, becomes a bottleneck, and controls the link rate in conformity to either the WAN-side link rate or the LAN-side link rate, whichever is lower, thereby allowing a band of the bottleneck to be reflected into the cost, an optimal path to be selected, and an efficiency of the net utilization to be enhanced without making a setting or a modification to the apparatus (bridge etc.) in which the path control protocol operates.

The sixth exemplary embodiment of the present invention differs from the second exemplary embodiment, in which the cost rewriter 15 rewrites the cost being included in the BPDU responding to the rate of the bottleneck, in a point that a port manager 14D causes each of the LAN-side rate and the WAN-side rate to coincide with the other by lowering either the former or the latter, whichever is higher. Causing each of the LAN-side rate and the WAN-side rate to coincide with the other by lowering either the former or the latter, whichever is higher, enables each bridge to correctly compute the path because the rates of all links coincide with the rate of the bottleneck band over the path between the bridges. Additionally, the identical numeral is affixed to a component similar to that of the above-mentioned exemplary embodiments, and its detailed explanation is omitted.

(Explanation of a Configuration)

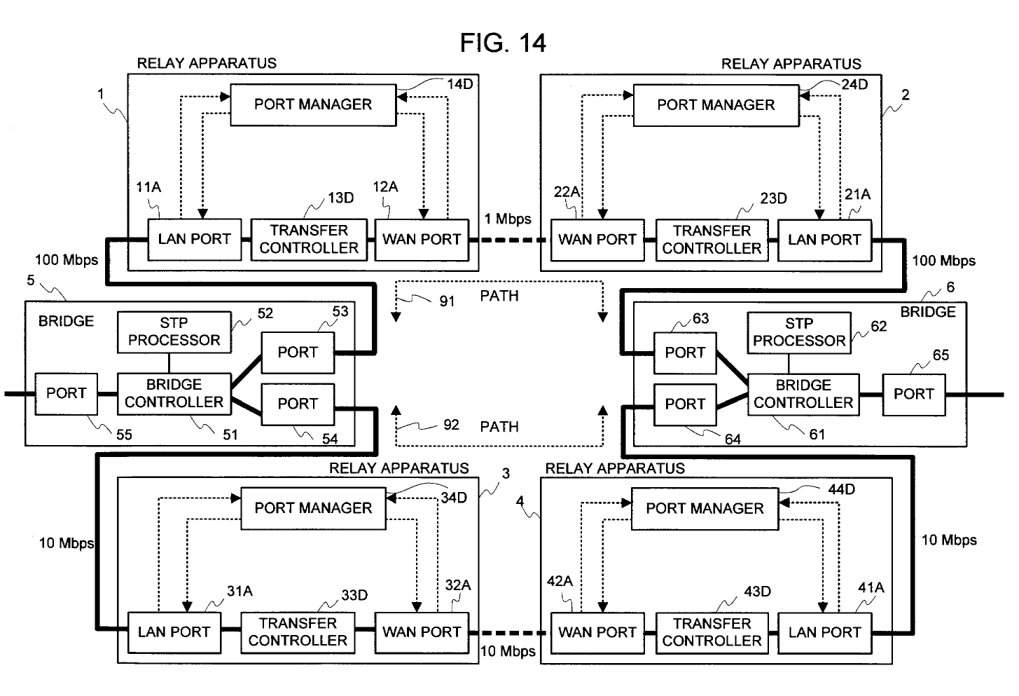

A configuration in this exemplary embodiment will be explained by making a reference to FIG. 14.

The relay apparatus 1 of this exemplary embodiment, which loses the cost rewriter 15 and the rate notifier 16 of the second embodiment, includes a LAN PORT 11A instead of the LAN PORT 11, a WAN PORT 12A instead of the WAN PORT 12, a transfer controller 13D instead of the transfer controller 13, and a port manager 14D instead of the port manager 14.

The LAN PORT 11A, which is a port for accommodating the LAN-side Ethernet link, notifies the link rate to the port manager 14D at the time of the link-up, and in addition hereto, notifies the fact that the link communication has been lost to the port manager 14D at the time of the link-down. In addition hereto, when the link rate is designated by the port manager 14D, the LAN PORT 11A changes the link rate so that it becomes a designated rate.

The WAN PORT 12A, which is a port for accommodating the WAN-side link (Ethernet etc.), notifies the link rate to the port manager 14D at the time of the link-up, and in addition hereto, notifies the fact that the link communication has been lost to the port manager 14D at the time of the link-down. Further, the WAN PORT 12A performs the processes as well such as a process of converting an electric signal into an optical signal, and a process of encoding and decoding for extending a transmission distance responding to a necessity. In addition hereto, when the link rate is designated by the port manager 14D, the WAN PORT 12A changes the link rate so that it becomes a designated rate.

The transfer controller 13D receives the frame from the LAN PORT 11A, adds a header, a tag, a flag, or the like for a purpose of constructing a tunnel with the relay apparatus (relay apparatus 2) facing its own relay apparatus responding to a necessity, and in addition hereto, makes a buffering for a purpose of absorbing a rate difference between the LAN and the WAN and outputs the frame to the WAN PORT 12A.

The transfer controller 13D also receives the frame from the WAN PORT 12A, deletes a header, a tag, a flag, or the like for a purpose of constructing a tunnel with the relay apparatus (relay apparatus 2) facing its own relay apparatus responding to a necessity, and in addition hereto, makes a buffering for a purpose of absorbing a rate difference between the LAN and the WAN and outputs the frame to the LAN PORT 11A.

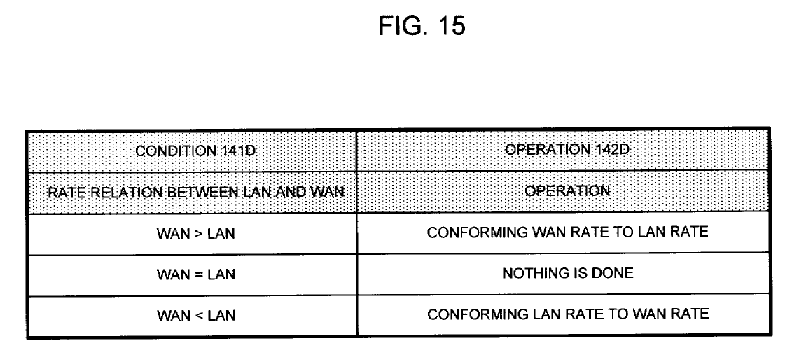

The port manager 14D receives a notification of the link rate decided with the auto-negotiation etc. at the time of the link-up or at the time of the link-down from the LAN PORT 11A and the WAN PORT 12A, decides an operation according to a table shown in FIG. 15, and instructs the LAN PORT 11A or the WAN PORT 12A to change the link rate responding to a necessity. Additionally, the notified rate is preserved until the next-time notification is issued (The rate being preserved is not a rate changed by an instruction for changing the link rate given by the port manager 14D but a not-yet-changed link rate notified from the port, which has been decided with the auto-negotiation etc.) Further, the decision of the operation using the table as a reference is made not only at the time of having received a notification of the link rate, but also for each constant time period.

FIG. 15 is a table to which the port manager 14D in the sixth exemplary embodiment makes a reference for deciding an operation at the moment of having received the link-up rate or the rate notification.

A condition 141D is an index (a key) for retrieving an operation 142D responding to the notified link-up rate or rate notification. There is an item of a rate relation between the LAN and the WAN in the condition 141D, and the port manager 14D searches the condition 141D at the time of receiving a notification of the link-up rate from the LAN PORT 11A and the WAN PORT 12A, and decides the operation 142D.

The operation 142D is an operation that is retrieved with the condition 141D assumed to be an index, and the instruction as to how to change the link rate is described in the operation 142D.

### The Operational Example 1

Hereinafter, an operation in this exemplary embodiment will be explained by making a reference to FIG. 14 with the case of the network configuration similar to the configuration having the problem caused by the related art shown in FIG. 1 and the link rate thereof as an example.

(The Operational Example 1: a Precondition and an Initial Operation)

Herein, it is assumed that the Spanning Tree Protocol (the Rapid Spanning Tree specified in the old IEEE 802. 1w) operates in the bridge 5 and the bridge 6. Further, it is assumed that the bridge 5 is a root node.

Herein, it is assumed that the link between the relay apparatus 1 and the relay apparatus 2 has been linked-up at 1 Mbps.

The WAN PORT 12A notifies the effect that the link has been linked-up at 1 Mbps to the port manager 14D.

A WAN PORT 22A notifies the effect that the link has been linked-up at 1 Mbps to a port manager 24D.

Herein, it is assumed that the link between the relay apparatus 3 and the relay apparatus 4 has been linked-up at 10 Mbps.

A WAN PORT 32A notifies the effect that the link has been linked-up at 10 Mbps to a port manager 34D.

A WAN PORT 42A notifies the effect that the link has been linked-up at 10 Mbps to a port manager 44D.

Herein, it is assumed that the link between the relay apparatus 1 and the bridge 5, and the link between the relay apparatus 2 and the bridge 6 have been linked-up at 100 Mbps, respectively.

The LAN PORT 11A notifies the effect that the link has been linked-up at 100 Mbps to the port manager 14D.

A LAN PORT 21A notifies the effect that the link has been linked-up at 100 Mbps to the port manager 24D.

Herein, it is assumed that the link between the relay apparatus 3 and the bridge 5, and the link between the relay apparatus 4 and the bridge 6 have been linked-up at 10 Mbps, respectively.

A LAN PORT 31A notifies the effect that the link has been linked-up at 10 Mbps to the port manager 34D.

A LAN PORT 41A notifies the effect that the link has been linked-up at 10 Mbps to the port manager 44D.

The port manager 14D receives a notification of the link-up from the LAN PORT 11A and the WAN PORT 12A, and collates the notified rate with the condition 141D. And, it instructs the LAN PORT 11A to change the link-up rate to 1 Mbps because the LAN rate is 100 Mbps and the WAN rate is 1 Mbps.

The port manager 24D receives a notification of the link-up from the LAN PORT 21A and the WAN PORT 22A, and collates the notified rate with the condition 141D.

And, it instructs the LAN PORT 21A to change the link-up rate to 1 Mbps because the LAN rate is 100 Mbps and the WAN rate is 1 Mbps.

The port manager 34D receives a notification of the link-up from the LAN PORT 31A and the WAN PORT 32A, and collates the notified rate with the condition 141D. And, it continues to monitor the port rate without doing anything because the LAN rate is 10 Mbps and the WAN rate is 10 Mbps.

The port manager 44D receives a notification of the link-up from the LAN PORT 41A and the WAN PORT 42A, and collates the notified rate with the condition 141D. And, it continues to monitor the port rate without doing anything because the LAN rate is 10 Mbps and the WAN rate is 10 Mbps.

The LAN PORT 11A receives an instruction for changing the link-up rate to 1 Mbps from the port manager 14D, and lowers the link-up rate to 1 Mbps.

The PORT 53 lowers the link-up rate to 1 Mbps with the auto-negotiation because the LAN PORT 11A has lowered the link-up rate to 1 Mbps.

The LAN PORT 21A receives an instruction for changing the link-up rate to 1 Mbps from the port manager 24D, and lowers the link-up rate to 1 Mbps.

The PORT 63 lowers the link-up rate to 1 Mbps with the auto-negotiation because the LAN PORT 21A has lowered the link-up rate to 1 Mbps.

(The Operational Example 1: Explanation of an Operation in the Path 91)

The STP processor 52 within the bridge 5 transmits the RST-BPDU frame to the PORT 53 through the bridge controller 51. and “Designated” have been set to this frame as a RPC (Root Path Cost) and a port state, respectively. (The bridge 5 has become a root node.)

The transfer controller 13D within the relay apparatus 1 receives the RST-BPDU frame from the LAN PORT 11A, and outputs the frame to the WAN PORT 12A.

A transfer controller 23D within the relay apparatus 2 receives the RST-BPDU frame from the WAN PORT 22A, and outputs the frame to the LAN PORT 21A.

When the RST-BPDU frame arrives from the PORT 63, the bridge controller 61 within the bridge 6 transfers it to the STP processor 62.

The STP processor 62 receives the RST-BPDU frame from the bridge controller 61, and computes the root path cost of the path 91. At this time, the STP processor 62 recognizes that the root path cost of the path 91 is 0+20000000=20000000 because the PORT 63 has been linked up at 1 Mbps, and in addition hereto, 0 has been set to the “Root Path Cost” value of the RST-BPDU that was input. In short, it recognizes that the band of path 91 is 1 Mbps.

(The Operational Example 1: Explanation of an Operation in the Path 92)

The STP processor 52 within the bridge 5 transmits the RST-BPDU frame to the PORT 54 through the bridge controller 51. and “Designated” have been set to this frame as a RPC (Root Path Cost) and a port state, respectively. (The bridge 5 has become a root node.)

A transfer controller 33D within the relay apparatus 3 receives the RST-BPDU frame from the LAN PORT 31A, and outputs the frame to the WAN PORT 32A.

A transfer controller 43D within the relay apparatus 4 receives the RST-BPDU frame from the WAN PORT 42A, and outputs the frame to the LAN PORT 41A.

When the RST-BPDU frame arrives from the PORT 64, the bridge controller 61 within the bridge 6 transfers it to the STP processor 62.

The STP processor 62 receives the RST-BPDU frame from the bridge controller 61, and computes the root path cost of the path 92. At this time, the STP processor 62 recognizes that the root path cost of the path 92 is 0+2000000=2000000 because the PORT 64 has been linked up at 10 Mbps, and in addition hereto, 0 has been set to the “Root Path Cost” value of the RST-BPDU that was input. In short, it recognizes that the band of path 92 is 10 Mbps.

(The Operational Example 1: a Path Selection in the Bridge 6)

The STP processor 62 within the bridge 6 recognizes that the root path cost of the path 91 is 20000000 (1 Mbps), and the root path cost of the path 92 is 2000000 (10 Mbps) from the operation described up to this point. For this, the STP processor 62 closes the port in the path 91 side, thereby preventing the frame from being transmitted/received to/from the port in the path 91 side. In short, communication between the bridge 5 and the bridge 6 results in being all made through the path 92.

Upon comparing the maximum band (1 Mbps) of the path 91 with the maximum band (10 Mbps) of the path 92, the latter is larger. Thus, the optimal path was selected.

With the above explanation, it was demonstrated that applying the configuration shown in this exemplary embodiment allowed a cost to be computed normally, and an optimal path to be selected also in a case where a difference existed between an actually utilizable rate and a link rate of the connection link when the STP was utilized among the LANs (user network etc.) spanning the WAN (carrier network etc.).

### An Operational Example 2

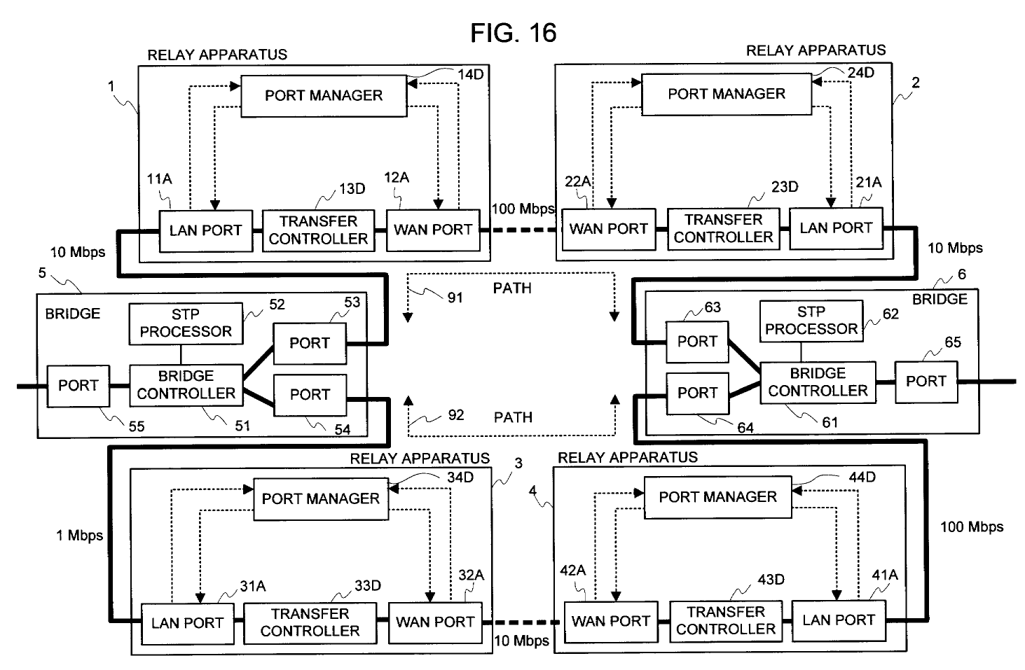

Hereinafter, an operation in this exemplary embodiment will be explained by making a reference to FIG. 16 with the operation of the subordinate node (bridge 6) in the case that the band of the connection link of the root node (bridge 5) is smallest in the path as an example.

(The Operational Example 2: a Precondition and an Initial Operation)

Herein, it is assumed that the Spanning Tree Protocol (the Rapid Spanning Tree specified in the old IEEE 802. 1w) operates in the bridge 5 and the bridge 6. Further, it is assumed that the bridge 5 is a root node.

Herein, it is assumed that the link between the relay apparatus 1 and the relay apparatus 2 has been linked-up at 100 Mbps.

The WAN PORT 12A notifies the effect that the link has been linked-up at 100 Mbps to the port manager 14D.

The WAN PORT 22A notifies the effect that the link has been linked-up at 100 Mbps to the port manager 24D.

Herein, it is assumed that the link between the relay apparatus 3 and the relay apparatus 4 has been linked-up at 10 Mbps.

The WAN PORT 32A notifies the effect that the link has been linked-up at 10 Mbps to the port manager 34D.

The WAN PORT 42A notifies the effect that the link has been linked-up at 10 Mbps to the port manager 44D.

Herein, it is assumed that the link between the relay apparatus 1 and the bridge 5 has been linked-up at 10 Mbps.

The LAN PORT 11A notifies the effect that the link has been linked-up at 10 Mbps to the port manager 14D.

Herein, it is assumed that the link between the relay apparatus 2 and the bridge 6 has been linked-up at 10 Mbps.

The LAN PORT 21A notifies the effect that the link has been linked-up at 10 Mbps to the port manager 24D.

Herein, it is assumed that the link between the relay apparatus 3 and the bridge 5 has been linked-up at 1 Mbps.

The LAN PORT 31A notifies the effect that the link has been linked-up at 1 Mbps to the port manager 34D.

Herein, it is assumed that the link between the relay apparatus 4 and the bridge 6 has been linked-up at 100 Mbps.

The LAN PORT 41A notifies the effect that the link has been linked-up at 100 Mbps to the port manager 44D.

The port manager 14D receives a notification of the link-up from the LAN PORT 11A and the WAN PORT 12A, and collates the notified rate with the condition 141D.

And, it instructs the WAN PORT 12A to change the link-up rate to 10 Mbps because the LAN rate is 10 Mbps and the WAN rate is 100 Mbps.

The port manager 24D receives a notification of the link-up from the LAN PORT 21A and the WAN PORT 22A, and collates the notified rate with the condition 141D. And, it instructs the WAN PORT 22A to change the link-up rate to 10 Mbps because the LAN rate is 10 Mbps and the WAN rate is 100 Mbps.

The port manager 34D receives a notification of the link-up from the LAN PORT 31A and the WAN PORT 32A, and collates the notified rate with the condition 141D. And, it instructs the WAN PORT 32A to change the link-up rate to 1 Mbps because the LAN rate is 1 Mbps and the WAN rate is 10 Mbps.

The port manager 44D receives a notification of the link-up from the LAN PORT 41A and the WAN PORT 42A, and collates the notified rate with the condition 141D. And, it instructs the LAN PORT 41A to change the link-up rate to 10 Mbps because the LAN rate is 100 Mbps and the WAN rate is 10 Mbps.

The WAN PORT 12A receives an instruction for changing the link-up rate to 10 Mbps from the port manager 14D, and lowers the link-up rate to 10 Mbps.

The WAN PORT 22A receives an instruction for changing the link-up rate to 10 Mbps from the port manager 24D, and lowers the link-up rate to 10 Mbps.

The WAN PORT 32A receives an instruction for changing the link-up rate to 1 Mbps from the port manager 34D, and lowers the link-up rate to 1 Mbps.

The WAN PORT 42A lowers the link-up rate to 1 Mbps with the auto-negotiation because the WAN PORT 32A has lowered the link-up rate to 1 Mbps.

The WAN PORT 42A notifies the effect that the link-up rate has been changed to 1 Mbps to the port manager 44D.

The port manager 44D receives a notification of a change in the link-up rate from the WAN PORT 42A, and collates the notified rate with the condition 141D. And, it instructs the LAN PORT 41A to change the link-up rate to 1 Mbps because the LAN rate is 10 Mbps and the WAN rate is 1 Mbps.

The LAN PORT 41A receives an instruction for changing the link-up rate to 1 Mbps from the port manager 44D, and lowers the link-up rate to 1 Mbps.

The PORT 64 lowers the link-up rate to 1 Mbps with the auto-negotiation because the LAN PORT 41A has lowered the link-up rate to 1 Mbps.

(The Operational Example 2: Explanation of an Operation in the Path 91)

The STP processor 52 within the bridge 5 transmits the RST-BPDU frame to the PORT 53 through the bridge controller 51. and “Designated” have been set to this frame as a RPC (Root Path Cost) and a port state, respectively. (The bridge 5 has become a root node.)

The transfer controller 13D within the relay apparatus 1 receives the RST-BPDU frame from the LAN PORT 11A, and outputs the frame to the WAN PORT 12A.

The transfer controller 23D within the relay apparatus 2 receives the RST-BPDU frame from the WAN PORT 22A, and outputs the frame to the LAN PORT 21A.

When the RST-BPDU frame arrives from the PORT 63, the bridge controller 61 within the bridge 6 transfers it to the STP processor 62.

The STP processor 62 receives the RST-BPDU frame from the bridge controller 61, and computes the root path cost of the path 91. At this time, the STP processor 62 recognizes that the root path cost of the path 91 is 0+2000000=2000000 because the PORT 63 has been linked up at 10 Mbps, and in addition hereto, 0 has been set to the “Root Path Cost” value of the RST-BPDU that was input. In short, it recognizes that the band of path 91 is 10 Mbps.

(The Operational Example 2: Explanation of an Operation in the Path 92)

The STP processor 52 within the bridge 5 transmits the RST-BPDU frame to the PORT 54 through the bridge controller 51. and “Designated” have been set to this frame as a RPC (Root Path Cost) and a port state, respectively. (The bridge 5 has become a root node.)

The transfer controller 33D within the relay apparatus 3 receives the RST-BPDU frame from the LAN PORT 31A, and outputs the frame to the WAN PORT 32A.

The transfer controller 43D within the relay apparatus 4 receives the RST-BPDU frame from the WAN PORT 42A, and outputs the frame to the LAN PORT 41A.

When the RST-BPDU frame arrives from the PORT 64, the bridge controller 61 within the bridge 6 transfers it to the STP processor 62.

The STP processor 62 receives the RST-BPDU frame from the bridge controller 61, and computes the root path cost of the path 92. At this time, the STP processor 62 recognizes that the root path cost of the path 92 is 0+20000000=20000000 because the PORT 64 has been linked up at 1 Mbps, and in addition hereto, 0 has been set to the “Root Path Cost” value of the RST-BPDU that was input. In short, it recognizes that the band of path 92 is 1 Mbps.

(The Operational Example 2: a Path Selection in the Bridge 6)

The STP processor 62 within the bridge 6 recognizes that the root path cost of the path 91 is 2000000 (10 Mbps), and the root path cost of the path 92 is 20000000 (1 Mbps) from the operation described up to this point. For this, the STP processor 62 closes the port in the path 92 side, thereby preventing the frame from being transmitted/received to/from the port in the path 92 side. In short, communication between the bridge 5 and the bridge 6 results in being all made through the path 91.

Upon comparing the maximum band (10 Mbps) of the path 91 with the maximum band (1 Mbps) of the path 92, the former is larger. Thus, the optimal path was selected.

With the above explanation, it was demonstrated that applying the configuration shown in this exemplary embodiment allowed a cost to be computed normally, and an optimal path to be selected also in a case where a difference existed between an actually utilizable rate and a link rate of the connection link when the STP was utilized among the LANs (user network etc.) spanning the WAN (carrier network etc.).

(Effects of the Invention)

Next, the effects of this exemplary embodiment will be explained.

Utilizing the invention listed in this exemplary embodiment makes it possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exists.

The reason is that in the relay apparatus (a transmission apparatus, a tunnel apparatus, or the like) that is inserted between the bridges etc., the port manager within the relay apparatus, upon receipt of a notification of the link rate from the port, investigates which side, out of the WAN side and the LAN side, becomes a bottleneck, and in addition hereto, controls the link rate in conformity to either the WAN-side link rate or the LAN-side link rate, whichever is lower.

### A Seventh Exemplary Embodiment

The seventh exemplary embodiment of the present invention differs from the sixth exemplary embodiment, in which the rate of the WAN line is acquired from the link-up rate in the WAN PORT 12A, the WAN PORT 22A, the WAN PORT 32A, and the WAN PORT 42A, in a point of providing a rate delay measurer 17, a rate delay measurer 27, a rate delay measurer 37, and a rate delay measurer 47, acquiring the rate of the WAN line by transmitting/receiving the measurement frame, and computing the cost.

This makes it possible to accurately obtain the cost also in a case where the link rate of the WAN line fluctuates.

(Explanation of a Configuration)

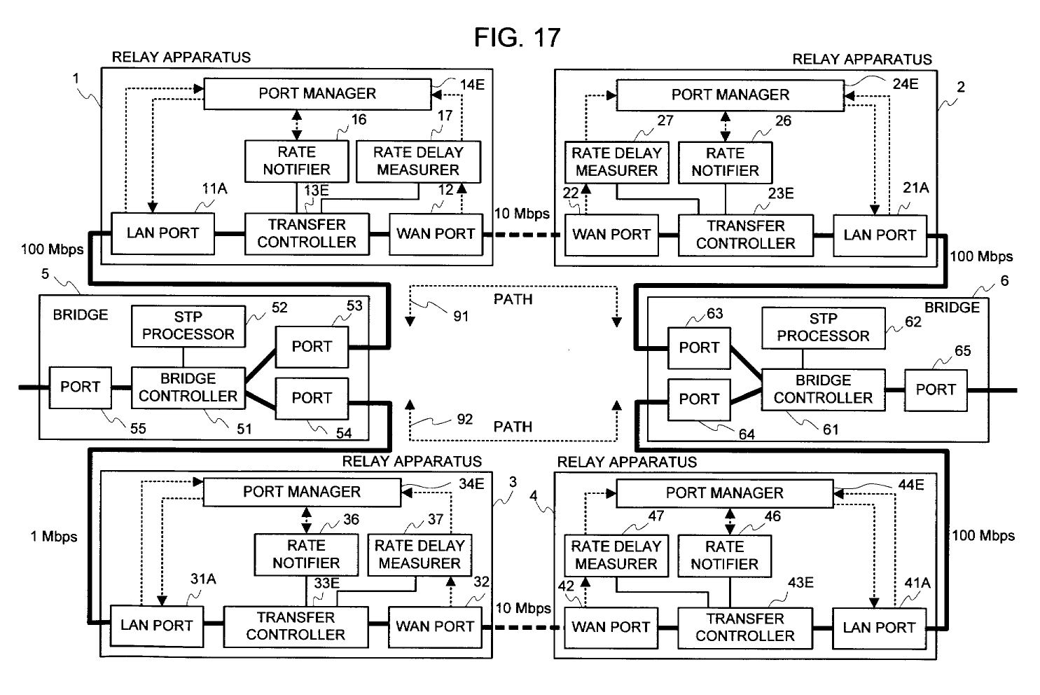

A configuration in this exemplary embodiment will be explained by making a reference to FIG. 17.

In the seventh exemplary embodiment of the present invention, a rate delay measurer and a rate notifier are added to the configuration of the sixth exemplary embodiment, a notification of link rate from the WAN PORT to the port manager is abolished, and the link-up is notified from the WAN PORT to the rate delay measurer instead thereof.

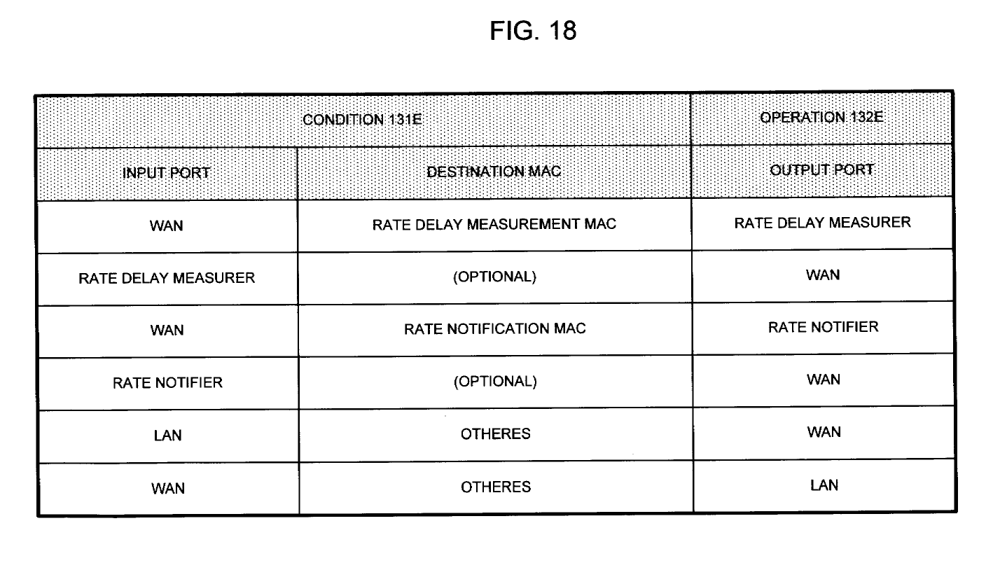

In a case of having received the frame from the LAN PORT 11A, the WAN port 12, the rate notifier 16, and the rate delay measurer 17, a transfer controller 13E makes a reference the input port, the destination MAC address, and the destination port thereof, decides an operation, an output port, and so on according a table shown in FIG. 18, and transfers the frame to the LAN PORT 11A, the WAN port 12, the rate notifier 16, and the rate delay measurer 17. Further, it adds or deletes a header, a tag, a flag, or the like for a purpose of constructing a tunnel with the relay apparatus (relay apparatus 2) facing its own relay apparatus responding to a necessity. Further, it makes a buffering as well for a purpose of avoiding a frame collision and further absorbing a rate difference between the LAN and the WAN.

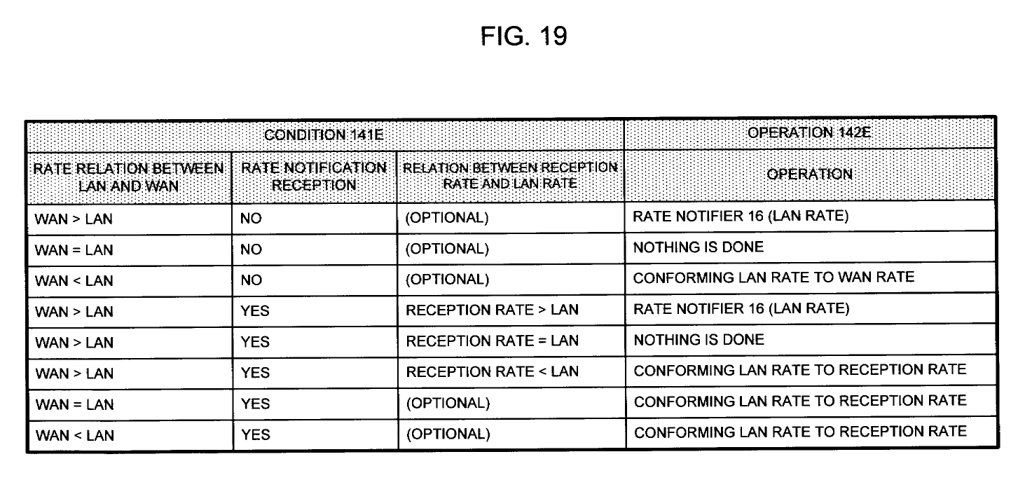

A port manager 14E receives a notification of the LAN rate and the WAN rate from LAN PORT 11A and the rate delay measurer 17, respectively, at the time of the link-up or at the time of the link-down, decides an operation according to a table shown in FIG. 19, and instructs the LAN PORT 11A to change the link rate responding to a necessity. Further, it instructs the rate notifier 16 to convey the LAN rate to the relay apparatus facing its own the relay apparatus (relay apparatus 2) responding to a necessity. Additionally, the notified rate is preserved until the next notification is issued.

In a case of having received the LAN rate of the relay apparatus (relay apparatus 2) facing its own the relay apparatus from the rate notifier 16, the port manager 14E decides an operation according to the table shown in FIG. 19, and instructs the LAN PORT 11A to change the link rate responding to a necessity. Further, it instructs the rate notifier 16 to convey the LAN rate to the relay apparatus (relay apparatus 2) facing its own the relay apparatus responding to a necessity. Additionally, the notified rate is preserved until the next notification is issued (The rate being preserved is a rate that has not been changed yet.)

The port manager 14E employs the rate information preserved owing to the notification received in the past to decide an operation for each constant time period according to the table shown in FIG. 19, and instructs the LAN PORT 11A to change the link rate responding to a necessity. Further, it instructs the rate notifier 16 to convey the LAN rate to the relay apparatus (relay apparatus 2) facing its own relay apparatus responding to a necessity.

(Explanation of an Operation)

Hereinafter, an operation in this exemplary embodiment will be explained by making a reference to FIG. 17.

(The Operational Example: the path 91)

Upon receipt of a notification of the link-up from the WAN PORT 12, the rate delay measurer 17 transmits a pre-decided quantity of the measurement frame (the quantity of the frame that occupies the band of the WAN link for several seconds, or something like it) to the relay apparatus facing its own relay apparatus. The rate delay measurement MAC and the MAC address of the relay apparatus 1 have been set to the MAC DA and the MAC SA of the measurement frame, respectively, and the measurement frame transmitted from the rate delay measurer 17 arrives at the rate delay measurer 27 via the transfer controller 13E, the WAN PORT 12, the WAN PORT 22, and a transfer controller 23E.

Upon receipt of the measurement frame, the rate delay measurer 27 starts a measurement of the band. And, upon completing reception of the measurement frame, it returns a measurement result to the rate delay measurer 17 as a reply by transmitting a measurement result frame. The rate delay measurement MAC and the MAC address of the relay apparatus 2 have been set to the MAC DA and the MAC SA of the measurement result frame, respectively, and the measurement result frame transmitted from the rate delay measurer 27 arrives at the rate delay measurer 17 via the transfer controller 23E, the WAN PORT 22, the WAN PORT 12, and the transfer controller 13E.

Upon receipt of the measurement result frame, the rate delay measurer 17 notifies the rate described in the measurement result frame to the port manager 14E.

The port manager 14E receives a notification of the WAN rate from the rate delay measurer 17, and collates the notified rate with a condition 141E. And, the port manager 14E instructs the LAN PORT 11A to change the link rate to 10 Mbps because the LAN rate is 100 Mbps the WAN rate is 10 Mbps, and in addition hereto, the rate notification has been not received.

Additionally, in this operational example, the measurement frame is transmitted from the rate delay measurer 17 to the rate delay measurer 27, and the measurement result frame is sent back from the rate delay measurer 27 to the rate delay measurer 17; however contrarily hereto, the measurement request frame may be transmitted from the rate delay measurer 27 to the rate delay measurer 17, and the measurement frame may be sent back from the rate delay measurer 17 to the rate delay measurer 27. Further, both of the above-mentioned methods may be employed at the same time.

The operation similar to the above-mentioned operation is performed in the relay apparatus 2 as well, and as a result, the LAN PORT 21A is linked-up at 10 Mbps.

(The Operational Example: the Path 92)

Upon receipt of a notification of the link-up from the WAN PORT 32, the rate delay measurer 37 transmits a pre-decided quantity of the measurement frame (the quantity of the frame that occupies the band of the WAN link for several seconds, or something like it) to the relay apparatus facing its own relay apparatus. The rate delay measurement MAC and the MAC address of the relay apparatus 3 have been set to the MAC DA and the MAC SA of the measurement frame, respectively, and the measurement frame transmitted from the rate delay measurer 37 arrives at the rate delay measurer 47 via a transfer controller 33E, the WAN PORT 32, the WAN PORT 42, and a transfer controller 43E.

Upon receipt of the measurement frame, the rate delay measurer 47 starts a measurement of the band. And, upon completing reception of the measurement frame, it returns a measurement result to the rate delay measurer 37 as a reply by transmitting a measurement result frame. The rate delay measurement MAC and the MAC address of the relay apparatus 4 have been set to the MAC DA and the MAC SA of the measurement result frame, respectively, and the measurement result frame transmitted from the rate delay measurer 47 arrives at the rate delay measurer 37 via the transfer controller 43E, the WAN PORT 42, the WAN PORT 32, and the transfer controller 33E.

Upon receipt of the measurement result frame, the rate delay measurer 37 notifies the rate described in the measurement result frame to a port manager 34E.

The port manager 34E receives a notification of the WAN rate from the rate delay measurer 37, and collates the notified rate with the condition 141E. And, the port manager 34E instructs the rate notifier 36 to notify the LAN rate (1 Mbps) to the rate notifier 46 because the LAN rate is 1 Mbps and the WAN rate is 10 Mbps, and in addition hereto, the rate notification has been not received.

Upon receipt of an instruction for notifying the LAN rate from the port manager 34E, the rate notifier 36 prepares a rate notification frame, and notifies the LAN rate to the rate notifier 46 via the transfer controller 33E, the WAN PORT 32, the WAN PORT 42, and the transfer controller 43E. Upon receipt of the rate notification frame transmitted by the rate notifier 36, the rate notifier 46 notifies the LAN-side rate (1 Mbps) of the relay apparatus 3 to a port manager 44E.

The port manager 44E receives a notification of the LAN rate of the apparatus facing it from the rate notifier 46, and collates the already-preserved rate (100 Mbps) of the LAN PORT 41A and rate (10 Mbps) of the WAN PORT 42, and the reception rate (1 Mbps) notified this time with the condition 141E. And, the port manager 44E instructs the LAN PORT 41A to change the link rate to 1 Mbps because the LAN rate is 100 Mbps and the WAN rate is 10 Mbps, and in addition hereto, the rate notification has been received and the reception rate<the LAN rate.

The LAN PORT 41A receives an instruction for changing the link-up rate to 1 Mbps from the port manager 44E, and lowers the link-up rate to 1 Mbps.

The PORT 64 lowers the link-up rate to 1 Mbps with the auto-negotiation because the LAN PORT 41A has lowered the link-up rate to 1 Mbps.

(The Operational Example: a Path Selection in the Bridge 6)

The STP processor 62 within the bridge 6 recognizes that the root path cost of the path 91 is 2000000 (10 Mbps), and the root path cost of the path 92 is 20000000 (1 Mbps) from the operation described up to this point. For this, the STP processor 62 closes the port in the path 92 side, thereby preventing the frame from being transmitted/received to/from the port in the path 92 side. In short, communication between the bridge 5 and the bridge 6 results in being all made through the path 91.

Upon comparing the maximum band (10 Mbps) of the path 91 with the maximum band (1 Mbps) of the path 92, the former is larger. Thus, the optimal path was selected.

With the above explanation, it was demonstrated that applying the configuration shown in this exemplary embodiment allowed a cost to be computed normally, and an optimal path to be selected also in a case where a difference existed between an actually utilizable rate and a link rate of the connection link when the STP was utilized among the LANs (user network etc.) spanning the WAN (carrier network etc.).

(Effects of the Invention)

Next, the effects of this exemplary embodiment will be explained.

Utilizing the invention listed in this exemplary embodiment makes it possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exists.

The reason is that in the relay apparatus (a transmission apparatus, a tunnel apparatus, or the like) that is inserted between the bridges etc, the port manager within the relay apparatus, upon receipt of a notification of the link rate from the port, investigates which side, out of the WAN side and the LAN side, becomes a bottleneck, and in addition hereto, the port manager controls the link rate in conformity to either the WAN-side link rate or the LAN-side link rate, whichever is lower.

Further, utilizing the invention listed in this exemplary embodiment makes it possible to reflect an actually utilizable rate (a band of the bottleneck) in the path between the bridges etc. into the cost, to select an optimal path, and to enhance an efficiency of the net utilization also in a case where no bottleneck exists in the connection link of the relay apparatus for rewriting the root path cost.

The reason is that in the relay apparatus (a transmission apparatus, a tunnel apparatus, or the like) that is inserted between the bridges etc, the rate notifier within the relay apparatus notifies the latest rate of the bottleneck of its own to the relay apparatus facing its own relay apparatus, and contrarily, receives a notification of the rate from the relay apparatus facing and notifies the rate to the port manager.

Further, utilizing the invention listed in this exemplary embodiment makes it possible to reflect a band of the bottleneck into the cost, to select an optimal path, and to enhance an efficiency of the net utilization in a case where the band of the WAN line fluctuates in some cases, and the link-up rate differs from the band of the bottleneck within the WAN net in some cases.

The reason is that in the relay apparatus (a transmission apparatus, a tunnel apparatus, or the like) that is inserted between the bridges etc., the rate delay measurer within the relay apparatus measures the band of the WAN by transmitting/receiving the measurement frame.

### An Eighth Exemplary Embodiment

In the second exemplary embodiment, information of the bottleneck was intensively collected into the relay apparatus nearest to the bridge for computing the path by the rate notifier, and thereafter the cost was rewritten in the cost rewriter, whereas in the eighth exemplary embodiment, the cost is added up in conformity to the band of the input-side link in all relay apparatuses over the path. (Contrarily, as to the BPDUs in the return trip of which the RST-BPDU has “Root”, “Backup”, and “Alternate”, respectively, as a port state, the cost is subtracted in conformity to the band of the output-side link).

This makes it possible to reflect a band of the bottleneck into the cost, to select an optimal path, and to enhance an efficiency of the net utilization without employing the rate notification frame etc.

(Explanation of a Configuration)

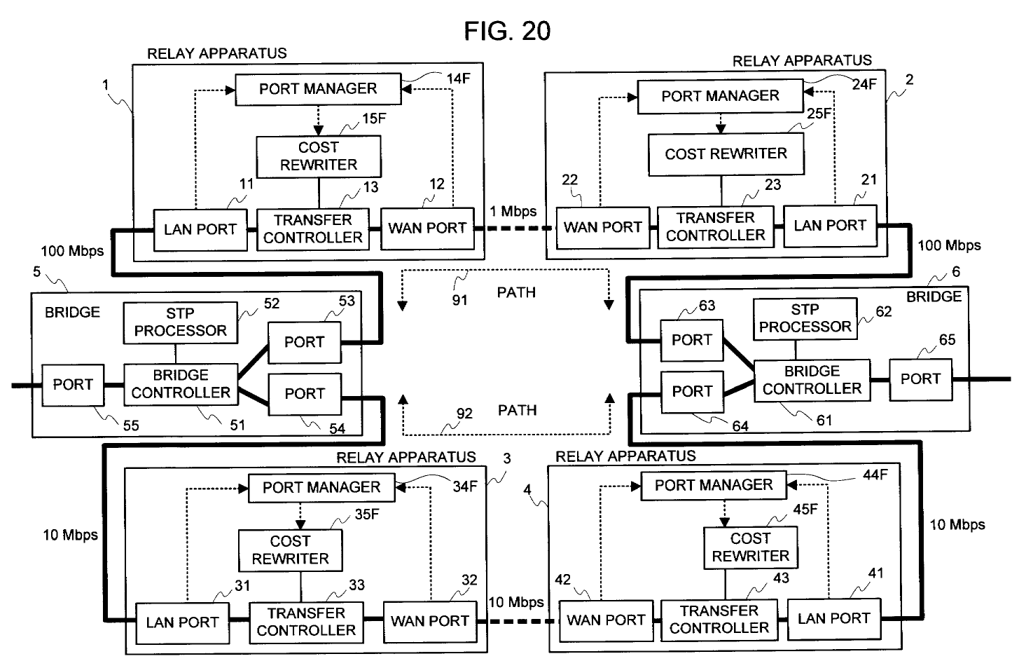

A configuration in this exemplary embodiment will be explained by making a reference to FIG. 20.

In the eighth exemplary embodiment of the present invention, the port manager 14 and the cost rewriter 15 in the first exemplary embodiment shown in FIG. 2 are replaced with a port manager 14F and a cost rewriter 15F, respectively, and the cost is added up in conformity to the band of the input-side link in all relay apparatuses over the path. Additionally, the identical numeral is affixed to a component similar to that of the above-mentioned exemplary embodiment, and its detailed explanation is omitted.

The port manager 14F receives a notification of the link rate from the LAN PORT 11 and the WAN PORT 12 at the time of the link-up or at the time of the link-down, and conveys to the cost rewriter 15F the rates of the LAN and the WAN, and a classification as to whether the link is in a state of the link-up or in a state of the link-down. Additionally, the rate notified from the port is preserved until the next notification is issued.

The port manager 14F conveys the rate information and link-up/down information preserved owing to the notification received in the past to the cost rewriter 15F for each constant time period.

The cost rewriter 15F receives a notification of the LAN rate and the WAN rate from the port manager 14F, preserves these parameters until the next notification is issued, and utilizes them at the time of the rewrite.

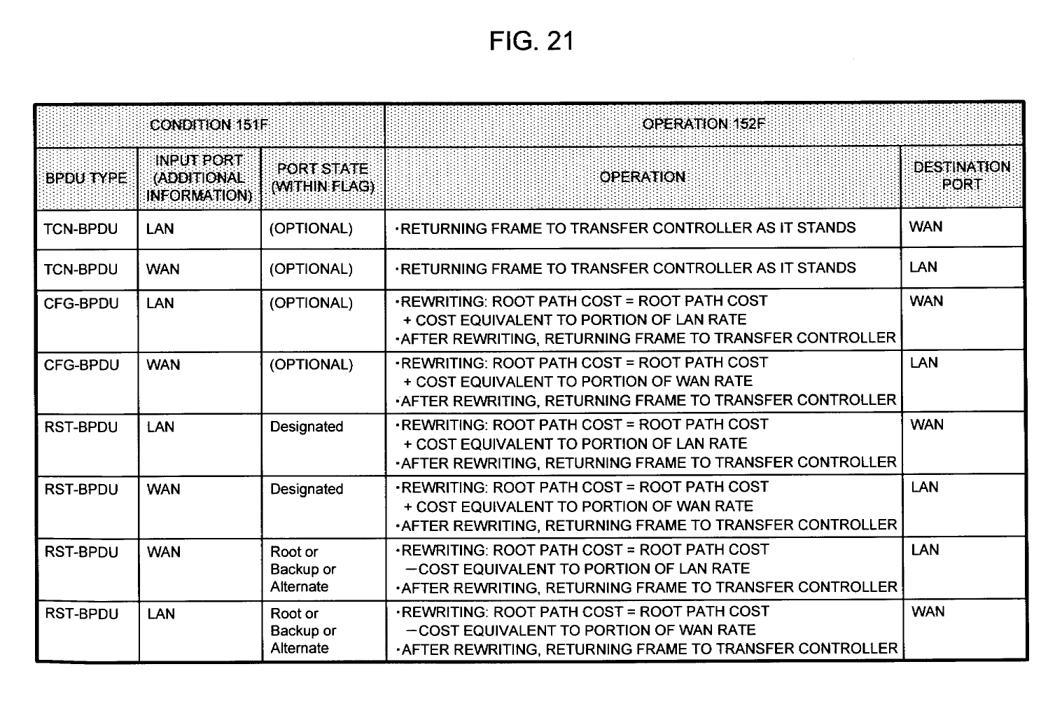

In a case of having received the BPDU frame and the additional information (input port) from the transfer controller 13, the cost rewriter 15F decides an operation and a destination port according to a table shown in FIG. 21 based upon type information (BPDU Type) within the BPDU frame, the port state (Port Role) within the “Flags” field of the BPDU frame, and in addition hereto, the input port, being additional information. The rewriting process, if necessary, is performed, by rewriting the cost recorded into the “Root Path Cost” field within the BPDU frame. And, it adds the destination port information as additional information, and returns it the transfer controller 13.

A port manager 24F is similar to the port manager 14F.

A port manager 34F is similar to the port manager 14F.

A port manager 44F is similar to the port manager 14F.

A cost rewriter 25F is similar to the cost rewriter 15F.

A cost rewriter 35F is similar to the cost rewriter 15F.

A cost rewriter 45F is similar to the cost rewriter 15F.

### THE OPERATIONAL EXAMPLE

Hereinafter, an operation in this exemplary embodiment will be explained by making a reference to FIG. 20 with the case of the network configuration similar to the configuration having the problem caused by the related art 2 shown in FIG. 1 and the link rate thereof as an example.

(The Operational Example: a Precondition and an Initial Operation)

Herein, it is assumed that the Spanning Tree Protocol (the Rapid Spanning Tree specified in the old IEEE 802. 1w) operates in the bridge 5 and the bridge 6. Further, it is assumed that the bridge 5 is a root node.

The STP processor 52 sets 200000 to the PORT 53 as a cost value (port path cost) because the PORT 53 is linked-up at 100 Mbps. In addition hereto, it sets 2000000 to the PORT 54 as a cost value (port path cost) because the PORT 54 is linked-up at 10 Mbps.

The STP processor 62 sets 200000 to the PORT 63 as a cost value (port path cost) because the PORT 63 is linked-up at 100 Mbps. In addition hereto, it sets 2000000 to the PORT 64 as a cost value (port path cost) because the PORT 64 is linked-up at 10 Mbps.

Herein, it is assumed that the link between the relay apparatus 1 and the relay apparatus 2 has been linked-up at 1 Mbps.

The WAN PORT 12 notifies the effect that the link has been linked-up at 1 Mbps to the port manager 14F.

The WAN PORT 22 notifies the effect that the link has been linked-up at 1 Mbps to the port manager 24F.

Herein, it is assumed that the link between the relay apparatus 3 and the relay apparatus 4 has been linked-up at 10 Mbps.

The WAN PORT 32 notifies the effect that the link has been linked-up at 10 Mbps to the port manager 34F.

The WAN PORT 42 notifies the effect that the link has been linked-up at 10 Mbps to the port manager 44F.

Herein, it is assumed that the link between the relay apparatus 1 and the bridge 5, and the link between the relay apparatus 2 and the bridge 6 have been linked-up at 100 Mbps, respectively.

The LAN PORT 11 notifies the effect that the link has been linked-up at 100 Mbps to the port manager 14F.

The LAN PORT 21 notifies the effect that the link has been linked-up at 100 Mbps to the port manager 24F.

Herein, it is assumed that the link between the relay apparatus 3 and the bridge 5, and the link between the relay apparatus 4 and the bridge 6 have been linked-up at 10 Mbps, respectively.

The LAN PORT 31 notifies the effect that the link has been linked-up at 10 Mbps to the port manager 34F.

The LAN PORT 41 notifies the effect that the link has been linked-up at 10 Mbps to the port manager 44F.

The port manager 14F receives a notification of the link-up from the LAN PORT 11 and the WAN PORT 12, and notifies the effect that the LAN rate is 100 Mbps and the WAN rate is 1 Mbps to the cost rewriter 15F.

The port manager 24F receives a notification of the link-up from the LAN PORT 21 and the WAN PORT 22, and notifies the effect that the LAN rate is 100 Mbps and the WAN rate is 1 Mbps to the cost rewriter 25F.

The port manager 34F receives a notification of the link-up from the LAN PORT 31 and the WAN PORT 32, and notifies the effect that the LAN rate is 10 Mbps and the WAN rate is 10 Mbps to the cost rewriter 35F.

The port manager 44F receives a notification of the link-up from the LAN PORT 41 and the WAN PORT 42, and notifies the effect that the LAN rate is 10 Mbps and the WAN rate is 10 Mbps to the cost rewriter 45F.

(The Operational Example: Explanation of an Operation in the Outward Trip of the BPDU in the Path 91)

The STP processor 52 within the bridge 5 transmits the RST-BPDU frame to the PORT 53 through the bridge controller 51. and “Designated” have been set to this frame as a RPC (Root Path Cost) and a port state, respectively. (The bridge 5 has become a root node.)

The transfer controller 13 within the relay apparatus 1 receives the RST-BPDU frame from the LAN PORT 11, and collates the input port and the destination MAC thereof with the condition 131 of FIG. 3. And, it makes a reference to the operation 132, adds the LAN port to the frame that was input as additional information (input port), and outputs the RST-BPDU frame to the cost rewriter because the input port is a LAN port and the destination MAC is “BPDU-MAC”.

Upon receipt of the RST-BPDU frame from the transfer controller 13, the cost rewriter 15F collates it with a condition 151F of FIG. 21, and makes a reference to a corresponding operation 152F because the input port is a LAN and the port state is “Designated”.

The cost rewriter 15F, which has already been notified that the LAN rate is 100 Mbps and the WAN rate is 1 Mbps by the port manager 14F, rewrites the “Root Path Cost” into 200000 according to the new “Root Path Cost”=the old “Root Path Cost” (0)+200000=200000, which is derived by assuming the cost equivalent to the portion of 100 Mbps assumed to be 200000, and thereafter returns the frame to the transfer controller 13. At this moment, it sets the WAN as additional information (destination port).

The transfer controller 13 receives the RST-BPDU frame and the WAN as a destination port from the cost rewriter, and outputs the frame to the WAN PORT 12 according to the condition 131 and the operation 132 shown in FIG. 3. At this moment, it deletes the additional information.

The transfer controller 23 within the relay apparatus 2 receives the RST-BPDU frame from the WAN PORT 22, and collates the input port and the destination MAC thereof with the condition 131 of FIG. 3. And, it makes a reference to the operation 132, adds the WAN port to the frame that was input as additional information (input port), and outputs the RST-BPDU frame to the cost rewriter because the input port is a WAN port and the destination MAC is “BPDU-MAC”.

Upon receipt of the RST-BPDU frame from the transfer controller 23, the cost rewriter 25F collates it with the condition 151F of FIG. 21, and makes a reference to the corresponding operation 152F because the input port is “WAN” and the port state is “Designated”.

The cost rewriter 25F, which has already been notified that the LAN rate is 100 Mbps and the WAN rate is 1 Mbps by the port manager 24F, rewrites the “Root Path Cost” into 20200000 according to the new “Root Path Cost”=the old “Root Path Cost” (200000)+20000000=20200000, which is derived by assuming the cost equivalent to the portion of 1 Mbps to be 20000000, and thereafter returns the frame to the transfer controller 23. At this moment, it sets the LAN as additional information (destination port).

The transfer controller 23 receives the RST-BPDU frame and the LAN as a destination port from the cost rewriter, and outputs the frame to the LAN PORT 21 according to the condition 131 and the operation 132 shown in FIG. 3. At this moment, it deletes the additional information.

When the RST-BPDU frame arrives from the PORT 63, the bridge controller 61 within the bridge 6 transfers it to the STP processor 62.

The STP processor 62 receives the RST-BPDU frame from the bridge controller 61, and computes the root path cost of the path 91. At this time, the STP processor 62 recognizes that the root path cost of the path 91 is 20200000+200000=20400000 because the PORT 63 has been linked up at 100 Mbps, and in addition hereto, 20200000 has been set to the “Root Path Cost” value of the RST-BPDU that was input.

Additionally, the operation in the outward trip of the path 91 described above is similarly applicable to the CFG-BPDU of the old IEEE 802. 1D as well. However, the operation in the return trip of the path 91 to be described below is not generated in the CFG-BPDU of the old IEEE 802. 1D.

(The Operational Example: Explanation of an Operation in the Return Trip of the BPDU in the Path 91)

In the following, an operation in the case that a “Proposal” flag has been set to the RST-BPDU in the return trip transmitted by the bridge 5, and the bridge 6 returns the BPDU with an “Agreement” flag to the bridge 5 will be explained.

The STP processor 62 transmits the RST-BPDU frame to the PORT 63 through the bridge controller 61. 20200000 and “Root” have been set to this frame as a RPC (Root Path Cost) and a port state, respectively. (The bridge 5 has become a root node, and the bridge 6 has become a subordinate node)

The transfer controller 23 within the relay apparatus 2 receives the RST-BPDU frame from the LAN PORT 21, and collates the input port and the destination MAC thereof with the condition 131 of FIG. 3. And, it makes a reference to the operation 132, adds the LAN port to the frame that was input as additional information (input port), and outputs the RST-BPDU frame to the cost rewriter because the input port is a LAN port and the destination MAC is “BPDU-MAC”.

Upon receipt of the RST-BPDU frame from the transfer controller 23, the cost rewriter 25F collates it with the condition 151F of FIG. 21, and makes a reference to the corresponding operation 152F because the input port is “LAN” and the port state is “Root”.

The cost rewriter 25F, has already been notified that the LAN rate is 100 Mbps and the WAN rate is 1 Mbps by the port manager 24F, rewrites the “Root Path Cost” into 200000 according to the new “Root Path Cost”=the old “Root Path Cost” (20200000)−20000000=200000, which is derived by assuming the cost equivalent to the portion of 1 Mbps to be 20000000, and thereafter returns the frame to the transfer controller 23. At this moment, it sets the WAN as additional information (destination port).

The transfer controller 23 receives the RST-BPDU frame and the WAN as a destination port from the cost rewriter, and outputs the frame to the WAN PORT 22 according to the condition 131 and the operation 132 shown in FIG. 3. At this moment, it deletes the additional information.

The transfer controller 13 within the relay apparatus 1 receives the RST-BPDU frame from the WAN PORT 12, and collates the input port and the destination MAC thereof with the condition 131 of FIG. 3. And, it makes a reference to the operation 132, adds the WAN port to the frame that was input as additional information (input port), and outputs the RST-BPDU frame to the cost rewriter because the input port is a WAN port and the destination MAC is “BPDU-MAC”.

Upon receipt of the RST-BPDU frame from the transfer controller 13, the cost rewriter 15F collates it with the condition 151F of FIG. 21, and makes a reference to the corresponding operation 152F because the input port is “LAN” and the port state is “Root”.

The cost rewriter 15F, has already been notified that the LAN rate is 100 Mbps and the WAN rate is 1 Mbps by the port manager 14F, rewrites the “Root Path Cost” into 0 according to the new “Root Path Cost”=the old “Root Path Cost” (200000)−200000=0, which is derived by assuming the cost equivalent to the portion of 100 Mbps to be 200000, and thereafter, returns the frame to the transfer controller 13. At this moment, it sets the LAN as additional information (destination port).

The transfer controller 13 receives the RST-BPDU frame and the LAN as a destination port from the cost rewriter, and outputs the frame to the LAN PORT 11 according to the condition 131 and the operation 132 shown in FIG. 3. At this moment, it deletes the additional information.

When the RST-BPDU frame arrives from the PORT 53, the bridge controller 51 within the bridge 5 transfers it to the STP processor 52.

The STP processor 52 receives the RST-BPDU frame from the bridge controller 51, and preserves the state (The bridge 5 is a root node, and the PORT 53 is a “Designated” port) maintained up to this point because “Root” has been set hereto as a port state.

Additionally, the operation in the return trip of the path 91 described above is not generated in the CFG-BPDU of the old IEEE 802. 1D.

(The Operational Example: Explanation of an Operation in the Path 92)

The STP processor 52 within the bridge 5 transmits the RST-BPDU frame to the PORT 54 through the bridge controller 51. and “Designated” have been set to this frame as a RPC (Root Path Cost) and a port state, respectively. (The bridge 5 has become a root node.)

The transfer controller 33 within the relay apparatus 3 receives the RST-BPDU frame from the LAN PORT 31, and collates the input port and the destination MAC thereof with the condition 131 of FIG. 3. And, it makes a reference to the operation 132, adds the LAN port to the frame that was input as additional information (input port), and outputs the RST-BPDU frame to the cost rewriter because the input port is a LAN port and the destination MAC is “BPDU-MAC”.

Upon receipt of the RST-BPDU frame from the transfer controller 33, the cost rewriter 35F collates it with the condition 151F of FIG. 21, and makes a reference to the corresponding operation 152F because the input port is “LAN” and the port state is “Designated”.

The cost rewriter 35F, which has already been notified that the LAN rate is 10 Mbps and the WAN rate is 10 Mbps by the port manager 34F, rewrites the “Root Path Cost” into 2000000 according to the new “Root Path Cost”=the old “Root Path Cost” (0)+2000000=2000000, which is derived by assuming the cost equivalent to the portion of 10 Mbps to be 2000000, and thereafter returns the frame to the transfer controller 33. At this moment, it sets the WAN as additional information (destination port).

The transfer controller 33 receives the RST-BPDU frame and the WAN as a destination port from the cost rewriter, and outputs the frame to the WAN PORT 32 according to the condition 131 and the operation 132 shown in FIG. 3. At this moment, it deletes the additional information.

The transfer controller 43 within the relay apparatus 4 receives the RST-BPDU frame from the WAN PORT 32, and collates the input port and the destination MAC thereof with the condition 131 of FIG. 3. And, it makes a reference to the operation 132, adds the WAN port to the frame that was input as additional information (input port), and outputs the RST-BPDU frame to the cost rewriter because the input port is a WAN port and the destination MAC is “BPDU-MAC”.

Upon receipt of the RST-BPDU frame from the transfer controller 43, the cost rewriter 45F collates it with the condition 151F of FIG. 21, and makes a reference to the corresponding operation 152F because the input port is “LAN” and the port state is “Designated”.

The cost rewriter 45F, which has already been notified that the LAN rate is 10 Mbps and the WAN rate is 10 Mbps by the port manager 44F, rewrites the “Root Path Cost” into 4000000 according to the new “Root Path Cost”=the old “Root Path Cost” (2000000)+2000000=4000000, which is derived by assuming the cost equivalent to the portion of 10 Mbps to be 2000000, and thereafter returns the frame to the transfer controller 43. At this moment, it sets the LAN as additional information (destination port).

The transfer controller 43 receives the RST-BPDU frame and the LAN as a destination port from the cost rewriter, and outputs the frame to the LAN PORT 41 according to the condition 131 and the operation 132 shown in FIG. 3. At this moment, it deletes the additional information.

When the RST-BPDU frame arrives from the PORT 63, the bridge controller 61 within the bridge 6 transfers it to the STP processor 62.

The STP processor 62 receives the RST-BPDU frame from the bridge controller 61, and computes the root path cost of the path 92. At this time, the STP processor 62 recognizes that the root path cost of the path 92 is 4000000+2000000=6000000 because the PORT 64 has been linked up at 10 Mbps, and in addition hereto, 0 has been set to the “Root Path Cost” value of the RST-BPDU that was input.

In the path 92, the process of rewriting the cost was not generated in the transfer of the BPDU in the outward trip described above. For this reason, the process of rewriting the cost is not generated in the transfer in the return trip.

Additionally, the operation in the outward trip of the path 92 described above is similarly applicable to the CFG-BPDU of the old IEEE 802. 1D as well. However, the operation in the return trip of the path 92 is not generated in the CFG-BPDU of the old IEEE 802. 1D.

(The Operational Example: a Path Selection in the Bridge 6)

The STP processor 62 within the bridge 6 recognizes that the root path cost of the path 91 is 20400000, and the root path cost of the path 92 is 6000000 from the operation described up to this point. For this, the STP processor 62 closes the port in the path 91 side, thereby preventing the frame from being transmitted/received to/from the port in the path 91 side. In short, communication between the bridge 5 and the bridge 6 results in being all made through the path 92.

Upon comparing the maximum band (1 Mbps) of the path 91 with the maximum band (10 Mbps) of the path 92, the latter is larger. Thus, the optimal path was selected.

With the above explanation, it was demonstrated that applying the configuration shown in this exemplary embodiment allowed a cost to be computed normally, and an optimal path to be selected also in a case where a difference existed between an actually utilizable rate and a link rate of the connection link when the STP was utilized among the LANs (user network etc.) spanning the WAN (carrier network etc.).

Additionally, from a viewpoint of the cost computation, this exemplary embodiment is equivalent to the case of likening the relay apparatus to the bridge. That is, it follows that the process of computing the cost that is usually performed by the bridge is performed also in the relay apparatus. The bridge of the related art performs both of the cost computation and the path selection, whereas in this exemplary embodiment, not only the bridge but also the relay apparatus performs the process of computing the cost, thereby enabling an accurate path selection based upon an accurate cost.

(Effects of the Invention)

Next, the effects of this exemplary embodiment will be explained.

Utilizing the invention listed in this exemplary embodiment makes it possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exists.

The reason is that in the relay apparatus (a transmission apparatus, a tunnel apparatus, or the like) that is inserted between the bridges etc, the port manager within the relay apparatus receives a notification of the link rate from the port, and the cost rewriter within the relay apparatus rewrites the root path cost field within the BPDU in conformity to the rate of the input/output link.

Further, utilizing the invention listed in this exemplary embodiment makes it possible to reflect an actually utilizable rate (band of the bottleneck) in the path between the bridges etc. into the cost, to select an optimal path, and to enhance an efficiency of the net utilization also in a case where no bottleneck exists in the connection link of the relay apparatus for rewriting the root path cost.

The reason is that in the relay apparatus (a transmission apparatus, a tunnel apparatus, or the like) that is inserted between the bridges etc. the cost is added up in conformity to the band of the input-side link.

In the second exemplary embodiment, the third exemplary embodiment, and the seventh exemplary embodiment, the rate of the bottleneck was notified to the relay apparatus facing its own relay apparatus by employing the rate notification, whereas the cost may be added up (in the case of the outward trip), or subtracted simply (in the case of the return trip) whenever the BPDU frame passes through the relay apparatus instead of employing such a rate notification.

In the exemplary embodiments and the examples mentioned above, the technical term “frame” was employed, and the frame is a synonym of the Ethernet frame. Further, the packet is one part of the frame (a data row of Layer 3 or higher out of the frame), and is included in the frame.

While the present invention was explained by listing the preferred exemplary embodiments and examples above, the present invention is not always limited to the above-mentioned exemplary embodiments and examples, and various modifications may be made within the technical sprit thereof. Needless to say, the exemplary embodiments and examples described above may be mutually combined for execution. For example, the result manager 18 shown in the fourth exemplary embodiment may be applied instead of the rate notifier 16 in the configuration shown in the seventh exemplary embodiment.

Additionally, as apparent from the above-mentioned explanation, the terminal of the present invention described above also can be configured with hardware, and also can be realized with a computer program.

In this case, a processor that operates under a program filed in a program memory allows the function and operation similar to that of the foregoing exemplary embodiments to be realized. Additionally, only one part of the functions of the foregoing exemplary embodiment can also be realized with the computer program.

The present invention described above is applicable to a terminating apparatus in the subscriber side of a wide-area Internet service for connecting the separate LAN companions via the WAN, or the like. Further, it is applicable to an Internet VPN apparatus and an Internet VPN system as well.

Next effects of the present invention described above will be explained.

The first effect in accordance with the present invention lies in a point that it is possible to reflect a band of the bottleneck into the cost, to select an optimal path, and to enhance an efficiency of the net utilization without making a setting or a modification to the apparatus (bridge etc.) in which the path control protocol operates in a case where a difference exists between an actually utilizable rate (a band of the bottleneck) in the path between the bridges etc. and a link rate of the connection link such as the bridge etc. in a net in which the apparatus (bridge etc.), in which the path control protocol (STP etc.) for automatically computing a cost of a link by a physical band of the connection link operates, exists.

The reason is that in the relay apparatus (a transmission apparatus, a tunnel apparatus, or the like) that is inserted between the bridges etc, the port manager within the relay apparatus, upon receipt of a notification of the link rate from the port, investigates which side, out of the WAN side and the LAN side, becomes a bottleneck, and the cost rewriter within the relay apparatus rewrites the root path cost field within the BPDU in conformity to the rate of the bottleneck.

Further, the reason is that in the relay apparatus (a transmission apparatus, a tunnel apparatus, or the like) that is inserted between the bridges etc, the port manager within the relay apparatus, upon receipt of a notification of the link rate from the port, investigates which side, out of the WAN side and the LAN side, becomes a bottleneck, and in addition hereto, the port manager controls the link rate in conformity to either the WAN-side link rate or the LAN-side link rate, whichever is lower.

Further, the reason is that in the relay apparatus (a transmission apparatus, a tunnel apparatus, or the like) that is inserted between the bridges etc, the port manager within the relay apparatus receives a notification of the link rate from the port, and the cost rewriter within the relay apparatus rewrites the root path cost field within the BPDU in conformity to the rate of the input/output link.

The second effect in accordance with the present invention lies in a point that it is possible to reflect an actually utilizable rate (a band of the bottleneck) in the path between the bridges etc. into the cost, to select an optimal path, and to enhance an efficiency of the net utilization also in a case where no bottleneck exists in the connection link of the relay apparatus for rewriting the root path cost.

The reason is that in the relay apparatus (a transmission apparatus, a tunnel apparatus, or the like) that is inserted between the bridges etc, the rate notifier within the relay apparatus notifies the latest rate of the bottleneck of its own to the relay apparatus facing its own relay apparatus, and contrarily, receives a notification of the rate from the relay apparatus facing its own relay apparatus and notifies it to the port manager.

Further, the reason is that in the relay apparatus (a transmission apparatus, a tunnel apparatus, or the like) that is inserted between the bridges etc., the cost is added up in conformity to the band of the input-side link.

The third effect in accordance with the present invention lies in a point that it is possible to reflect a band of the bottleneck into the cost, to select an optimal path, and to enhance an efficiency of the net utilization in a case where the band of the WAN line fluctuates in some cases and the link-up rate differs from the band of the bottleneck within the WAN net in some cases.

The reason is that in the relay apparatus (a transmission apparatus, a tunnel apparatus, or the like) that is inserted between the bridges etc, the rate delay measurer within the relay apparatus measures the band of the WAN by transmitting/receiving the measurement frame.

The fourth effect in accordance with the present invention lies in a point that it is possible to make the path selection in which the low delay takes priority over the wide band.

The reason is that in the relay apparatus (a transmission apparatus, a tunnel apparatus, or the like) that is inserted between the bridges etc, the result manager within the relay apparatus broadcasts the delay notified from the rate delay measurer to the other relay apparatuses within the net, and contrarily, receives a notification of the delay quantity from the other relay apparatuses within the net, converts its relative delay into a band (rate), and thereafter notifies it to the port manager.

The fifth effect in accordance with the present invention lies in a point that it is possible to avoid the dense path on which the setting of the VLAN concentrates, to keep fairness among the VLANs, and to enhance an efficiency of the net utilization in the network that is configured of the multiple spanning tree that is specified the IEEE 802. 1s.

The reason is that in the relay apparatus (a transmission apparatus, a tunnel apparatus, or the like) that is inserted between the bridges etc., the cost rewriter within the relay apparatus rewrites the “Root Path Cost” responding to the by-VLAN band utilization ratio.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A relay apparatus comprising a cost rewriter for, based upon a rate of a bottleneck out of a link rate of a first transfer apparatus for transmitting a root path cost, a link rate of a connection link of a second transfer apparatus for selecting a path based upon said root path cost, and a transfer rate of a WAN, rewriting said root path cost, said relay apparatus being provided between said first transfer apparatus and said second transfer apparatus.

2. The relay apparatus according to claim 1, said relay apparatus comprising:
a WAN-side port for notifying said transfer rate of the WAN;
a LAN-side port for notifying said link rate of the connection link of the second transfer apparatus; and
a port manager for investigating a rate of the bottleneck based upon said notified transfer rate of the WAN, said notified link rate of the connection link of the second transfer apparatus, and either said link rate of the first transfer apparatus or said transfer rate of the WAN being transmitted from the relay apparatus facing its own relay apparatus, whichever is lower, wherein said cost rewriter rewrites the root path cost in conformity to the rate of the bottleneck from said port manager.

3. The relay apparatus according to claim 1, said relay apparatus comprising:
a WAN-side port for notifying said transfer rate of the WAN;
a LAN-side port for notifying said link rate of the connection link of the second transfer apparatus; and
a port manager for investigating a rate of the bottleneck based upon said notified transfer rate of the WAN, said notified link rate of the connection link of the second transfer apparatus, and said link rate of the first transfer apparatus being transmitted from the relay apparatus facing its own relay apparatus, wherein said cost rewriter rewrites the root path cost in conformity to the rate of the bottleneck from said port manager.

4. The relay apparatus according to claim 1, said relay apparatus comprising:
a measurer for measuring said transfer rate of the WAN;
a LAN-side port for notifying said link rate of the connection link of the second transfer apparatus; and
a port manager for investigating a rate of the bottleneck based upon said notified transfer rate of the WAN, said notified link rate of the connection link of the second transfer apparatus, and either said link rate of the first transfer apparatus or said transfer rate of the WAN being transmitted from the relay apparatus facing its own relay apparatus, whichever is lower, wherein said cost rewriter rewrites the root path cost in conformity to the rate of the bottleneck from said port manager.

5. The relay apparatus according to claim 1, said relay apparatus comprising:
a converter for converting a transfer delay of the WAN into a transfer rate, said transfer delay being broadcast from the transfer apparatus provided in an identical net;
a LAN-side port for notifying said link rate of the connection link of the second transfer apparatus; and
a port manager for investigating a rate of the bottleneck based upon said converted transfer rate of the WAN, said notified link rate of the connection link of the second transfer apparatus, and said link rate of the first transfer apparatus being transmitted from the relay apparatus facing its own relay apparatus, wherein said cost rewriter rewrites the root path cost in conformity to the rate of the bottleneck from said port manager.

6. The relay apparatus according to claim 1, said relay apparatus comprising:
a WAN-side port for notifying said link rate of the WAN; and
a LAN-side port for notifying said link rate of the connection link of the second transfer apparatus, wherein said cost rewriter, based upon said notified transfer rate of the WAN and said notified link rate of the connection link of the second transfer apparatus, rewrites the root path cost rewritten by the relay apparatus facing its own relay apparatus based upon either said link rate of the first transfer apparatus or said transfer rate of the WAN, whichever is lower.

7. The relay apparatus according to one of claim 1 to claim 6, wherein said cost rewriter decides the cost, which is rewritten, responding to a utilization ratio of a band set VLAN by VLAN.

8. A relay apparatus provided between transfer apparatuses for selecting a path based upon a link rate of a connection link, said relay apparatus comprising a controller for controlling one of a transfer rate of a WAN-side port and a link rate of a LAN-side port in conformity to either a link rate of a WAN or a link rate of a connection link of said transfer apparatus, whichever is lower.

9. A path selection system, said path selection system comprising a cost rewriter provided between a first transfer apparatus for transmitting a root path cost and a second transfer apparatus for selecting a path based upon said root path cost, said cost rewriter rewriting said root path cost by pre-subtracting a cost that is added up in said second transfer apparatus, wherein said second transfer apparatus selects a path based upon the root path cost from the cost rewriter of each path.

10. The path selection system according to claim 9, wherein said cost rewriter provided between a first transfer apparatus for transmitting a root path cost and a second transfer apparatus for selecting a path based upon said root path cost rewrites said root path cost based upon a rate of a bottleneck out of a link rate of a connection link of said first transfer apparatus, a link rate of said second transfer apparatus, and a transfer rate of a WAN.

11. The path selection system according to claim 10, wherein said cost rewriter comprises:
a first cost rewriter for rewriting said root path cost when said link rate of the first transfer apparatus is larger than said transfer rate of the WAN; and
a second cost rewriter for rewriting said rewritten root path cost based upon a rate of the bottleneck out of said link rate of the connection link of the second transfer apparatus and said transfer rate of the WAN.

12. The path selection system according to claim 10, said path selection system comprising:
a notifier for notifying said link rate of the first transfer apparatus; and
a port manager for investigating a rate of the bottleneck based upon said notified link rate of the first transfer apparatus, said transfer rate of the WAN, and said link rate of the connection link of the second transfer apparatus, wherein said cost rewriter rewrites the root path cost in conformity to the rate of the bottleneck from said port manager.

13. The path selection system according to claim 10, said path selection system comprising:
a measurer for measuring said transfer rate of the WAN;
a notifier for notifying either said link rate of the first transfer apparatus or said measured transfer rate of the WAN, whichever is lower; and
a port manager for investigating a rate of the bottleneck based upon said notified link rate, said transfer rate of the WAN, and said link rate of the connection link of the second transfer apparatus, wherein said cost rewriter rewrites the root path cost in conformity to the rate of the bottleneck from said port manager.

14. The path selection system according to claim 10, said path selection system comprising:
a notifier for notifying said link rate of the first transfer apparatus;
a converter for converting a transfer delay of the WAN into a transfer rate, said transfer delay being broadcast from the transfer apparatus provided in an identical net; and
a port manager for investigating a rate of the bottleneck based upon said converted transfer rate of the WAN, said link rate of the connection link of the second transfer apparatus, and said notified link rate of the first transfer apparatus, wherein said cost rewriter rewrites the root path cost in conformity to the rate of the bottleneck from said port manager.

15. The path selection system according to claim 10, wherein said cost rewriter comprises:
a first cost rewriter for rewriting said root path cost in conformity to either said link rate of the first transfer apparatus or said transfer rate of the WAN, whichever is lower; and
a second cost rewriter for rewriting said rewritten root path cost based upon a rate of the bottleneck out of said link rate of the connection link of the second transfer apparatus and said transfer rate of the WAN.

16. A path selection system, comprising:
a changer for, in conformity to either a transfer rate of a WAN or a link rate of a connection link, whichever is lower, changing said link rate of the connection link;
a transfer apparatus for transmitting a root path cost based upon said changed link rate of the connection link; and
a second transfer apparatus for selecting a path based upon said root path cost of each path.

17. A path selection method of selecting a path based upon a root path cost, said path selection method comprising:
a cost rewrite step of rewriting said root path cost based upon a rate of a bottleneck out of a link rate of a first transfer apparatus for transmitting said root path cost, a link rate of a connection link of a second transfer apparatus for selecting a path based upon said root path cost, and a transfer rate of a WAN; and
a step of collecting said rewritten root path cost from each path, and selecting a path based upon this collected root path cost.

18. The path selection method according to claim 17, wherein said cost rewrite step comprises:
a first cost rewrite step of rewriting said root path cost when said link rate of the first transfer apparatus is larger than said transfer rate of the WAN; and
a second cost rewrite step of rewriting said rewritten root path cost based upon a rate of the bottleneck out of said link rate of the connection link of the second transfer apparatus and said transfer rate of the WAN.

19. The path selection method according to claim 17, said path selection method comprising:
a notification step of notifying said link rate of the first transfer apparatus;
an investigation step of investigating a rate of the bottleneck based upon said notified link rate of the first transfer apparatus, said transfer rate of the WAN, and said link rate of the connection link of the second transfer apparatus, wherein said cost rewrite step is a step of rewriting the root path cost in conformity to the rate of the bottleneck investigated in said investigation step.

20. The path selection method according to claim 17, said path selection method comprising:
a measurement step of measuring said transfer rate of the WAN;
a notification step of notifying either said link rate of the first transfer apparatus or said measured transfer rate of the WAN, whichever is lower; and
an investigation step of investigating a rate of the bottleneck based upon said notified rate, said transfer rate of the WAN, and said link rate of the connection link of the second transfer apparatus, wherein said cost rewrite step is a step of rewriting the root path cost in conformity to the rate of the bottleneck investigated in said investigation step.

21. The path selection method according to claim 17, said path selection method comprising:
a notification step of notifying said link rate of the first transfer apparatus;
a conversion step of converting a transfer delay of the WAN into a transfer rate, said transfer delay being broadcast from the transfer apparatus provided in an identical net; and
an investigation step of investigating a rate of the bottleneck based upon said converted transfer rate of the WAN, said link rate of the connection link of the second transfer apparatus, and said notified link rate of the first transfer apparatus, wherein said cost rewrite step is a step of rewriting the root path cost in conformity to the rate of the bottleneck investigated in said investigation step.

22. The path selection method according to claim 17, said path selection method comprising:
a first cost rewrite step of rewriting said root path cost in conformity to either said link rate of the first transfer apparatus or said transfer rate of the WAN, whichever is lower; and
a second cost rewrite step of rewriting said written root path cost based upon a rate of the bottleneck out of said link rate of the connection link of the second transfer apparatus and said transfer rate of the WAN.

23. A path selection method, comprising:
a change step of, in conformity to either a transfer rate of a WAN or a link rate of a connection link, whichever is lower, changing said link rate of the connection link;
a transmission step of transmitting a root path cost based upon said changed link rate of the connection link; and
a selection step of selecting a path based upon said root path cost that is transmitted from each path.

24. A medium in which a program of a relay apparatus provided between a first transfer apparatus for transmitting a root path cost and a second transfer apparatus for selecting a path based upon said root path cost has been recorded, said program causing said relay apparatus to function as a cost rewriter for rewriting said root path cost based upon a rate of a bottleneck out of a link rate of said first transfer apparatus, a link rate of a connection link of said second transfer apparatus, and a transfer rate of a WAN.

25. A medium in which a program of a relay apparatus provided between transfer apparatuses for selecting a path based upon a link rate of a connection link has been recorded, said program causing said relay apparatus to function as a controller for controlling one of a transfer rate of a WAN-side port and a link rate of a LAN-side port in conformity to either a transfer rate of a WAN or the link rate of the connection link of said transfer apparatus, whichever is lower.
